(19) United States
(12) Patent Application Publication
(10) Pub. No.: US 2009/0288390 A1
(43) Pub. Date: Nov. 26, 2009

(54) SIMPLIFIED THRUST CHAMBER RECIRCULATING COOLING SYSTEM

(76) Inventors: Thomas Clayton Pavia, Mojave, CA (US); James Robert Grote, Mojave, CA (US)

Correspondence Address: RAMIREZ & SMITH, PO BOX 341179, AUSTIN, TX, 78734, US

(21) Appl. No.: 12/472,373

(22) Filed: May 26, 2009

Related U.S. Application Data
(60) Provisional application No. 61/128,761, filed on May 23, 2008.
(60) Provisional application No. 61/131,912, filed on Jun. 12, 2008.

(51) Int. Cl. F02K 99/00

(52) U.S. Cl. 60/267

(57) ABSTRACT

In some implementations a propulsion system includes a thrust chamber having a gap between an inner shell and an outer shell, the inner shell and the outer shell being attached together to form the thrust chamber. In some implementations, the rocket engine also includes a recirculating cooling system operably coupled to the gap in at least two locations and operable to recirculate a convective coolant through the gap.

### RELATED APPLICATIONS

This disclosure claims priority under 35 U.S.C. 121 to copending U.S. application Ser. No. 12/120,833, filed 15 MAY, 2008 entitled “SIMPLIFIED THRUST CHAMBER RECIRCULATING COOLING SYSTEM” which claims the benefit of U.S. Provisional Application Ser. No. 60/930,373 filed 15 MAY 2007 under 35 U.S.C. 119(e). This application claims the benefit of copending U.S. Provisional Application Ser. No. 61/128,761 filed 23 MAY 2008 under 35 U.S.C. 119(e). This application claims the benefit of copending U.S. Provisional Application Ser. No. 61/131,192 filed 12 JUN. 2008 under 35 U.S.C. 119(e).

### FIELD

This disclosure relates generally to propulsion systems, and more particularly to rocket engine thrust chambers and thrust chamber cooling systems.

### BACKGROUND

In conventional liquid propellant rocket engines, a main propellant injector sprays liquid propellants into a combustion chamber, where the propellants are burned. The burned propellants expand in an expansion nozzle, where the resulting gases increase in velocity and produce thrust. A thrust chamber encompasses both the combustion chamber and the expansion nozzle.

One of the propellants (usually the fuel) flows through coolant tubes or channels in the thrust chamber. The relatively cool propellant flowing in the coolant tubes or channels cools the thrust chamber and prevents the thrust chamber from failing or melting. These conventional fluid cooled engines are typically called regenerative cooled engines because the engine uses one of the main propellant to cool the thrust chambers. Examples of regenerative cooled engines are the Space Shuttle's SSME engine and the Apollo program's F-1 and engines.

The thrust chambers of conventional regenerative cooled engines can include large numbers of individual coolant tubes, perhaps dozens to as high as one thousand coolant tubes, and above. The coolant tubes are brazed or welded together side-by-side like asparagus, or instead of coolant tubes cooling channels are fabricated from large, thick metal shells that require extensive machining, custom tooling, and custom processes to fabricate the fluid cooling channels (i.e. passages) in the thrust chamber. These types of coolant tubes and flow channels for regenerative cooled thrust chambers are produced by a small number (perhaps several) of very specialized, high-overhead, expensive fabricators. The cooling system of the thrust chamber is very often a large part of the procurement expense of a rocket engine and requires a long lead time to manufacture.

### BRIEF DESCRIPTION

The above-mentioned shortcomings, disadvantages and problems are addressed herein, which will be understood by reading and studying the following specification.

In some aspects, a thrust chamber 102 recirculating cooling system includes a baseline implementation of a rocket engine, thrust chamber, and cooling system. No aspects are limited to the baseline implementation of the rocket engine, but the baseline implementation of the rocket engine serves as an example of construction and operation of a recirculating cooling system. In some examples, the recirculating cooling system is similar to, but not the same as a closed cycle radiator-based water cooling system of an automobile (see FIGS. 1 and 2).

To start with the baseline rocket engine main propellants are liquid oxygen (Lox) and jet fuel with water as the convective coolant 214. The baseline engine is a pressure-fed rocket engine with a 300 psia combustion chamber 122 pressure. In addition to the water convective coolant 214 there is a jet fuel internal film coolant injected on the inside hot-wall 204 of the thrust chamber 102. The film coolant valve 215 and film coolant manifold/injector 218 are shown in FIG. 2 but not in FIG. 1 simply because FIG. 1 had too many items on it. The baseline expansion nozzle 118 area ratio is 6.32, an appropriate value for a first stage engine.

To maintain maximum simplicity, the thrust chamber 102 in FIGS. 1 and 2 is composed of two simple, free-floating spun and welded shells, the inner shell 104 and outer shell 106. The shells are attached to each other only at their ends and have a gap 110 in between them for convective coolant 214 flow.

Free-floating shells described herein are useful for smaller thrust chambers 102 (smaller than about 25,000 lbs) but for larger thrust chambers 102 with a thin inner shell 104 the throat area 121 is going to want to pucker out after engine start. Some implementations include any type of interconnections between the two shells to prevent any kind of collapse or buckling in any direction. However, some features support such interconnections to be simplified and minimized, as is described below.

In FIG. 1 the coolant feed tank 112 (contains water) is pressurized to about 50 psig. The pressure from the coolant feed tank 112 forces a water convective coolant 214 to flow throughout the gap 110 between the thrust chamber 102 inner and outer shells and thus cools the thrust chamber 102. The convective coolant 214 is assisted by a coking internal film coolant 210 (jet fuel) that greatly reduces the heat flux flowing through the inner shell 104 and into the convective coolant 214. The gap 110 between the shells is oversized. The gap 110 can be any size, but in some implementations on a 250,000 lb thrust engine the gap 110 is about 0.3″ wide or larger.

Since the gap 110 is oversized then the flowrate of convective coolant 214 must be increased to keep velocity of the convective coolant 214 above the critical burnout velocity. The convective coolant 214 flowrate will be higher than is necessary for cooling the thrust chamber 102, typically 5 to 25 times the required flowrate. The reasoning for the higher flowrate is to increase cooling safety factor, minimize gap 110 pressure drop, and loosen thrust chamber 102 tolerances to facilitate ease of fabrication. Thus, the convective coolant 214 flows through the gap 110 absorbing any heat that gets past the carbon deposited on the inner shell 104 hot-wall 204 by the coking internal film coolant 210. Because the flowrate of the convective coolant 214 is higher than necessary for cooling, the temperature of the convective coolant will increase in any single pass through the thrust chamber 102 by only about 15-60 deg F.

Note that in some implementations, the fluid operating pressure in the gap 110 can be any pressure, but in the baseline implementation the pressure in the gap 110 is low: sea level atmospheric pressure or 14.69 psia. Keeping the operating pressure of the gap 110 low is helpful because a low gap 110 pressure helps prevent collapse of the inner shell 104 and greatly reduces the amount of fabrication required to attach the inner and outer shells 104, 106 together. Thus a simplified sheet metal construction can be implemented to make the thrust chamber 102.

As stated, the pressure in the coolant feed tank 112 pushes the convective coolant 214 through the gap 110, out of the thrust chamber 102, and into a heat exchanger 138 where the water convective coolant 214 is cooled by all or a portion of a main propellant flowrate. In the baseline implementation the heat exchanger 138 coolant will be Lox. Lox is implemented because the larger temperature differential between itself and the water will greatly decrease the heat exchanger 138 size and weight.

After the water passes through the heat exchanger 138, the water flows into a recirculation pump 108 that increases its pressure so that the water can flow back into the coolant feed tank 112. In addition to flowing through the gap 110, a specified flowrate of water (convective coolant 214) is injected downstream of the thrust chamber throat 121 as a nozzle film coolant 222. The downstream flowrate from the thrust chamber occurs because the static pressure in the nozzle is low after engine start, often 5-30 less than the combustion chamber 122 pressure depending on area ratio.

The nozzle film coolant 222 (actually convective coolant 214) not only cools the at least a portion of the expansion nozzle 118 but can help get rid of heat build-up in the coolant feed tank 112 in implementations where an undersized heat exchanger 138 is implemented or even no heat exchanger 138 at all. The nozzle film coolant 222 also ensures that the coolant feed tank 112 will be empty at the point of engine shutdown.

To increase its heat absorbing capacity and to make the water more effective as a convective and nozzle film coolant, in the baseline implementation the water is prechilled in the coolant feed tank to 36 deg F. prior to engine start.

Once the convective coolant 214 is pumped back into the coolant feed tank 112, the convective coolant is then pushed once back into the thrust chamber gap 110 by the pressure of the coolant feed tank to once again cool the thrust chamber 102. The cycle of pumping the convective coolant 214 in a circular path between the coolant feed tank and the thrust chamber 110 is repeated in which the convective coolant 214 is recirculated round-and-round in a continuous convective coolant loop 114.

For a baseline 250,000 lb thrust engine the internal film coolant 210 flowrate is in the range of 2.5-3.5% of the total fluid flowrate to the thrust chamber 102. The nozzle film coolant 222 (water) flowrate for one version of the baseline can be approximately 2.62% of the total fluid flowrate. A nozzle film coolant 222 efficiency of 35% in the liquid and boiling phases and 30% in the vapor phase and a 1200 deg F. maximum nozzle exit temperature is assumed. The portion of the nozzle that is exclusively film cooled is simply a single sheet metal shell (called the “nozzle shell” 26) and the nozzle film coolant 222 is injected at an area ratio of 3 in the baseline implementation.

Apparatus, systems, and methods of varying scope are described herein. In addition to the aspects and advantages described in this brief description, further aspects and advantages will become apparent by reference to the drawings and by reading the detailed description that follows.

### BRIEF DESCRIPTION OF THE DRAWINGS

FIG. 1 is a cross section side-view block diagram of a propulsion system with a rocket engine having a thrust chamber recirculating coolant system;

FIG. 2 is a cross section side-view block diagram of the propulsion system's rocket engine assembly with a dual-shell thrust chamber that is cooled by a recirculating cooling system;

FIG. 3 is a cross section top-view block diagram of combustion chamber apparatus having vortex film coolant injection orifices;

FIG. 4 is an isometric block diagram of a thrust chamber that shows a vortex swirling flow of a layer of internal film coolant along the thrust chamber inside wall;

FIG. 5 is a cross section side-view block diagram of an alternative configuration for the propulsion system's rocket engine thrust chamber having a shell and a spiraled coolant tube instead of a gap between two shells;

FIG. 6 is a cross section side-view block diagram of a sample bolting arrangement for a dual-shell thrust chamber for securing the inner and outer shells together;

FIG. 7 is a flowchart of a method to cool a rocket engine thrust chamber through recirculation of a convective coolant;

FIG. 8 is a flowchart of a method to cool a rocket engine thrust chamber;

FIG. 9 is a block diagram of an engine control computer in which different methods can be practiced;

FIG. 10 is a block diagram of a data acquisition circuit of an engine control computer in which different methods can be practiced;

FIG. 11 is a cross section side-view block diagram of a propulsion system having a rocket engine with a thrust chamber spray coolant recirculating cooling system with static spray devices;

FIG. 12 is a cross section side-view block diagram of the spray coolant propulsion system's rocket engine with a thrust chamber cooled with static spray devices;

FIG. 13 is a cross section side-view block diagram of a sample bolting arrangement for securing the inner and outer shells together for a thrust chamber cooled with a spray coolant system utilizing static spray devices;

FIG. 14 is a cross section side-view of a thrust chamber spray cooling method utilizing a rotating spray manifold;

FIG. 15 is a cross section side-view of a thrust chamber spray cooling method utilizing a rotating spray cooling spindle;

FIG. 16 is a cross section side-view block diagram of a propulsion system having a thrust chamber spray coolant recirculating cooling system with static spray devices and a coolant delivery pump;

FIG. 17 is a cross section side-view of a thrust chamber spray cooling method utilizing an alternative rotating spray cooling spindle with an electric motor inside the housing;

FIG. 18 is a cross section side-view block diagram of a propulsion system having a simplified thrust chamber regenerative cooling system;

FIG. 19 is a cross section side-view block diagram of a propulsion system's engine utilizing a simplified thrust chamber regenerative cooling system; and

FIG. 20 is a cross section side-view block diagram of a propulsion system having a simplified thrust chamber regenerative cooling system with a heat exchanger and a coolant recirculation pump.

### DETAILED DESCRIPTION

In the following detailed description, reference is made to the accompanying drawings that form a part hereof, and in which is shown by way of illustration of specific implementations which may be practiced. These implementations are described in sufficient detail to enable those skilled in the art to practice the implementations, and it is to be understood that other implementations may be utilized and that logical, mechanical, electrical and other changes may be made without departing from the scope of the implementations. The following detailed description is, therefore, not to be taken in a limiting sense.

The systems, methods and apparatus described herein involve low-cost rocket engine technology that can be implemented to produce liquid propellant rocket engines of a very wide range of thrust sizes or propellant combinations for private, commercial, or government aerospace programs. Such an engine technology provides liquid propellant rocket engines at greatly reduced cost and procurement times as compared to conventional rocket engines. In some instances, the systems, methods and apparatus described herein reduce the procurement lead time of rocket engines from 9-to-18 months to approximately 4-to-6 weeks and the procurement costs from millions of dollars per unit to tens of thousands of dollars per unit. The systems, methods and apparatus described herein provide much faster and less expensive development and reproduction of rocket engines of a very wide range of thrust sizes or propellant combinations (i.e. combination of fuel and oxidizer).

### Apparatus Implementations

In this section, particular apparatus are described by reference to a series of diagrams.

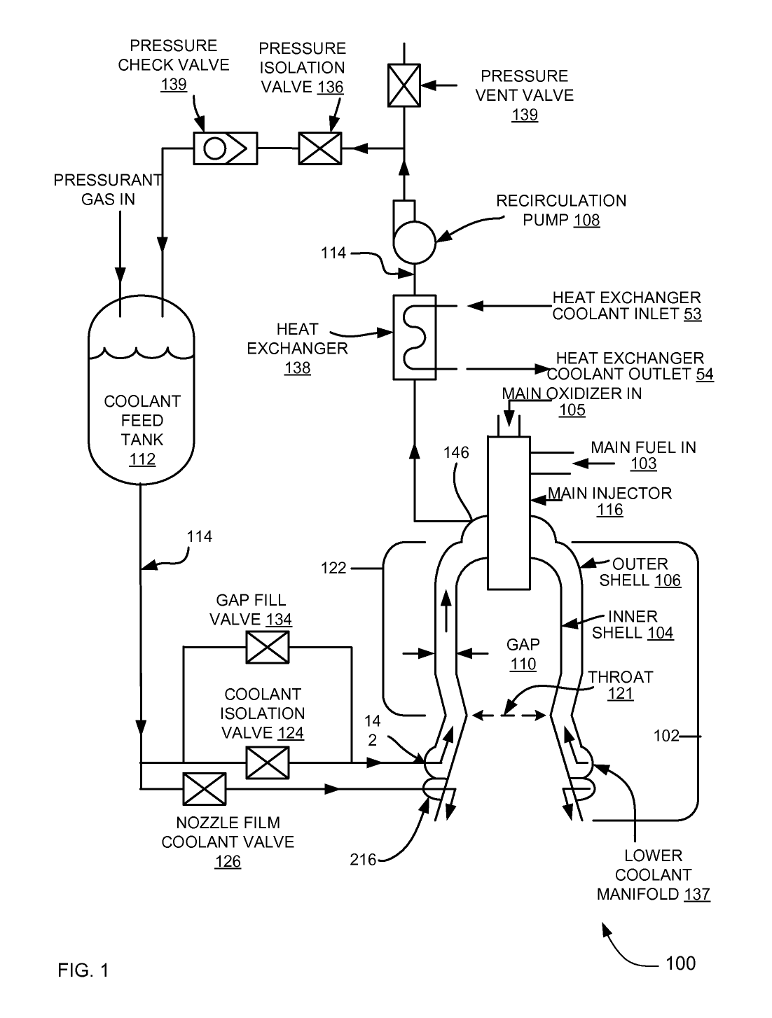

FIG. 1 is a cross section side-view block diagram of an overview of a propulsion system 100 having a thrust chamber recirculating cooling system. The thrust chamber 102 and recirculating cooling system do not require extensive machining, custom tooling and fabrication custom processes. Fabrication of propulsion system 100 can be simplified to an extent where a balance is achieved between a low-cost rocket engine and a rocket engine that has enough performance (i.e. Isp performance) to fly useful missions.

FIG. 1 is a cross section side-view block diagram of a propulsion system 100 having a thrust chamber recirculating cooling system. Propulsion system 100 includes a rocket engine cooling system that does not require extensive machining, custom tooling and fabrication custom processes.

Propulsion system 100 includes thrust chamber 102 that has a double-walled shell structure, a dual-shell structure that includes an inner shell 104 and an outer shell 106. The inner shell 104 has an interior hot wall 204 adjacent to the combustion flames of the thrust chamber 102 and a cold wall that is opposite to the hot-wall. The outer shell 106 has an inner wall in between the two shells and an outer wall that is the exterior surface of the thrust chamber 102. The dual-shell thrust chamber 102 is easy and simple to fabricate.

In propulsion system 100, the rocket engine thrust chamber 102 is cooled with water (known as the convective coolant 214) that flows between the inner shell 104 and outer shell 106 by apparatus of a recirculation pump 108. The convective coolant 214 (water in one example) absorbs heat that is conducted through the inner shell 104 from combustion gases of the propulsion system 100. The exact flow rate of the convective coolant 214 required to cool a rocket engine depends on the materials of construction, the desired confidence level in the engine implementation, the heat flux flowing into the inner shell 104, and the desired maximum temperature of the structures of the rocket engine, but the flow rate of convective coolant 214 will typically fall between 0.5% and 10% of the total fluid flow rate to the engine thrust chamber 102. The total fluid includes main propellants (main fuel 103 and main oxidizer 105), film coolant, and convective coolant 214. The convective coolant 214 is sometimes also known as a conductive coolant.

A rocket engine thrust chamber 102 recirculating cooling system can be implemented to cool any type of rocket engine thrust chamber 102, whether the engine receives main propellants (main fuel 103 and oxidizer 105) delivered as a pressure-fed rocket engine (i.e. main propellants fed to the engine solely by pressurizing the main propellant tanks) or whether the rocket engine is pump-fed (i.e. where the main propellants are fed to the engine by a pump or pumps, usually but not always a turbopump/turbopumps). If implemented as shown in FIG. 1, the thrust chamber 102 cooling system can operate completely independently of the turbopump system making development of both systems easier and less costly.

A rocket engine thrust chamber recirculating cooling system consists of the all the components of the convective coolant loop 114: namely the thrust chamber gap 110, the heat exchanger 138, the recirculation pump 108, coolant feed tank 112, and the remaining piping, tubing, and valves of the system that keep at least a portion of the convective coolant 214 flowing in a continuous loop or circle. The terms “recirculating cooling system” and “convective coolant loop” 214 are equivalent to each other and interchangeable.

To ensure that there is adequate cooling of the thrust chamber 102, more convective coolant 214 is pumped through a gap 110 between the inner shell 104 and outer shell 106 than is required to cool the thrust chamber 102 below a maximum allowable temperature of the thrust chamber. The greater convective coolant 214 flow rate maintains acceptable convective coolant 214 velocity for adequate cooling and also gives higher cooling safety factor. In some implementations, about 1.1 to 25 times more convective coolant 214 is pumped through the gap than is required to cool the thrust chamber 102 below a maximum allowable temperature of the thrust chamber 102. Since excess convective coolant 214 is flowing through the thrust chamber 102, that portion of convective coolant 214 that is not expended during the cooling process is recirculated back to a coolant feed tank 112 for reuse with a recirculation pump 108. The recirculation pump 108 is located anywhere in the convective coolant 214 loop 114. The recirculation pump 108 can be any type of pump that can pump the convective coolant 214. The recirculation pump 108 can be electrically, hydraulically, or pneumatically driven or driven by any other apparatus so long as the recirculation pump 108 pumps the convective coolant 214.

The thrust chamber 102 is easy to fabricate because the larger convective coolant 214 flow rate allows for a gap 110 that is larger between the inner shell 104 and the outer shell 106 of the thrust chamber 102. The larger gap 110 in turn allows for a lower fluid pressure drop in the gap 110, less chance of plugging due to contaminants, less warpage effects, much looser gap tolerances, and less surface smoothing requirements.

A larger, wider gap 110 provides a greater flow rate of the convective coolant 214, with the convective coolant 214 not expended during the cooling process being recirculated via the recirculation pump 108 back to the coolant feed tank 112. The width of the gap 110 is directly proportional to the increase in the flow rate convective coolant 214. For example, consider a rocket engine with a conventional convective non-recirculating cooling system in which the sea level thrust is 25,000 lbs, a chamber pressure is 300 psia, propellants are Lox/Jet fuel with water convective coolant 214, the % water flow rate is 2.8% of total fluid flow (flow rate) to engine, a inner shell wall thickness of 0.026″, and a convective coolant 214 velocity at throat region of 30 ft/sec, such an engine can have a gap around the engine's throat of about 0.0125″ wide. With a recirculation system of propulsion system 100, the flow rate of the convective coolant 214 is increased by a factor of 10, to make the gap 110 wider, in which the gap becomes 0.125.″ These figures should only be considered as examples and can vary widely. A wider gap 110 facilitates the production of low cost, easier to produce engines.

In some implementations, the gap is in a range of 0.04-0.375 inches, which provide looser tolerances in the dimensions and geometry between inner and outer shells and allows greater cooling when implemented with the coolant recirculation system.

The double-wall construction of the thrust chamber 102 with recirculation of convective coolant 214 in the gap 110 provides looser acceptable values for gap tolerance. With the exemplary 0.125″ gap of the propulsion system 100, an acceptable tolerance can be ±50% which would translate to ±0.0625″ or a total tolerance range of 0.125.″ These amounts of tolerances are achievable with standard metal working of sheet metal, thus fabricating the thrust camber 102 from sheet metal is practical in propulsion system 100. Because cost increases and potential reductions in reliability increase largely with tighter tolerances, a reduction in tolerance requirements represents a potentially huge reduction in cost and production time. These numbers should be accepted as examples only and can vary.

In some implementations, the flow rate of the convective coolant 214 flow rate is increased to maintain constant velocity above a burnout velocity as the gap dimension is increased in width, and at least a portion of the convective coolant 214 is recirculated back to the coolant feed tank 112.

Propulsion system 100 has less convective coolant 214 pressure drop in the gap. As the distance of the gap 110 becomes smaller, the pressure drop of the convective coolant 214 flowing through the gap 110 dramatically increases due to the effects of surface friction between the fluid and the metallic wall. The surface friction between the fluid and the metallic wall occurs because surface friction translates into increased fluid boundary layer effects in a small gap. A gap of 0.0125″ has much more significant surface friction/boundary layer effects than a gap of 0.125.″ For very tiny gaps (such as 0.0125″) the pressure drop can be very high, perhaps 5 to 50 times higher that of a larger gap. Pressure drops for tiny gap sizes are usually difficult to calculate and should be determined experimentally. The problem with these high pressure drops for small gap sizes is that they increase the horsepower of the recirculation pump and/or the pressure of the coolant feed tank 112 (and their weights) dramatically, making these items much less practical for a real working rocket vehicle. Thus, when the convective coolant 214 flow rate is increased and the gap 110 is increased as well, these friction/boundary layer pressure losses are dramatically decreased to the benefit of the rocket system as a whole.

Propulsion system 100 has less surface smoothness requirements. As the gap 100 distance decreases the friction/boundary layer pressure losses increase. To help minimize these pressure losses, the inside surfaces of the gap (shells) can be polished or smoothed, the smaller the gap 110, the greater the need for extreme smoothing. Smoothing can be difficult and expensive for the large surface area of a thrust chamber, especially if that area is contoured. The contoured shape of the thrust chamber will only contribute to the complexity and expense of thrust chamber fabrication. Having a larger gap distance will greatly reduce the need for smoothing/polishing or eliminate the need for smoothing/polishing altogether.

Propulsion system 100 has a higher convective cooling safety factor. In a thrust chamber without recirculation cooling, the maximum temperature for the convective coolant 214 after one pass through the thrust chamber is variable but an acceptable value is 30 degrees less than the boiling point of the fluid. For water convective coolant 214 the maximum temperature for the convective coolant 214 after one pass through the thrust chamber can be 182 deg F. for an ambient pressure water cooling system.

Assuming the cooling water in the coolant feed tank 112 has a starting temperature of 36 deg F., in a propulsion system 100 having convective coolant 214 recirculation, there is a greater coolant flow rate; for example 10 times the rate without recirculation, in which case the temperature rise of the convective coolant 214 with each pass through the thrust chamber 102 might be only 14.6 deg F. but would be 146 deg F. without coolant recirculation. Moreover, depending on the exact engine parameters, a propulsion system 100 having convective coolant 214 recirculation will be able to cool approximately 1.25 to 4.0 times the heat flux that a non-recirculating system can cool. Cooling approximately 1.25 to 4.0 times the heat flux that a non-recirculating system can cool is very helpful when anomalies should develop in the thrust chamber 102 that increase the heat flux at any one location in the thrust chamber 102.

The output pressures of the recirculation pump 108 can be of a wide range of pressure, but in some implementations, the output pressure of the recirculation pump 108 is at least be enough to compensate for the pressure drop and head difference (height difference) of the convective coolant 214 as the convective coolant 214 flows through the convective coolant 214 loop 114, including acceleration effects. The output pressure of the recirculation pump 108 should also be less than the amount of pressure required to cause the inner shell 104 to collapse before the engine starts and the pressure in the thrust chamber 102 increases to the operating pressure of the thrust chamber 102. Typical values (for example only, other values applicable) of the output pressure of the recirculation pump 108 output pressure can fall between approximately 5 to 100 psid (differential pressure across pump) but the ultimate value is determined by the pressure drop of the convective coolant 214 loop 114, the height difference of the recirculating cooling system, and the acceleration field that the convective coolant 214 loop 114 is being subjected to.

Propulsion system 100 can use liquid oxygen (Lox) and jet fuel as the main propellant of the engine (i.e. the propellants that generate the bulk of the thrust of the rocket engine), as well as any other propellant. To reduce the amount of convective coolant 214 required to cool the inner shell 104 to acceptable temperatures, propulsion system 100 includes one of two techniques or both: 1) film coolant and 2) application of a ceramic or metal layer such as but not limited to a metal oxide, carbide, or nitride; metal alloy; pure metal; or anodizing of the interior hot-wall surface 204 of the inner shell 104. The hot-wall 204 (or hot-wall surface 204) is the interior wall of the inner shell 104 adjacent to the combustion gases inside the thrust chamber 102. Anodizing is appropriate only for materials of the inner shell 104 that can be anodized such as aluminum. Film coolant is a liquid or gas that flows along the interior hot-wall surface 204 of the inner shell 104. In propulsion system 100, the film coolant (called internal film coolant 210) is jet fuel that is injected along the inner shell 104 hot-wall 204. The jet fuel internal film coolant 210 reduces the heat to be absorbed by the convective coolant 214 by, upon evaporation and/or decomposition of the internal film coolant 210, depositing carbon (soot) on the hot-wall surface 204 of the inner shell 104. The carbon or soot is an excellent insulator that greatly reduces the transmission of heat to the convective coolant 214. The process of depositing soot on the hot-wall 204 of the inner shell 104 is called coking, jet fuel being a coking fluid. The amount of internal film coolant 210 utilized can be within a wide range and depends on the maximum desired hot-wall 204 temperature of the engine and the materials of construction, but the amount usually falls between 0 and 10% of the total fluid flow to an interior 115 of the thrust chamber 102. The total fluid includes the main propellants (main fuel 103 and oxidizer 105 or other propellants) and any coolants. The internal film coolant 210 can be either a coking or noncoking fluid, but is shown as a coking fluid as the baseline for the systems, methods and apparatus disclosed.

In addition, anodizing the hot-wall surface of aluminum inner shell 104 produces a layer of aluminum oxide on the hot-wall surface 204. Aluminum oxide is also a very good insulator and, like carbon, can withstand very high temperatures (approx. 3500 deg F. and greater).

In propulsion system 100, a main propellant injector 116 is a Pintle injector such as was developed in the 1960's. However the thrust chamber 102 cooling system of propulsion system 100 can be implemented with any rocket main propellant injector 116 as discussed below.

In many cases, when implemented in a flying rocket vehicle, the convective coolant 214 must be gradually expended (i.e. dumped overboard) somehow. In a particular implementation, the convective coolant 214 is expended overboard the flight vehicle during rocket engine operation such that the coolant feed tank 112 is empty or near empty at the moment of engine shutdown. If not, then at the end of the flight of vehicle, the coolant feed tank 112 will be just as full at the end of the operation engine as the coolant feed tank 112 is at the start of engine operation, which results in a heavier vehicle at engine shutdown and thus results in the vehicle being able to carry less useful payload. In addition, if the heat exchanger 138 is not implemented or is undersized and if convective coolant 214 is not dumped overboard in a gradual and measured way, the convective coolant 214 in the coolant feed tank 112 can rise in temperature until the temperature in the convective coolant 214 in the coolant feed tank 112 is at or near a boiling point (assuming the cooling system is implemented without a heat exchanger 138 or the heat exchanger is undersized or under capacity). Some implementations of the propulsion system 100 include a “dumping overboard” mode of the convective coolant 214 that includes gradually expending the convective coolant 214 overboard. Dumping overboard is discussed in greater detail below. In propulsion system 100, piping, tubing, and/or hose or other apparatus connects the main components as helpful.

Three possible methods to expend convective coolant 214 during engine operation are:

a.) Cooling an expansion nozzle 118 using convective coolant 214 injected along the interior wall 206 (or simply interior 206) of the expansion nozzle 118 as a film coolant. Cooling an expansion nozzle 118 using convective coolant 214 injected along the interior wall 206 of the expansion nozzle 118 as a film coolant expends convective coolant. The baseline configuration cools an expansion nozzle 118 using convective coolant 214 injected along the interior wall 206 of the expansion nozzle 118. In propulsion system 100, the convective coolant 214 is routed to the expansion nozzle 118 where convective coolant 214 is injected along the interior wall 206 of the expansion nozzle 118 to be implemented as a film coolant that cools part or all of the expansion nozzle 118. The convective coolant 214, implemented in the expansion nozzle 118 as film coolant (i.e the nozzle film coolant 222), can be injected anywhere in the nozzle using any apparatus of injection, but injecting convective coolant 214 at a nozzle expansion area ratio somewhere between 2 to 4 are a typical example. In cooling the expansion nozzle 118 by using convective coolant 214 as a film coolant, a low static pressure exists in the flowfield of the expansion nozzle 118, thus the coolant feed tank 112 and/or the recirculation pump 108 can be run at lower pressures (i.e. slightly higher than the static pressure of the expansion nozzle 118) while still being able to cool the nozzle. Lower tank and pump output pressures provide lower vehicle weights and thus the rocket vehicle can carry more useful payload. The expansion nozzle 118 cooling method can be implemented alone or in combination with a coolant metering device 17 (not shown in FIG. 1). The area ratio of an expansion nozzle 118 is the ratio of a cross sectional area of the nozzle at a specified location (in the nozzle) to the cross sectional area of a throat 121 of the thrust chamber 102 (i.e. the narrowest part of the thrust chamber 102).

Note that in the figures herein, that portion of the expansion nozzle 118 that is cooled by nozzle film coolant 222 is simply a single shell structure (called the nozzle shell 26) and not a dual-shell structure as other parts of the thrust chamber 102. Also, the interior 206 is a hot-wall of the expansion nozzle 118 that is exclusively film cooled and differs from the hot-wall 204 which is the interior wall of the thrust chamber 102 that is cooled by convective coolant 214 flowing in the gap 110.

b) Dumping the convective coolant 214 overboard through a coolant metering device 17. In some implementations, the convective coolant 214 is gradually dumped overboard through the coolant metering device 17. The coolant metering device 17 can be an orifice or valve or some other fluid flow-metering device or combination of devices. The coolant metering device 17 can be passive or actively controlled. The coolant metering device 17 can also be implemented by itself or in combination with using the convective coolant 214 as film coolant in the expansion nozzle 118.

c) Using the convective coolant 214 as a film coolant in the combustion chamber: After the convective coolant 214 travels through the gap 110 between the inner shell 104 and the outer shell 106 a portion of convective coolant 214 can be injected along the hot-wall of the combustion chamber 122 as the film coolant while the remainder of the convective coolant 214 is pumped back to the convective coolant 214 feed tank. In propulsion system 100, the combustion chamber 122 internal film coolant 210 is jet fuel.

In some implementations, the propulsion system 100 includes as many as six valves, such as a pressure isolation valve 136, a coolant isolation valve 124, a nozzle film coolant valve 126, a pressure vent valve 139, a pressure check valve 130, and the gap fill valve 134. These valves can be implemented by single or multiple valves or can be implemented alone or in combination with any other of these valves. These valves are significantly helpful under the following circumstances:

In implementations where the pressure in the gap 110 between the inner shell 104 and outer shell 106 is always less than the critical pressure required to collapse the inner shell 104 prior to engine startup (i.e. before the main propellants 103 and 105 are burning and there is pressure in the combustion chamber 122) or after, then any of the valves mentioned above are optional with the exception of the nozzle film coolant valve 126 which is optional depending of film cooling timing/control requirements. One or all of them can be implemented depending on how much control is required over the cooling process. Another optional valve is a film coolant valve 215 on the combustion chamber 122. The internal film coolant 210 can be fed directly from the gap 110 or from the external coolant tube(s) 504 without a valve for the internal film coolant 210, or the internal film coolant 210 can be fed from a valve and manifold dedicated to distributing the film coolant as shown in FIGS. 1, 2, and 5 and others. In some implementations, the internal film coolant 210 is be fed without a valve from a tube(s) branching off downstream of a main fuel valve 150. Likewise the nozzle film coolant 222 is fed from its own valve such as the nozzle film coolant valve 126 in FIG. 1 or the nozzle film coolant is fed without a valve dedicated to the nozzle film coolant but having tube(s) branching off downstream of the coolant isolation valve 124 or fed directly from a lower coolant manifold 137. Note that the film coolant manifold/injector 218 and the nozzle film coolant manifold/injector 216 perform both functions of manifolding (distributing) and injecting their respective film coolants. Options for the film coolant manifold/injector 218 are also valid for the nozzle film coolant manifold/injector 216 and vice versa. Any film coolant on the thrust chamber 102 can be valved and manifolded.

However, there are two implementations where the gap pressure will be high enough to collapse the inner shell 104 prior to engine startup (i.e. prior to buildup of pressure in the combustion chamber 122).

a.) High coolant Passage Pressure Drop: When the sizing of the convective coolant 214 flow passage is such that the pressure drop through the convective coolant 214 flow passage is high enough to require a recirculation pump 108 output pressure or coolant feed tank 112 operating pressure that is high enough to collapse the inner shell 104 prior to engine startup. The convective coolant 214 flow passage is all the piping, plumbing, and the gap 110 of the convective coolant 214 loop 114.

b.) Higher Gap Pressure Apparatus Higher coolant Boiling Temperature: The higher the convective coolant 214 pressure when the coolant is in the gap 110, the higher the boiling temperature will be, and thus the higher the amount of heat the convective coolant 214 can absorb before boiling, and thus the lower the required convective coolant 214 flow rate to cool the thrust chamber 102. A lower required flow rate of convective coolant 214 apparatus a smaller recirculation pump 108 and coolant feed tank 112 and thus a rocket vehicle with less tankage and inert weights and a higher useful payload weight.

If the convective coolant 214 is to have an operating pressure in the gap 110 that is higher than the external collapse pressure of the inner shell 104, then pressure in the gap 110 cannot increase to a full operating value of the gap 100 until the engine has started and the combustion chamber 122 pressure is at the full operating value (300 psia as an example).

Having convective coolant 214 at an operating pressure in the gap 110 that is higher than the external collapse pressure of the inner shell 104 is accomplished as follows: Prior to engine startup, the gap 110 in between the inner shell 104 and outer shell 106 is filled with convective coolant 214. The filling is performed by opening then closing the coolant isolation valve 124 before the coolant feed tank 112 is fully pressurized such that the pressure of the convective coolant 214 system is not enough to collapse the inner shell 104. The coolant feed tank 112 is then fully pressurized after the coolant isolation valve 124 and the pressure isolation valve 136 are closed. Note that pressure isolation valve 136 can be implemented in conjunction with a pressure check valve 130, or the pressure check valve 130 can be implemented by itself in place of the pressure isolation valve 136. If the coolant feed tank 112 is fully pressurized to an operating pressure prior to opening the coolant isolation valve 124 then filling the gap 110 prior to engine start is accomplished with the gap fill valve 134. The gap fill valve 134 is a manual or actuated valve that can be briefly opened to fill the gap 110 with convective coolant 214 prior to the coolant isolation valve 124 opening. The gap fill valve 134 is implemented in conjunction with opening the pressure vent valve 139 in order to fill the gap 110. The gap fill valve 134 and the pressure vent valve 139 can be replaced with ports that are simply plugged after gap 110 filling. After the gap 110 is filled the gap fill valve 134 and the pressure vent valve 139 are closed. In some implementations, the gap fill valve 134 is a small valve or a valve that has an orifice or metering device built into the gap fill valve or implemented with the gap fill valve 134 so that during the filling process the gap 110 pressure never exceeds the collapse pressure of the inner shell 104. The gap 110 filling can also be accomplished by opening and closing the gap fill valve 134 very quickly in successive pulses to keep the gap 110 pressure below the critical collapse pressure. Or the gap 110 can be filled from the coolant feed tank 112 prior to pressurizing that tank beyond the collapse pressure of the inner shell 104, or filled from a separate low pressure source that will not collapse the inner shell 104.

Once the gap 110 is filled with convective coolant 214 and the gap fill valve 134 and the pressure vent valve 139 are closed, the engine is started as follows:

At nearly the same time or just after (perhaps a few milliseconds to dozens of milliseconds as an example) the main propellants (main fuel 103 and oxidizer 105) have ignited in the combustion chamber 122 and pressure is building up in the combustion chamber 122 the coolant isolation valve 124 and the pressure isolation valve 136 are opened to allow convective coolant 214 to begin flowing through the gap 110 the moment that the recirculation pump 108 starts. The nonflowing convective coolant 214 that filled the gap 110 prior to opening the coolant isolation valve 124 will cool the thrust chamber 102 for the short duration (perhaps 0.010 second to 0.1 second as an example range) that the main propellants (main fuel 103 and oxidizer 105) are burning in the combustion chamber 122 and prior to opening the coolant isolation valve 124. Once the coolant isolation valve 124 and pressure isolation valve 136 opens, the combustion chamber 122 pressure is high enough to prevent the gap 110 pressure from collapsing the inner shell 104 and when the recirculation pump 108 starts the convective coolant 214 flows through the gap 110 to cool the thrust chamber 102. The pressure isolation valve 136 can open slightly sooner than the coolant isolation valve 124 or nearly the same time. Prior to the opening of the coolant isolation valve 124 and the pressure isolation valve 136 the convective coolant 214 is in a trapped space in the gap 110 and thermal expansion effects can cause the convective coolant 214 to collapse the inner shell 104. To prevent collapse of the inner shell caimplemented by the expansion effects of the convective coolant 214, the pressure vent valve 139 is opened and closed to the extent that the thermal expansion pressure is relieved to prevent collapse of the inner shell 104. The pressure vent valve 139 can be implemented to relieve any kind of pressure buildup that can collapse the inner shell 104, or another type of relief device can be implemented.

The entire thrust chamber 102 can be cooled with convective coolant 214 flowing through the gap 110, or a portion of the expansion nozzle 118 can be cooled by using convective coolant 214 as the nozzle film coolant 222. The convective coolant 214 implemented as film coolant in the expansion nozzle 118 can be flowed through a plumbing branch or manifold downstream of the coolant isolation valve 124 without a separate nozzle film coolant valve, or the convective coolant 214 can be controlled with a valve dedicated to distribution of the convective coolant 214, called the nozzle film coolant valve 126, for improved control and timing of initiation of flow or the convective coolant 214 (as the nozzle film coolant 222) can simply feed off of the lower coolant manifold 137. If a nozzle film coolant valve 126 is included, an inlet of the nozzle film coolant valve 126 can branch-off upstream of the coolant isolation valve 124 as shown in FIG. 1 or just upstream of a heat exchanger 138 or anywhere else in the convective coolant loop 114.

Some implementations of the propulsion system 100 also include a heat exchanger 138 for cooling the convective coolant 214 of the heat the convective coolant 214 has absorbed in the thrust chamber 102. Propulsion system 100 having convective coolant 214 recirculation provides circulation of the convective coolant 214, using the recirculation pump 108, through the heat exchanger 138 that uses as heat exchanger working coolants one or more of the following fluids which could be liquids or gases: fuel, oxidizer or pressurant gas or any combination of these. Recirculating the convective coolant 214 can have the beneficial effect of a) reducing the total convective coolant 214 and b) adding energy to the heat exchanger working coolants, thus increasing engine or pressurant efficiency. The benefits that can accrue from the use of a heat exchanger 138 can be to permit reduction of coolant weight and/or increase engine and/or pressurant efficiency, which can allow either reducing vehicle size for a given payload, or increasing payload for a fixed propellant size. A heat exchanger 138 of sufficient size can resemble a closed (except for any coolant bled off into the nozzle) low-pressure, pump circulated radiator not unlike a liquid-cooled automotive engine coolant system.

A convective coolant 214 loop 114 includes a number components in the propulsion system such as the gap 110, the heat exchanger 138, recirculation pump 108, the pressure isolation valve 136, the pressure check valve 130, the coolant feed tank 112, the nozzle film coolant valve 126, the coolant isolation valve 124 and the gap fill valve 134.

When the recirculating cooling system is part of a rocket engine in flight (i.e. on board a flying rocket vehicle). A coolant metering device 17 is one of the optional components. The purpose of the coolant metering device 17 is to dump convective coolant 214 during the rocket vehicles flight in order to end up with zero or near zero convective coolant 214 left in the coolant feed tank 112 when the mission is done and the engine has shut down. If excess convective coolant 214 remains on the vehicle at engine shut down, then the vehicles burnout weight is excessive and the weight of the remaining convective coolant 214 can result in less payload carried by the vehicle. The convective coolant 214 can be dumped into the atmosphere and/or injected along the expansion nozzle 118 interior wall 206, at/or downstream or upstream of the throat 121 of the thrust chamber (i.e. the narrowest part of the thrust chamber 102) in order to act as film coolant to cool the expansion nozzle 118. To accomplish this, the coolant metering device 17 can be either an actively controlled or preset device. The coolant metering device 17 can be implemented by itself to dump at least a portion of convective coolant 214 or can be implemented in conjunction with using at least a portion of convective coolant 214 as film coolant in the expansion nozzle 118. The heat exchanger 138 is optional and can be placed anywhere in the convective coolant 214 loop 114. The convective coolant 214 can also be injected into the expansion nozzle 118 as film or dump or transpiration coolant without a separate coolant metering device 17 as is shown in FIG. 1 (implemented as a nozzle film coolant).

The following section provides descriptions of various options to propulsion system 100 that have not yet been described in the previous sections.

Option 1, geometry of the combustion chamber 122: The recirculating cooling system can be implemented with any geometry of thrust chamber 102 including those with the conventional cylindrical combustion chambers (as in most rocket engines today) or spherical combustion chambers (such as in the German WW2 V2 rocket engine). Likewise the outer shell 106 of the thrust chamber 102 can be of any geometry so as long as the gap between the inner shell 104 and the outer shell 106 is sufficient to allow the sufficient flow of convective coolant 214 to cool the thrust chamber 102, cooling especially the inner shell 104. The thrust chamber 102 can be of any geometry, so long as the thrust chamber 102 is able to function as a rocket thrust chamber 102.

Option 2, engine main propellants: Because the recirculating cooling system operates independently of the main propellant injector 116, the cooling system can be implemented with rocket engines using any type of main propellants (main fuel 103 and oxidizer 105) including jet fuel, RP-1, kerosene, liquid hydrogen, liquid methane, propane, liquid oxygen, hydrogen peroxide, alcohol, nitric acid, and others.

Option 3, main propellant injector: Because the cooling system operates independently of the main propellant injector 116, the cooling system can be implemented with rocket engines utilizing any type of main propellant injector 116 including the Pintle injector originally developed in the 1960's or the so-called “flat-face” injectors such as utilized in the Space Shuttle Main Engine (SSME) and the Apollo J-2, H-1, and F-1 engines.

Option 4, film coolant: To reduce the flow rate and amount of convective coolant 214 required, the recirculating cooling system can be implemented with film coolant injected along the hot wall of the thrust chamber 102. The film coolant is not a necessity but the film coolant can be implemented with the recirculating cooling system. The film coolant can be injected in the thrust chamber 102 in any manner or number of places. In addition, any fluid can be implemented as film coolant as long as cooling properties of the fluid are known and how the fluid interacts with the recirculating cooling system is also known.

Option 5, convective coolant 214: The type of fluid implemented as convective coolant 214 in the recirculating cooling system can be any liquid, supercritical fluid, boiling liquid, multi-phase fluid, or gas as long as the fluid can absorb the heat flowing through the inner shell 104 of the thrust chamber 102 while allowing the inner shell 104 to remain cool enough so that the inner shell 104 does not melt or fail structurally during engine operation. Water is an ideal conducive coolant 214, but the convective coolant 214 can also be one of the main propellants (main fuel 103 and oxidizer 105) of the engine such as but not limited to liquid hydrogen, liquid methane, liquid oxygen, hydrogen peroxide, jet fuel, kerosene, rocket fuel, or others. Liquid nitrogen can also be implemented. Any fluid, including a gas, can be implemented as the convective coolant 214 as long as the fluid can absorb the heat that flows into the thrust chamber 102 form the engine's combustion process. In those cases where the convective coolant 214 is one of the rocket engine's main propellants (main fuel 103 and oxidizer 105), then an option is the appropriate main propellant tank acting as both the convective coolant 214 feed tank 112 and as a main propellant tank.

Option 6, convective coolant 214 additives: The convective coolant 214 can be a pure fluid, a mixture of fluids, or a fluid with the addition of additives to obtain specific coolant characteristics. For example, if water is implemented as the convective coolant 214 the water can include additives that have an effect of either lowering the freezing point of the water, raise the boiling point of the water, reduce the corrosion potential of the water or to achieve any other effect so long as the water still can absorb the heat from the thrust chamber 102. Another alternative is to prechill the convective coolant 214 prior to use in the convective coolant 214 loop 114.

Option 7, recirculation pumps: The convective coolant 214 recirculation pump 108 can be any type of pump that can move a fluid and can be driven by any type of energy source. The example pump of propulsion system 100 is a centrifugal pump driven by an electric motor. Likewise any number of pumps can be implemented anywhere in the convective coolant 214 flow path as long as the pump (pumps) keep the convective coolant 214 flowing at the desired times.

Option 8, thrust chamber materials/processes of construction: The thrust chamber 102 can be made with any materials or processes that can create shell and other structures of the appropriate size, geometry, and structural strength and that allow the heat absorbed by the thrust chamber 102 to be absorbed by the convective coolant 214 to the extent where the thrust chamber 102 will not get so hot as to melt or structurally fail due to material heating. Example materials for the thrust chamber 102 include, but are not limited to, copper, aluminum, steel, alloy steel, stainless steel, nickel, a nickel-based superalloy, brass, bronze and alloys and/or composites of all of the above materials, any combination of the above materials, or any material that has the strength and heat transfer requirements of any particular specific rocket engine. The example material of construction for the propulsion system 100 is an alloy of an Inconel® alloy. Inconel® is a registered trademark of Special Metals Corporation of New Hartford, N.Y. that refers to a family of austenitic nickel-based superalloys. Inconel® alloys are oxidation and corrosion resistant materials well suited for service in extreme environments. When heated, Inconel® forms a thick, stable, passivating oxide layer protecting the surface from further attack. Inconel® retains strength over a wide temperature range, which is helpful in implementations where aluminum and steel can soften. The heat resistance of Inconel® is developed by solid solution strengthening or precipitation strengthening, depending on the alloy. Plastics and reinforced plastics can be implemented where helpful.

Option 9, surface enhancements: The surface characteristics of the cold-wall of the inner shell 104 can be modified to increase the heat transfer coefficient (btu/in̂2-sec-deg F.) of the recirculating coolant system 114. A higher heat transfer coefficient apparatus that the inner shell 104 can absorb/conduct heat at a higher rate while having lower overall wall temperatures. The enhancements to the cold wall of the inner shell 104 include but are not limited to smoothing, roughing, sanding, sand blasting, grit blasting, shot peening, sputtering, and/or machining or forming grooves or patterns into the cold-wall as well as other methods. Another option is to plate or coat the cold-wall with a highly convective metal such as gold, silver, nickel, or copper. Still another option is to flame spray or plasma spray or use some other process (including painting) to install a metallic or other surface onto the cold-wall of the inner shell 104. These modifications and other types of surface enhancements can also be done to the surfaces adjacent to the cold-wall of the inner shell 104 (including those on the outer shell 106) in any combination with any other modification in order to achieve a required heat transfer coefficient or for the prevention of corrosion.

The hot-wall of the inner shell 104 can be modified to reduce heat flux conducting through the inner shell 104 to the convective coolant 214. In one implementation the inner shell 104 is fabricated from parent material as-is without any coatings. In another implementation, the hot-wall 204 is anodized for materials that can be anodized, such as aluminum. Anodizing creates and heat resistant oxide layer on the material that reduces the amount of heat conducted through the inner shell 104. In another implementation, a ceramic, metal, or composite layer is deposited on the inner shell 104 hot-wall 204 to reduce heat conduction. In still another implementation, resistance of the inner shell 104 hot-wall 204 to oxidation by combustion gases is increased by depositing a ceramic, metal oxide, metal nitride or carbide, or metal layer on the hot-wall 204 using flame spraying, plasma spraying, vapor deposition, plating, or any other deposition technique. Example metals that can be deposited on the hot wall are Inconel®, nickel, copper, brass, stainless steel, gold, silver, ceramics, metal oxides, metal nitrides, metal carbides, and others. Such materials can be applied to enhance corrosion resistance as well.

Finally, coating the thrust chamber 102 parent materials (includes the inner shell 104 and outer shell 106 and nozzle shell 26) can be helpful when required to protect the trust chamber 102 from the corrosive effects of the convective coolant 214 when applicable. As an example, an alternative is to coat the portions of the thrust chamber 102 that are in contact with the convective coolant 214 with a coating to protect the thrust chamber 102. As an example, with an aluminum alloy thrust chamber 102, the inner wall of the outer shell 106 and the cold wall of the inner shell 104 can be coated with gold plating to protect the inner shell 104 and the outer shell 106 from the effects of water as the convective coolant 214. Any process or coating material can be implemented so long as the protective effects are realized without inhibiting the convective coolant 214 from absorbing the heat that is conducting through the inner shell 104.

Option 10, cooling the convective coolant 214: After the convective coolant 214 has cooled the thrust chamber 102, the convective coolant 214 will have been warmed from the heat that the convective coolant 214 absorbed from the thrust chamber 102. As an option, the convective coolant 214 can be run through a heat exchanger 138 to cool the convective coolant 214 as the convective coolant 214 is being pumped back to the coolant feed tank 112. The heat exchanger 138 can be located anywhere in the convective coolant 214 flow loop 114. The heat exchanger 138 can take the form of a coiled tube(s), a coiled and finned tube(s), straight tubes, straight finned tubes, or any other configuration that is suitable for cooling the convective coolant 214. The fluids implemented to cool the convective coolant 214 are one or both of the rocket engine main propellants (main fuel 103 and oxidizer 105 or the propulsion systems pressurant gas). To cool the convective coolant 214 the heat exchanger 138 can be located at one of several possible locations: inside the main oxidizer tank, inside the main fuel tank, inside both main propellant tanks, inside the main pressurant gas tank, inside the main oxidizer feedline (that feeds the engine), inside the main fuel line (that feeds the engine), inside the main pressurant gas line (that pressurizes the main propellant tanks), or wrapped around the outside of the main fuel, oxidizer, or pressurant gas lines or a portion of either or both main propellants can be routed to the heat exchanger 138 by a separate line. Any combination of lines can be implemented. If the heat exchanger 138 is located inside one of the propellant tanks, a small pump that is operable to pump main propellant over the heat exchanger 138 to absorb heat from the convective coolant 214. A portion of either or both of the main propellants (main fuel 103 and oxidizer 105) can be diverted, with a pump or pressure, into the heat exchanger 138 to cool the convective coolant 214 and then is dumped overboard the rocket vehicle or is rediverted to feed or cool the engines. The heat exchanger 138 is an option to operate the cooling system. The heat exchanger 138 can be of any location and configuration using any fluid within a rocket vehicle or system so long as the heat exchanger 138 absorbs the heat the convective coolant 214 has absorbed in the thrust chamber 102. The possible heat exchanger 138 configurations include spraying one or both of the main propellants (main fuel 103 and oxidizer 105) on the heat exchanger 138 to absorb heat.

In those recirculating cooling systems that opt to use no heat exchanger 138 the convective coolant 214 throughout the cooling system will steadily increase in temperature as the engine runs. If convective coolant 214 is also being expended (such as in cooling the expansion nozzle 118) then at the moment the convective coolant 214 reaches its maximum temperature (as will the thrust chamber 102) the coolant feed tank 112 should be empty or near empty.

Closed loop option: If enough of the main propellants (main fuel 103 and oxidizer 105) can be implemented to cool the convective coolant 214 so that all of the heat absorbed by the convective coolant 214 in the thrust chamber 102 is then absorbed by the one or both of the main propellants (main fuel 103 and oxidizer 105) and/or pressurant gas, then the convective coolant 214 can release most or all of the heat absorbed by the convective coolant 214 in the thrust chamber 102. Thus, only a very small amount of the convective coolant 214 running in the totally closed recirculating cooling system is required to cool the thrust chamber 102. Having a small amount of the convective coolant 214 running in the totally closed recirculating cooling system, either no coolant feed tank 112 or only a small coolant feed tank 112 is required. Thus, the average overall temperature of the convective coolant 214 can not increase or increase significantly (having given absorbed heat of the convective coolant 214 to the main propellant/propellants, or pressurant gas) thus the convective coolant's 214 coolant feed tank 112 can be very small or absent as compared to a system where convective coolant 214 is being dumped overboard (from a rocket engine or rocket vehicle) or is being implemented to cool the expansion nozzle 118 as a film coolant.

Option 11, gap spacing: There are many options of maintaining the gap 110 between the inner shell 104 and outer shell 106. The gap 110 can be void with no structures or solid items in the gap 110; or for example, spacers can be located in the gap 110 of any geometry, size, or material; the gap 110 can have ribs or spacers that are formed, machined, or bonded on the cold wall of the inner shell 104 and/or the inner wall of the outer shell 106; the gap 110 can include ribs or spacers that are loose but installed in the gap 110; the gap 110 can include ribs or spacers that are bonded or secured to the inner shell 104 and outer shell 106 using any methods. Spacing of the gap 110 can be maintained by rivet, bolt, or screw heads, rivets, bolts or screws that protrude through the outer shell 106, but have their heads within the gap 110, the heads acting as spacers and the inner shell 104 and outer shell 106 being unattached to each other except at their ends. The rivets, bolts or screws are sealed against the outer shell 106 to prevent convective coolant 214 leakage with solder, braze, or polymer sealant but any sealing method will do so long as the sealing method does not impair the heat absorbing ability of the recirculating cooling system, nor the structural integrity of the rocket engine.

The inner shell 104 and outer shell 106 can be only attached to each other directly or indirectly at their ends, or they can be secured to each other intermittently across their surfaces with rivets, bots, welded studs, welding, brazing, or by other apparatus. Securing the inner shell 104 and outer shell 106 to each other can prevent the inner shell 104 from collapsing from higher convective coolant 214 pressures in the gap 110. When the inner shell 104 and outer shell 106 is secured to each other, the gap 110 can be prefilled with convective coolant 214 at full operating pressure without the use of valve timing to prevent the collapse of the inner shell 104.

The inner shell 104 and outer shell 106 can be replaced by a thrust chamber 102 made of bundled tubes much in the same way as conventional regenerative cooled rocket engines, or the thrust chamber 102 can be made like other regenerative cooled rocket engines utilizing rectangular or semi-rectangular coolant channels that are formed or sealed with electroplating, plasma spraying, or other methods.

As long as the convective coolant 214 can absorb the heat conducted to the convective coolant 214 by the rocket engine and as long as the rocket engine can maintain adequate structural integrity to perform the mission of the rocket engine, a simplified thrust chamber 102 structure can be implemented as shown in FIGS. 1-2 and 5 (and others) or a more complicated thrust chamber 102 that is similar to conventional regenerative cooled rocket engines can be implemented.

So, for a simple shell-structure thrust chamber 102 the inner shell 104 and outer shell 106 can be free floating from each other (i.e. secured to each other only at their ends, either directly or indirectly), or can have any type of rib or spacer in the gap 110 made of any material that is compatible with the convective coolant 214 and secured using any methods, or the inner shell 104 and outer shell 106 can be secured to each other intermittently across their surfaces using any method including bolts, rivets, studs, welding, brazing, soldering, and bonding of any kind, including adhesive bonding.

Option 12, valve usage: The basic recirculating cooling system of the systems, methods and apparatus described herein utilizes a thrust chamber 102, a recirculating pump, convective coolant 214, and a heat exchanger 138 or a coolant feed tank 112 or both a coolant feed tank 112 and a heat exchanger 138 and, of course, pipe or tubing to connect these components together. Any valves in the system are optional and can be added to improve coolant handling, loading, and draining, system operation and timing, safety, minimizing convective coolant 214 quantity, and/or to prevent collapse of the inner shell 104 in implementations where the maximum gap 110 pressure is at a higher pressure than the minimum collapse pressure of the inner shell 104. The optional valves include manual valves, pyrotechnic valves, guillotine valves, blade valves, actuated valves, relief valves, check valves, and others, and can be located anywhere in the convective coolant 214 system to achieve the desired results.

Option 13, pump or pressure fed: A rocket thrust chamber 102 recirculating cooling system can be implemented to cool any type of rocket engine thrust chamber 102 whether the engine has main propellants (main fuel 103 and oxidizer 105) fed as a pressure-fed rocket engine (i.e. main propellants fed to the engine solely by pressurizing the main propellant tanks) or as a pump-fed rocket engine (i.e. where the main propellants are fed to the engine by a pump or pumps, usually but not always turbopump(s). The thrust chamber 102 recirculating cooling system can operate completely independently of a turbopump system making development of both systems easier and less costly.

Option 14, convective coolant 214 flow direction: The convective coolant 214 can flow in either the ‘up’ or ‘down’ directions or in any other direction, including sprirally (i.e. circumferentially), as long as the convective coolant 214 can adequately cool the thrust chamber 102. That is, the convective coolant 214 can start at the expansion nozzle 118 and flow upwards towards the main propellant injector 116 as previously described, or the convective coolant 214 can start flowing near the main propellant injector-end of the engine and flow downward towards the expansion nozzle 118 before being routed back to the coolant feed tank 112 or routed to both the coolant feed tank 112 and expansion nozzle 118 as film coolant. In the example of propulsion system 100, the convective coolant 214 passes in and/or out of the gap 110 from an entry point 142 into a first location 144 of the gap 110 and an exit point 146 at a second location 148 in the gap 110.

Option 15, phase of convective coolant 214: The convective coolant 214 can perform a cooling function in the liquid phase (all liquid), as a nucleate boiling liquid (i.e. with collapsing bubbles), as a boiling liquid (two phase fluid), as a supercritical fluid, or in the gaseous state (as a gas or vapor), or in any combination of these three fluid states. Another option is to pre-chill the convective coolant 214 prior to use of the convective coolant 214 in cooling the thrust chamber 102. The convective coolant 214 can be pre-chilled by continuing to cool the convective coolant 214 before or after loading the convective coolant 214 into the coolant feed tank 112, or by cooling the convective coolant 214 with a heat exchanger 138 with one or all of the rocket engine primary propellants as described above for cooling convective coolant 214 after the convective coolant 214 has absorbed heat from the thrust chamber 102. Pre-cooling the convective coolant 214 will allow the convective coolant 214 to absorb more heat from the thrust chamber 102 prior to boiling, thus less convective coolant 214 flow rate is achievable and likewise less total quantity of convective coolant 214 is required.

Option 16, cooling injectors: In addition to cooling any portion of the thrust chamber 102 and/or the expansion nozzle 118 the convective coolant 214 can be implemented to cool any portion of the main propellant injector 116. In some implementations, the gap 110 is between less than the entirety of the inner shell 104 and the outer shell 106 and the convective coolant 214 recirculates through a portion of the thrust chamber 102.

17.) Option 17, coolant feed tank pressure control: In implementations where the coolant feed tank 112 is operated at a pressure that is higher than the critical collapse pressure of the inner shell 104 then, as described herein, the opening speed of the coolant isolation valve 124 and the pressure isolation valve 136 controls the pressure in the gap 110 to prevent the gap 110 from coming up to full system pressure until after the engine has started and the combustion chamber 122 has come up to enough pressure to prevent the inner shell 104 from collapsing. The pressure isolation valve 136 controls the pressure in the gap by controlling the coolant isolation valve 124 and the pressure isolation valve 136 such that the combustion chamber pressure rises slightly faster than the gap 110 pressure and is thus always higher than the gap 110 pressure or at least is at a pressure that will not cause collapse or buckling of the inner shell 104. An alternative to operating the coolant isolation valve 124 and the pressure isolation valve 136 is pressurizing the coolant feed tank 112 to prevent collapse of the inner shell 104. In pressurizing the coolant feed tank 112, the coolant feed tank 112 pressure is kept below the collapse pressure of the inner shell 104, but the coolant feed tank 112 pressure is increased to full operating pressure only after the engine has started and the combustion chamber 122 is at a high enough pressure to prevent inner shell 104 collapse. Valves of any type can be implemented in the recirculating cooling system 114 to control the coolant feed tank 112 pressure to prevent collapse of the inner shell 104. At the end of the engine operation the pressure of the coolant feed tank 112 (and thus of the recirculating cooling system 114) is decreased to prevent inner shell 104 collapse as the combustion chamber 122 pressure comes down, or the inner shell 104 is simply allowed to collapse (i.e. the pressure of the coolant feed tank 112 is not decreased) because the engine has performed its mission.

Yet another option is to simply have the coolant feed tank 112 pressure constantly below the collapse pressure of the inner shell 104 so collapse of the inner shell 104 is not possible at any time during cooling system operation.

Option 18, processes and materials: The thrust chamber 102 is made of a thin sheet metal or sheet metal composite. The thin sheet metal or sheet metal composite can be made to any wall thickness depending on the size and combustion chamber pressure of the engine, but 0.020″ to 0.125″ is typical, but the thicknesses can also range from 0.010 inches to 0.50 inches. Other thicknesses can be implemented as well. These shell thicknesses do not include thickness of any ribs, stiffeners, or other hardware formed into or installed onto the shells. Any process or material or combination of these can be implemented to make the thrust chamber 102 (or other system hardware) as long as the thrust chamber 102 is of the appropriate thickness to take the structural and pressure loading of the thrust chamber 102 and will sufficiently conduct heat through the inner shell 104 to the convective coolant 214. Possible materials for the thrust chamber 102 include but are not limited to Inconel®, stainless steel, steel, alloy steel, copper, aluminum and alloys or composites of all of these materials or other materials. The outer shell 106 can be reinforced by wrapping the outer shell 106 in a composite material such as a filament wound overwrap such as graphite/epoxy, Kevlar/epoxy, or glass/epoxy or their equivalents or any other type of fiber/matrix composite either as a filament or tape winding or as a composite material cloth that is bonded or secured to or encircles the exterior surface of the outer shell 106. In addition, metallic stiffening ribs or structures can be welded, brazed, bonded, or soldered to the outer shell 106 to stiffen and strengthen the thrust chamber 102. In some implementations of the thrust chamber include formed composite ribs and structures of any geometry that are bonded or secured to the exterior surface of the outer shell 106 for the same purpose (of strengthening or stiffening the thrust chamber 102). Any structure can be added to the outside surface of the thrust chamber 102 to strengthen or stiffen the outside surface of the thrust chamber 102 because these structures do no effect the functioning of the cooling system presented here.

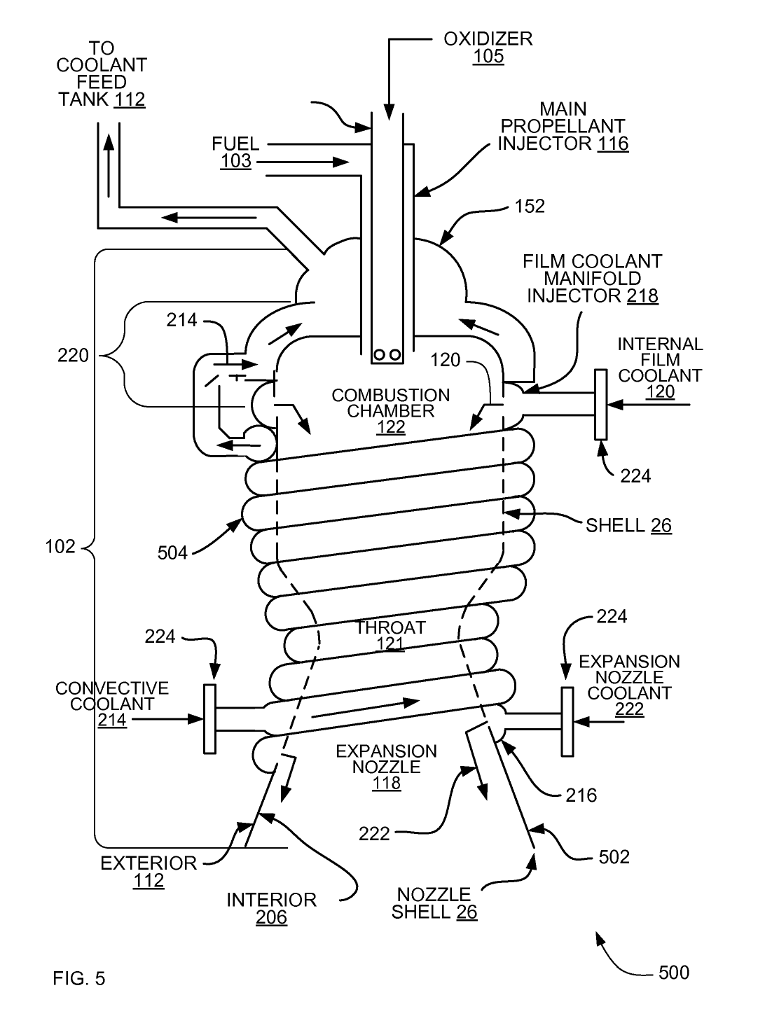

Option 19, a propulsion system having a single shell as described in greater detail in FIG. 5.

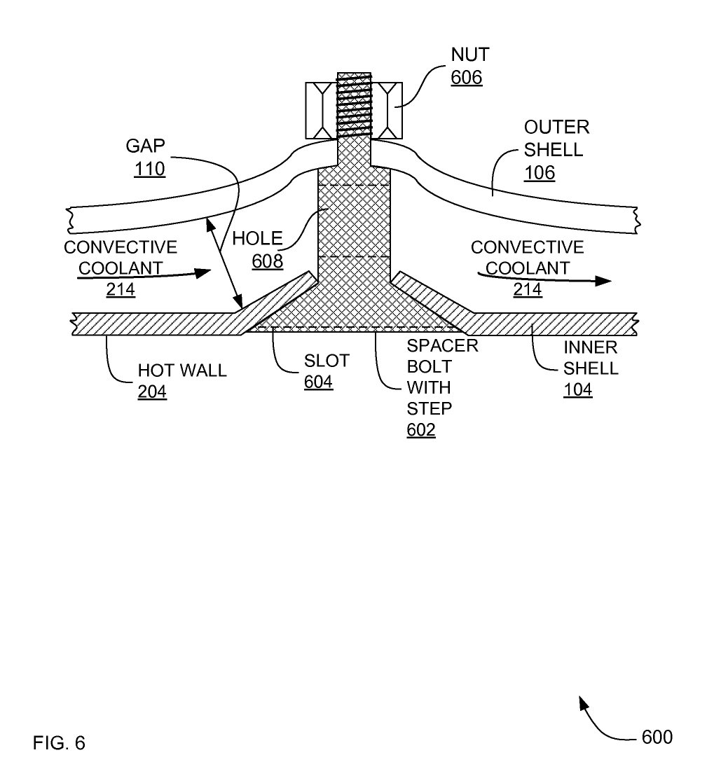

Option 20, a spacer bolt arrangement to connect the inner shell 104 to the outer shell 106 to prevent collapse of the inner shell 104, as described in greater detail in FIG. 6 below.

Option 21: Hybrid and Solid propellant rockets: The thrust chamber 102 recirculation cooling system can be implemented to liquid bi-propellant rocket engines and the thrust chamber 102 recirculation cooling system can be implemented in any rocket systems utilizing any number of propellants. Some implementations include monopropellant systems and liquid rocket systems with two or more propellants. In addition, the thrust chamber 102 recirculation cooling system can be implemented in hybrid and solid propellant rockets and rocket systems. Solid propellant rockets utilize propellant that is solid in form similar in consistency as an automobile tire. In hybrid rockets at least one of the propellants is a solid and at least one of the propellants is a liquid. In solid propellant rockets, additional tankage, plumbing, and valves can be added to deliver the convective coolant 214 and internal film coolant 210 to the solid propellant rocket's thrust chamber or nozzle. The same can be added to a hybrid propellant rocket unless the liquid propellant in the hybrid system can be implemented for either the internal film coolant 210 or the convective coolant 214 or both.

Option 22: Throat/Expansion Nozzle Plug: As an option to valve control and timing or more attach points (between the inner and outer shells) to prevent collapse of the inner shell 104 a plug can be put in or near the throat 121 or in the expansion nozzle 118. The plug would allow the combustion chamber 122 and/or complete thrust chamber 102 to be pressurized with gas to the point where the inner shell 104 will not collapse when the gap 110 is at full pressure before the engine has started. Upon engine start, the plug would be ejected from the engine whole or would break apart and then be ejected after which the thrust chamber 102 would be at a full operating pressure, and thus buckling of the inner shell 104 would be avoided.

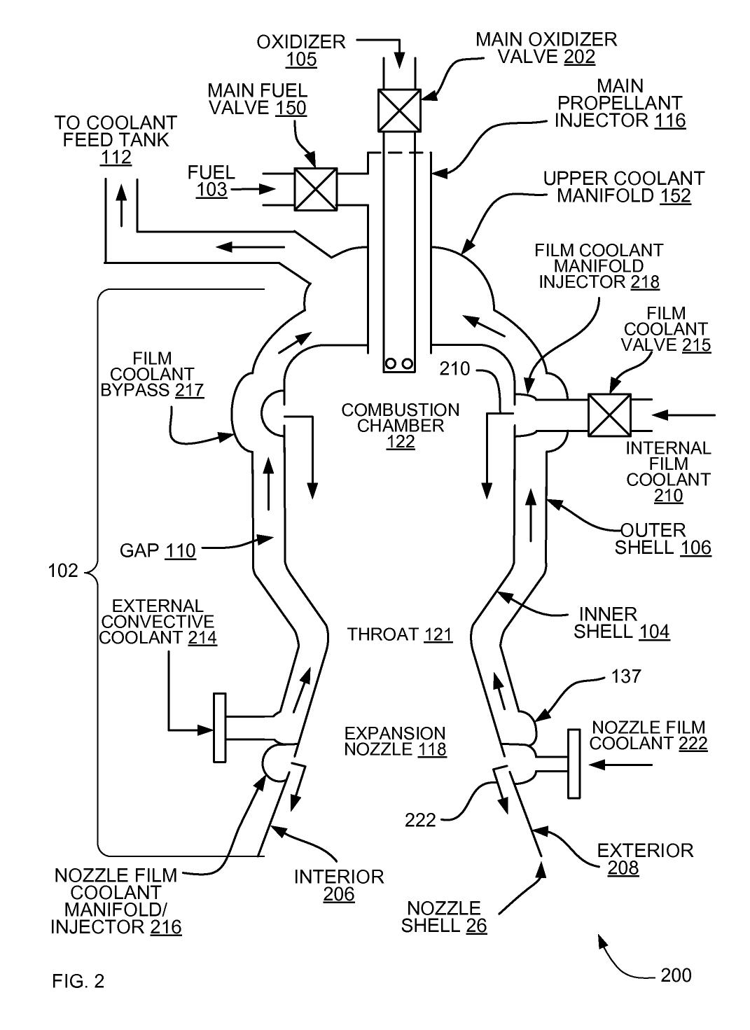

FIG. 2 is a cross section side-view block diagram of a rocket engine assembly 200. Rocket engine assembly 200 includes a rocket engine thrust chamber cooling system that does not require extensive machining, custom tooling and fabrication custom processes.

Rocket engine assembly 200 includes a thrust chamber 102 having an outer shell 106 and an inner shell 104 with an inside hot-wall 204. The thrust chamber 102 is the combination of the combustion chamber 122 and the expansion nozzle 118. The portion of the expansion nozzle 118 that is exclusively film cooled has an interior wall 206 and has an exterior 208. The inside wall of the combustion chamber is also known as the “hot-wall 204” or the “hot-gas-side” wall. The thrust chamber 102 outer shell 106 and inner shell 104 are thin metal structures that form the most significant, but not only, structural element that forms the thrust chamber.

The thrust chamber 102 is the portion of the rocket engine that is downstream of a main propellant injector 116 but also includes the thrust chamber dome 220. In some implementations, the main propellant injector 116 is a pintle injector as shown in FIGS. 1 and 2. The main propellant injector 116 is operably coupled to the thrust chamber 102. The main propellant injector 116 is also operable to inject a fluid of the main propellants (main fuel 103 and oxidizer 105) into the interior volume surrounded by the hot-wall 204 of the thrust chamber 102 and in some implementations an internal film coolant 210 is injected and in some implementations the internal film coolant 210 is not injected onto the hot-wall 204. If the main propellant injector does not inject the internal film coolant 210 then that coolant can be injected by a separate film coolant manifold injector 218 that injects only internal film coolant 210 as shown in FIG. 2. The fluid main propellant includes oxidizer 105 and fuel 103. The fluid flowing into and through the thrust chamber includes the oxidizer 105, fuel 103 and any additional cooling fluids and internal film coolant 210. The internal film coolant 210 is often known as “coolant A.” The main propellants (main fuel 103 and oxidizer 105) can be a mono-propellant, or a plurality of main propellants.

When injected, the internal film coolant 210 spreads into a thin film on the inside wall 204. The function of internal film coolant 210 is two-fold: 1) to absorb heat directly as a coolant, thus reducing heat flow to the inner shell 104 (and reducing shell temperature), and 2) to deposit carbon in the form of “carbon black” or soot on the inner surface of the thrust chamber 102 (i.e. a process called “coking”), the soot being an insulator with very low thermal conductivity and will greatly reduce the amount of heat that flows into the thrust chamber 102 walls (and into the convective coolant 214 described below). The internal film coolant 210 can also be a non-coking fluid which absorbs heat but does not deposit carbon, or the internal film coolant is included in implementations that do not implement film cooling.

The main propellant injector 116 is similar to a showerhead that sprays liquid propellants, such as an oxidizer 105 of liquid oxygen and a fuel 103 of jet fuel, into the combustion chamber 122 where the oxidizer 105 and fuel 103 are burned. After combustion, the burned propellants expand in the expansion nozzle 118 where the burned propellants increase to high velocity and produce thrust. The internal film coolant 210 provides protection from excessive heat by introducing a thin film of coolant or propellant through orifices around the injector periphery or through manifolded orifices (as shown in FIG. 2 and FIG. 5) in the thrust chamber inside wall on or near the main propellant injector 116 or chamber throat region 121 or anywhere else in the thrust chamber 102 where internal film coolant is needed or desired.

In addition to the main propellant injector 116, engine assembly 200 includes a thrust chamber 102 having an outer shell 106 and an inner shell 104 with a convective coolant 214 flowing between the two shells in a gap 110. The convective coolant 214 is often known as “coolant B.”

Engine assembly 200 also includes an expansion nozzle film coolant manifold injector 216 that is operably coupled to the expansion nozzle 118. The injector 216 is operable to inject the convective coolant 214 onto the interior wall 206 of the expansion nozzle 118 as a nozzle film coolant 222.

A film coolant bypass 217 is included to circumscribe a film coolant manifold 218. A dome 220 is a double shell dome as the baseline configuration of the systems, methods and apparatus as shown in FIG. 2. The flanges 224 shown in FIGS. 2 and 5 are only example connection points and can be any connection method that is compatible with the required flow rate, temperature, and pressure.

As shown in FIG. 1 and FIG. 2, convective coolant 214 starts flowing in the gap 110 between the thrust chamber 102 inner shell 104 and outer shell 106 starting at the expansion nozzle 118 at any area ratio, but an area ratio of 2 to 4 can be considered typical. The convective coolant 214 flows to the thrust chamber 102 due to pressure in the coolant feed tank 112 (FIG. 1). Flow of convective coolant 214 is initiated by opening the coolant isolation valve 124 and the pressure isolation valve 136 and by starting the recirculation pump 108. When the convective coolant 214 enters the thrust chamber 102 gap 110 at an entry point 142, of the thrust chamber 102, the convective coolant 214 flows upward until the convective coolant 214 reaches the top of the combustion chamber 122, after which the convective coolant 214 exits from the gap at exit point 146 and then is pumped back to the coolant feed tank 112 for reuse again as a convective coolant 214 or as an nozzle film coolant 222. Some of the convective coolant 214 is directed downward to the expansion nozzle 118, as in FIG. 1, where the convective coolant 214 (water as an example) is injected into the nozzle as an expansion nozzle film coolant 222 to cool that portion of the expansion nozzle 118 not cooled by the convective coolant 214 flowing between the outer shell 106 and inner shell 104, a portion of the baseline expansion nozzle 118 being made of a single shell (called the nozzle shell 26) downstream of the expansion nozzle film coolant manifold/injector 216 injection point. Other cooling methods for the nozzle shell 26 are possible such as dump, transpiration, radiation, ablative cooling and others.

The outer shell 106 and inner shell 104 of the thrust chamber 102 can be secured directly or indirectly to each other at their two ends (e.g. top and bottom ends) or the two shells can be secured to each other at many points throughout their surface area using any apparatus helpful including bolts, screws, rivets, welds, brazing, or any other apparatus. In addition, spacers and/or ribs of any configuration can be built into or added to the shells anywhere to maintain proper shell spacing and/or to ensure sufficient shell structural characteristics.

To strengthen the thrust chamber structure, the outer surface of the outer shell 106 can be overwrapped with filament winding or other composite material including, but not limited to graphite/epoxy, Kevlar/epoxy, glass/epoxy, metal wire/epoxy, and others including nonepoxy based composites.

The inner and outer shell(s) 104, 106 can be fabricated using conventional methods of shell fabrication. The shell has sufficient strength and heat conductivity needed to conduct heat to the external convective coolant 214 without overheating and/or failure. Methods of shell construction include, but are not limited to, spinning, welding, stamping, punching, extruding, explosive forming, drawing, plasma spraying, electroplating, brazing, riveting, and other methods. The materials and processes disclosed herein can be implemented in the nozzle shell 26.

As an option for construction of the thrust chamber 102, the thrust chamber can be fabricated in a similar way to a conventional regenerative cooled thrust chamber: with numerous parallel coolant tubes brazed, electroplated, welded, or soldered together (or other methods) with or without a metal jacket or filament overwrapping on the exterior surface. Or, the thrust chamber 102 can be fabricated like another type of regenerative cooled thrust chamber using cooling channels as opposed to tubes and fabricated using electroplating, plasma spraying, or other methods.

A top portion of the combustion chamber 122 is known as a dome 220. The dome shown in engine assembly 200 is a double-walled thrust chamber dome 220 with water (i.e. convective coolant 214) flowing between the two walls of the double-walled dome 220 and cooling the dome 220. The water flows from the gap between the outer and inner shells 106, 104 of the combustion chamber below to the interior of the double-shell of the dome and then the water is pumped back to the coolant feed tank 112. The dome 220 can either be a simple double-shell where both walls (or shells) of the dome 220 are unattached to each other (except at the ends), or the two walls can be attached to each other with rivets, bolts, welding, brazing, electroplating, or plasma spraying, or any other process. The dome 220 can also have coolant flow channels, ribs, or spacers fabricated or installed into the dome 220, or no channels at all. In rocket engines that do not exceed a particular temperature threshold, the dome 220 can be a single shell structure without any additional cooling mechanism.

The proportions of the internal film coolant 210 and convective coolant 214 provide for a high degree of thrust while maintaining relatively low temperatures in the thrust chamber 102. Cooling of the thrust chamber 102 is accomplished while sustaining acceptably low values of losses to thrust. The combination of sufficiently high thrust and low temperatures avoids the need for a large number of expense expensive individual coolant tubes that are difficult to manufacture as is in conventional regenerative cooled rocket engines. The technology of the systems, method and apparatus disclosed herein greatly simplifies and expedites fabrication of the thrust chamber 102 using conventional and simple fabrication techniques, such as fabrication techniques that might include but are not limited to spinning, winding, stamping, welding, brazing, rolling, explosion forming, welding, and others.

In one example, the thrust chamber 102 can be manufactured using the following process:

1.) Select shell material for both inner shell 104 and outer shell 106.

2.) Anneal the shell material.

3.) Spin shell material into appropriate geometries including the dome, cylindrical section of the combustion chamber, the conical section, and the expansion nozzle.

4.) Anneal the spun shell components again.

5.) Machine the internal film coolant and expansion nozzle film coolant manifold/injectors.

6.) Weld thrust chamber shell components together. Install spacers and/or stiffeners as required.

7.) Grind off excess weld and heat treat shell structure as required.

In addition, the lower temperatures in the thrust chamber 102 avoid the need for thick walls of the thrust chamber. Thus systems 100 and 200 provide a simple thin metal shell structure as a thrust chamber 102, as shown in FIG. 1 and FIG. 2.

Rocket engine assembly 200 provides a low-cost fluid cooled rocket thrust chamber 102 that is easy to fabricate. Rocket engine assembly 200 includes a greatly simplified light-weight, fluid-cooled thrust chamber 102 that can be implemented in conjunction with any kind of rocket engine main propellant injector 116, and a very wide range of rocket engine thrust sizes and propellant combinations.

In one example, the amount of internal film coolant 210 that is introduced or injected into the inside wall 204 of the thrust chamber 102 is typically in a range of about 1% to about 10% of the total fluid flow to the engine (i.e. the fluid) but other values can be implemented. In another example, the amount of internal film coolant 210 that is introduced or injected onto the hot-wall 204 of the thrust chamber 102 is about 2.5% of the fluid. In yet another example, the amount of internal film coolant 210 that is introduced or injected onto the hot-wall 204 of the thrust chamber 102 is about 3.5% of the fluid. In yet a further example, the amount of convective coolant 214 that is introduced or injected onto the interior wall 206 of the expansion nozzle 118 is typically will fall in a range of 1% to 10% of the fluid but other values can be implemented. In still yet another example, the amount of internal film coolant 210 that is introduced or injected onto the hot-wall 204 of the thrust chamber 102 is about 3.5% of the fluid and the amount of convective coolant 214 that is introduced or injected onto the interior wall 206 of the expansion nozzle 118 is about 3.0% of the fluid. Typical expected values for both the internal film coolant 210 and the convective coolant 214 can be 3.5% and 3.0% of total fluid flow respectively.

The thrust chamber inside shell wall 204 is also known as a “hot wall” because the heat of the combustion is generated inside of the thrust chamber 102. More specifically, the heat of combustion is generated inside of the combustion chamber 122.

In FIG. 2, cooling of the expansion nozzle 118 is accomplished as follows: A portion of the convective coolant 214 flow rate is then injected as an expansion nozzle film coolant 222 onto and along the interior wall 206 of the expansion nozzle 118 in order to cool the expansion nozzle 118. The film coolant valve 215 can be branched off the convective coolant 214 line either upstream of the coolant isolation valve 124 or downstream of the thrust chamber 102 and upstream of the heat exchanger 138 or anywhere else in the convective coolant 214 system. Another option is to eliminate the film coolant valve 215 and simply have the nozzle film coolant feed off of the lower coolant manifold 137, or is fed from its own tube that branches off downstream of the coolant isolation valve 124. Because the expansion nozzle 118 is of low static pressure as compared to the combustion chamber 122, on the order of 10-30 times less, the pressure and boiling point ranges of the convective coolant loop 114 available with which the engine assembly 200 can be manufactured and operated are very broad. Therefore, pressure of the convective coolant 214, and in turn, heat absorbing capacity of the convective coolant 214, can be selected to optimize the amount of convective coolant 214 for a given type of engine. The broad range of the pressure of the convective coolant 214 at which the engine assembly 200 can be manufactured for and operated at provides a variety of operating scenarios such as increasing the convective coolant 214 system pressure in order to increase the heat absorbing capacity and thus decrease the flowrate and amount of convective coolant 214 that is required, or of decreasing the convective coolant 214 system pressure to decrease the tankage and pressurant gas weight of the convective coolant 214 in a “pressure-fed” rocket system or to decrease pumping horsepower requirements (if a system that uses a pump to pressurize the convective coolant 214 is implemented). Cooling the nozzle as described in FIG. 2 simplifies the implementation of a nozzle shell 26. The nozzle shell 26 is the portion of the expansion nozzle 118 that is downstream of the injection point of the expansion nozzle coolant 222 (convective coolant 214) in the expansion nozzle 118. In the example of FIG. 2, the nozzle shell 26 is fabricated as a single wall (shell) of a simple thin sheet metal or a metal or plastic composite material or other materials.

The pintle injector implementation of the main propellant injector 116 that is shown in FIGS. 1, 2, and 5 was originally developed in the early 1960's. The dome 220 of a propulsion system using a pintle injector is the top of the thrust chamber 102. The dome 220 in FIG. 2 is a double walled metal shell with convective coolant 214 flowing between the two walls similar to the rest of the thrust chamber 102. A single-walled dome with no convective coolant 214 flowing in the single-walled dome can be implemented if the single-walled dome is made of the appropriate material and that portion of the combustion chamber is operating at low enough temperatures (not always the case for every type of engine). The dome 220 of FIGS. 1, 2, 5, 12, and 19 can be dome-shaped, conical, flat, or other geometries.

An alternative to using a pintle main propellant injector 116 in a rocket engine is to use a flat-face main propellant injector similar to the main propellant injectors of the SSME, J-2, and F-1 liquid bi-propellant rocket engines. A flat-faced main propellant injector has a metallic structure with a flat side (i.e. the face) that has holes in the face for injecting the main propellants, the main fuel 103 and main oxidizer 105, into the combustion chamber 122 where main propellants, the main fuel 103 and main oxidizer 105 are burned. Overall, a flat-face injector looks similar to many bathroom showerheads. In addition to injecting the main propellants the flat-face injector can have a ring of small holes or slots around a periphery of the flat-face injector to inject internal film coolant 210 along the combustion chamber 122 hot-wall 204. Or, the film coolant can be injected from a separate film coolant manifold/injector 218 of the film coolant as shown with a pintle injector in FIG. 2. The main propellants can be a mono-propellant, or a plurality of main propellants.

In an engine that includes a flat-face main propellant injector, the thrust chamber cooling system of the engine is similar to that of the previously described cooling system for the pintle injector engine with the exception that there is no thrust chamber dome 220 to cool with the convective coolant 214. However, flat-face injector rocket engines can include a propellant dome or an oxidizer dome at the top of the thrust chambers 102. The propellant dome or oxidizer dome can direct propellant (usually the oxidizer) to a main propellant injector 116 and the propellant dome or oxidizer are not positioned in the thrust chamber 102 in a location that exposes the propellant directly to hot combustion gases. Such structures are not implemented with a thrust chamber dome 220. The propellant can be a mono-propellant, or a plurality of propellants.

The systems, methods and apparatus described herein are not limited by particular implementations. For example, variations of the thrust chamber 102, which can include any of variety of geometries of combustion chamber 122 including the conventional cylindrical combustion chambers or spherical combustion chambers, such as in the German WW2 V2 rocket engine.

In other examples of non-limiting variations, the convective coolant 214 can flow in the either the “up” or “down” directions. More specifically, as shown in FIG. 1, 2, and 5, the convective coolant 214 that flows in the gap can begin at the expansion nozzle 118 and flow upwards towards the main propellant injector 116 (i.e. counter-current flow), or the convective coolant 214 can begin flowing near the injector-end of the engine and flow downward towards the expansion nozzle 118.

In other examples of non-limiting variations, the convective coolant 214 is circulated in the gap between the outer and inner shells 106, 104 in a liquid state, as a boiling liquid (two phase fluid), as a supercritical fluid, or in a gaseous state (as a gas or vapor), or in any combination various fluid states.

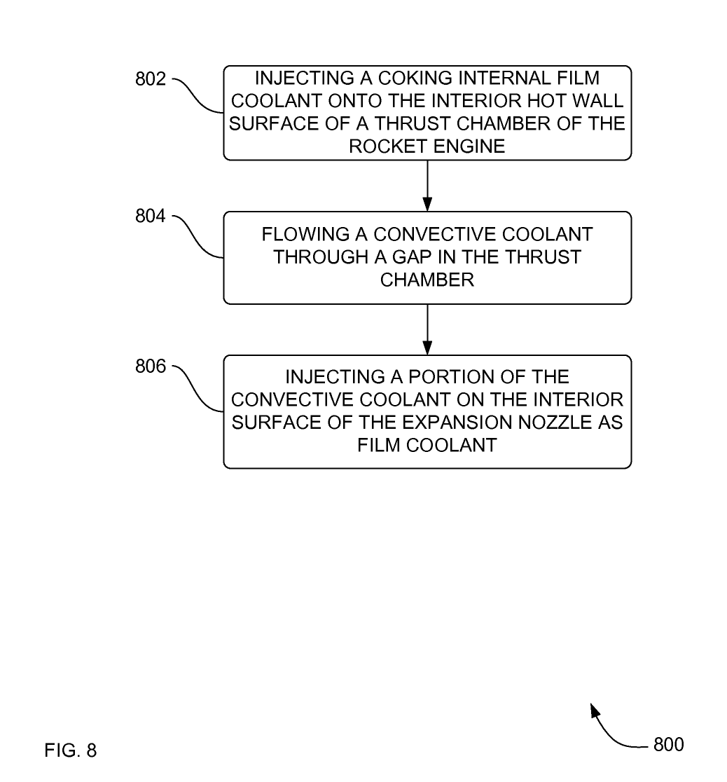

In other examples of non-limiting variations, either or both of the internal film coolant 210 and the convective coolant 214 can be different types of fluid than those that make up the main propellants (main fuel 103 and oxidizer 105). In one aspect briefly described in FIG. 1, dual coolants are implemented for the internal film coolant 210 and the convective coolant 214. For example, in a liquid oxygen/hydrogen engine, the internal film coolant 210 can be one of many different coking fluids, and the convective coolant 214 can be hydrogen, water or other non-coking fluid, that is the convective coolant 214 is non-coking at the maximum temperature is achieves when in the gap 110. The dual coolants are described in greater detail in conjunction with FIG. 8 below. In some implementations, hydrogen is included in the internal film coolant 210. The main propellants can be a mono-propellant, or a plurality of main propellants.

While the engine assembly 200 is not limited to any particular thrust chamber 102, hot-wall 204, combustion chamber 122, expansion nozzle 118, expansion nozzle interior 206, expansion nozzle exterior 208, nozzle film coolant 222, main propellant injector 116, oxidizer 105, fuel 103, main fuel valve 150, main oxidizer valve 202, film coolant valve 215, internal film coolant 210, outer shell 106, inner shell 104, a convective coolant 214 and an expansion nozzle film coolant manifold/injector 216, film coolant bypass 217, thrust chamber dome 220, for sake of clarity a simplified thrust chamber 102, hot-wall 204, combustion chamber 122, expansion nozzle 118, expansion nozzle interior 206, expansion nozzle exterior 208, main propellant injector 116, oxidizer 105, fuel 103, main fuel valve 150, main oxidizer valve 202, film coolant valve 215, internal film coolant 210, outer shell 106, inner shell 104, a gap 110, an convective coolant 214, nozzle film coolant 222, and an expansion nozzle film coolant manifold/injector 216, film coolant bypass 217, thrust chamber dome 220 are described.

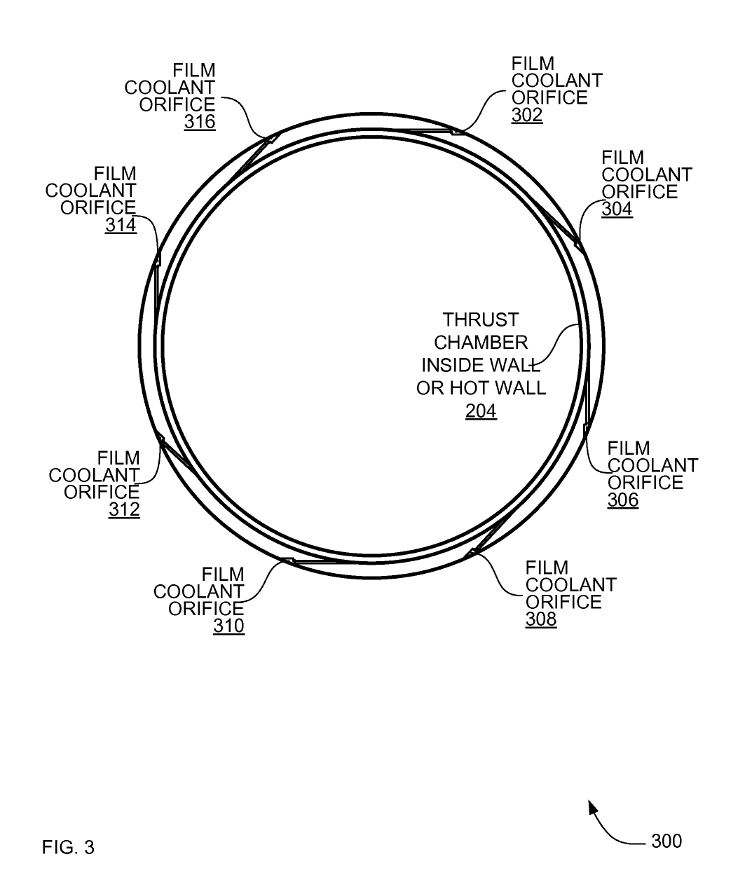

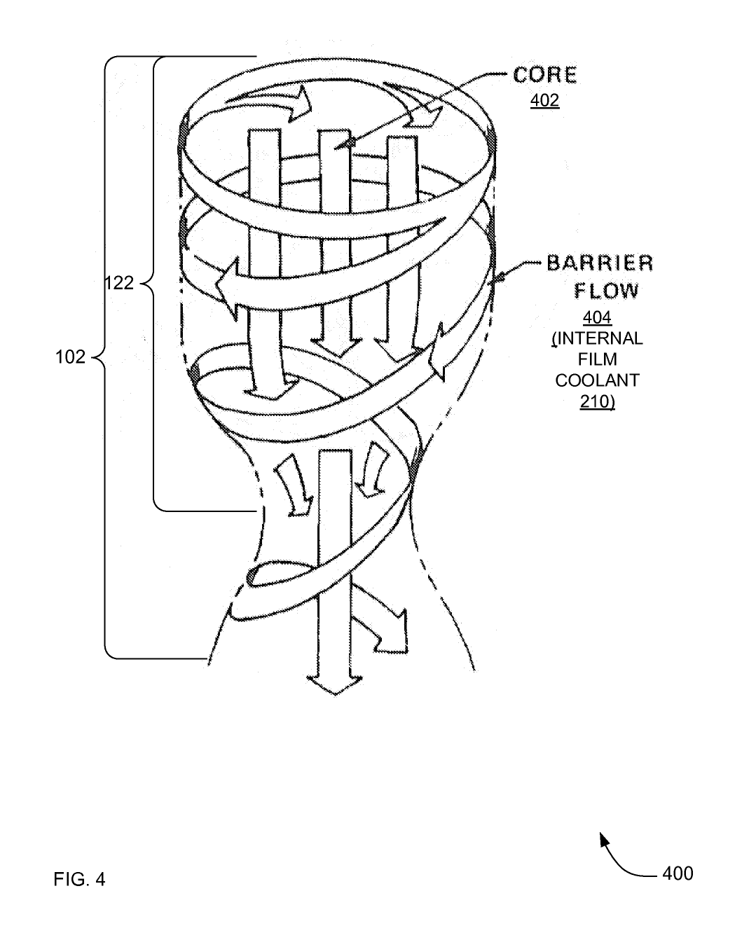

FIG. 3 and FIG. 4 show examples of a vortex injection pattern for internal film coolant 210 injection onto a hot chamber wall. Other patterns and methods for injecting internal film coolant 210 or nozzle film coolant 222, are also possible.

FIG. 3 is a cross section top-view block diagram of combustion chamber 122 apparatus 300 having film coolant injection orifices. Apparatus 300 helps provide for a lightweight rocket engine of any size while using low-cost fabrication methods and inexpensive, non-exotic materials. Thus, apparatus 300 simplifies and expedites the production of a fluid-cooled rocket engine thrust chamber 102. Apparatus 300 helps solve solves the need in the art for a thrust chamber made of less expensive materials and manufacturing processes.

Apparatus 300 includes one or more film coolant orifices that inject a internal film coolant fluid 210 onto the hot-wall 204 of a thrust chamber 102. In some implementations, the fluid is convective coolant 214 that is injected onto the interior wall 206 of the expansion nozzle 118 as an nozzle film coolant 222. Apparatus 300 includes eight film coolant orifices 302, 304, 306, 308, 310, 312, 314 and 316. However the orifices can be any geometry, number, size, or orientation, and can be located any where in the thrust chamber where coolant is needed. The internal film coolant fluid can be any coking fluid or non-coking fluid.

The injection of the fluid through the orifices and onto the inside wall of the thrust chamber 102 maintains the inside wall at modest temperatures, such as temperatures below 1000 degrees Fahrenheit. Temperatures below 1000 degrees Fahrenheit do not require exotic, rare, or expensive materials. Instead, low-cost and readily available materials that maintain their strength at low-to-medium temperatures (below 1000 degrees Fahrenheit) can implemented for the thrust chamber. For example, the thrust chamber 102 can be made of aluminum, steel, alloy steel, stainless steel, Inconel®, copper, bronze, alloys thereof, mixtures thereof, and metal composites and plastic composites. In some implementations, the thrust chamber can be made of aluminum, stainless steel, Inconel®, alloys thereof and mixtures thereof. In some implementations, the thrust chamber can be made of Inconel®. Inconel® is a registered trademark of Special Metals Corporation of New Hartford, N.Y., referring to a family of austenitic nickel-based superalloys.

The relatively low temperatures in the thrust chamber 102 also allows for a thrust chamber having a shell wall thickness typically (but not always) of between about 0.020 inches and about 0.125 inches but can range from 0.010 inches to 0.50 inches. Other thicknesses can be implemented as well. In some implementations, the wall thickness of the thrust chamber 102 shells is between about 0.06 and about 0.07 inches. In some implementations, the thrust chamber 102 shell wall thickness is about 0.030 inches.

The thrust chambers of FIG. 1 and FIG. 2 are less elaborate than conventional fluid cooled chambers, and operate at low-to-medium inner surface temperatures on the inside wall 204 (i.e. below about 1000 degrees Fahrenheit), approximately the exhaust temperature of high-performance internal combustion automotive engines, so that low-cost materials which can have low strength at elevated temperatures (i.e. above 1000 degrees Fahrenheit) can be implemented in the composition of the thrust chamber 102. Thus, the thrust chamber 102 is much easily produced by many more potential low-cost, low-overhead, commercial vendors that currently exist in industry.

FIG. 4 is an isometric block diagram of a thrust chamber 400 that shows a swirling barrier flow 404 of a layer of internal film coolant 210 along the thrust chamber 102 hot-wall 204. In FIG. 4, internal film coolant 210 is injected tangentially into the combustion chamber of the thrust chamber 400. Core flow 402 from main propellants (main fuel 103 and oxidizer 105) is inside the swirling barrier flow 404 and parallel to the engine's longitudinal axis. Any method of injecting the internal film coolant 210 into the combustion chamber of the thrust chamber 400 can be implemented that distributes the internal film coolant 210 over those areas requiring film coolant. The main propellants can be a mono-propellant, or a plurality of main propellants.

In comparison, tangential injection of fluid shown in FIG. 3 creates a swirling barrier flow 404 (FIG. 4) of the internal film coolant 210 layer against or along the thrust chamber inside hot-wall 204. The swirling barrier flow 404 can also be described as a vortex flow resulting from the injection method shown in FIG. 3.

As an alternative to cooling the thrust chamber dome 220 with wrapped coiled external coolant tubes 504 or a double-wall dome, the dome 220 can be cooled with a conventional ablative material mounted to the inside surface of the dome 220. In another option the thrust chamber dome 220 can be transpirationally cooled (as in conventional transpiration cooling), or the thrust chamber dome can be uncooled if the main propellant injector 116 causes the steady-state temperature of the dome to be low enough to operate without a cooling system.

FIG. 5 is a cross section side-view block diagram of an alternative configuration of a propulsion system engine 500 having a shell 502 and a spiraled coolant tube instead of a gap between two shells. FIG. 5 shows a thrust chamber 102 cooling system arrangement in which instead of having an inner shell 104, outer shell 106, and gap 110, a single shell 502 is included. Engine 500 has one or more external convective coolant tubes 504 wrapped around the shell. The convective coolant tube 504 can be brazed, soldered, welded or bonded to the shell 502 by other apparatus. The dome 220 is a double shell dome as the baseline configuration of the systems, methods and apparatus described herein but can also be a single shell dome 220 with a convective coolant tube 504 wrapped around the single shell dome 220 and bonded to the single shell dome 220. Although somewhat different than the double shell configuration with a gap 110, the propulsion system 500 functions in the same way in that convective coolant 214 flows through the convective coolant tube(s) 504 instead of a gap 110. Like the dual-shell configuration (sometimes called double-wall configuration), the single shell/tube configuration utilizes optional internal film coolant 210. A film coolant bypass 217 is included in the coolant tubes 504 to circumscribe a film coolant manifold/injector 218.

Although FIG. 5 shows a single convective coolant tube 504, in other examples of non-limiting variations, the one or more coolant tube(s) 504 wind around the thrust chamber 102; two, several, or more coolant tube(s) 504 can be wound around the thrust chamber 102 in parallel to each other; or, alternatively, a small number of stacked tubes (toruses) can be connected together by two (or a few) vertical manifolds providing inlet(s) and outlet(s) for each ring. In other examples of non-limiting variations, each of the coolant tube(s) 504 flow convective coolant 214, and the coolant tubes 504 are bonded in place using soldering, welding, brazing, or other methods. The exact number and configuration of one or more coolant tube(s) 504 are various.

In other examples of non-limiting variations, the one or more coolant tube(s) 504 of FIG. 5 can be of any material, wall thickness, or geometry in cross-section as long as the coolant tubes transfer the heat that flows through the thrust chamber 102 to the convective coolant 214. Other implementations of the coolant tubes 504 include copper, stainless steel, Inconel®, steel, aluminum, and nickel or alloys of all of these materials or other materials. In other examples of non-limiting variations, the cross-section geometry of the coolant tube(s) 504 can be circular, square, octagonal, hexagonal, round on one side and flat on the other, oval, or any other geometry that will carry fluid.

In FIG. 5 the external coolant tube(s) can be any geometry, material, or wall thickness so long as the tube(s) can adequately absorb the heat being conducted through the shell 502 of the thrust chamber 102.

An option to FIGS. 1, 2, and 5 is that the convective coolant 214 convective and internal film coolants can, be modified with any type of additives. Variations can include, but are not exclusive to, changing the boiling or freezing points of the fluids or the viscosity of the fluids or other properties.

In other examples of non-limiting variations of the propulsion system of FIG. 5, the one or more coolant tube(s) 504 are modified to be a half-tube, as opposed to the full perimeter tube, that is bonded (i.e. soldered, brazed, welded, or other attachment method) to the thrust chamber shell 502 exterior wall. The half-tube is a coolant tube 504 tube that has been split in half along length of the coolant tube 504 and is wound around the thrust chamber 102 in the same manner as a full diameter coolant tube(s) 504. Like a full tube, the half-tube can be of any cross-sectional geometry so as long as coolant tube 504 allows the heat flowing through the thrust chamber shell 502 to be transferred to the convective coolant 214. The half-tube coolant tube 504 is bonded to the thrust chamber shell 502 with an open side facing the thrust chamber 102, thus forming a flow passage for convective coolant 214. Any cross-sectional geometry of coolant tube 504 can be implemented including but not exclusive to a circle, square, rectangular, round on one side and flat on the other, octagonal, hexagonal, and others, or any combination of these and others.

FIG. 6 is a cross section side-view block diagram of a sample bolting arrangement for securing the inner and outer shells together. FIG. 6 shows an example spacer bolt arrangement that could be implemented to connect the inner shell 104 to the outer shell 106 to prevent collapse of the inner shell 104. The spacer bolt arrangement in FIG. 6 is one example. Other bolting arrangements can be implemented. In the bolting configuration of FIG. 6 the spacer bolt 602 is made of a strong yet highly conductive material such as an alloy of copper or nickel. The inner shell 104 and outer shell 106 are both dimpled to maintain a constant gap 110 width and to ensure that the bolt head is flush with the hot-wall 204 on the inside of the thrust chamber 102. For larger size spacer bolts 602 an optional hole 608 of any shape can be fabricated through the bolt to allow convective coolant 214 to better cool the spacer bolt 602. In some implementations, a step is fabricated into the spacer bolt 602 to maintain the gap 110 at a constant width. The spacer bolt 602 can be have an optional slot 604 or any other kind of keying mechanism or no keying mechanism. In implementation that includes a slot 604, the slot 604 can be oriented parallel to the hot gas flow inside the thrust chamber 102. A nut 606 is sealed with braze, solder, welding, adhesives, polymers, or by other apparatus. As an option the nut 606 can be sealed with an o-ring or gasket instead of the apparatus listed above. An o-ring implemented with a slightly oversized hole in the outer shell 106 provides movement of the outer shell 106 slightly relative to the inner shell 104 to allow provide movement of the two shells when the inner shell 104 thermally expands due to heating. Washers can be implemented with the nut 606 when deemed helpful. Some implementations include expansion joint(s) between the inner shell 104 and outer shell 106, the outer shell 106 to assist in accommodating thermal expansion differences between the inner shell 104 and outer shell 106, the outer shell 106. The expansion joint(s) can include bellows. Bolts as in FIG. 6 or any other connective device that joins the inner shell 104 and outer shell 106 can be implemented to prevent collapse of the inner shell 104. In addition to direct pressure effects they can also resist buckling due to static pressure head of the fluid in the gap, acceleration effects especially for upper state engines, and for the drop in static pressure incurred near the throat 121 and in the expansion nozzle 118 after the engine has started.

Any bolts that penetrate the inner shell 104 can be sealed to the inner shell utilizing any useful apparatus such as brazing, soldering, polymer sealants and others. Implementation that do not seal the bolt against the inner shell 104 then the gap 110 pressure can be operated at a slightly higher (such as but not limited to a few psi higher) pressure than the interior 115 of the thrust chamber 102. The higher operating temperature between the pressure in the gap 110 and the pressure of the interior 115 prevents any combustion gas from leaking into the gap 110 and destroying the cooling capacity to absorb heat of the cooling systems. In addition, a bolt and a separate spacer of any shape can be a substitute for a spacer bolt 602, with the bolt would pass through the spacer in the gap 110. The bolt would pull the inner and outer shells 104, 106 together against the spacer while the spacer would maintain the gap 110 width. Optional holes can be formed in the bolt and spacer to allow coolant to flow through them.

The arrows in the figures that are not item designator arrows or other such arrows but are shown as inside or adjacent to fluid flow pipes, flow passages, or flow lines designate the direction of fluid flow in the pipes, passages, or lines.

For unignited, non-running rocket engines (such as upper stage engines) that are mounted to a rocket vehicle that is ascending in the atmosphere and have the gap 110 of their thrust chambers 102 prefilled with convective coolant 214: the gaps 110 of such unignited rocket engines can be vented as necessary to prevent collapse of the inner shell 104 due to the increase in pressure differential across the inner shell 104 implemented by the fall in pressure inside the thrust chamber 102 due to the decrease in atmospheric pressure as altitude increases.

If a heat exchanger 138 is implemented in the recirculating cooling system then a portion of the recirculated coolant (i.e. convective, spray, or regenerative coolant) can bypass the heat exchanger 138.

Some possibilities for lightening any electric motors implemented on the cooling system pumps include using electric motors with aluminum windings, fluid cooled motors, or motors that are downsized to the point where they will overheat (with continued operation) shortly after their useful life has been implemented up. Other lightening methods can be implemented as well.

### Sray Cooling

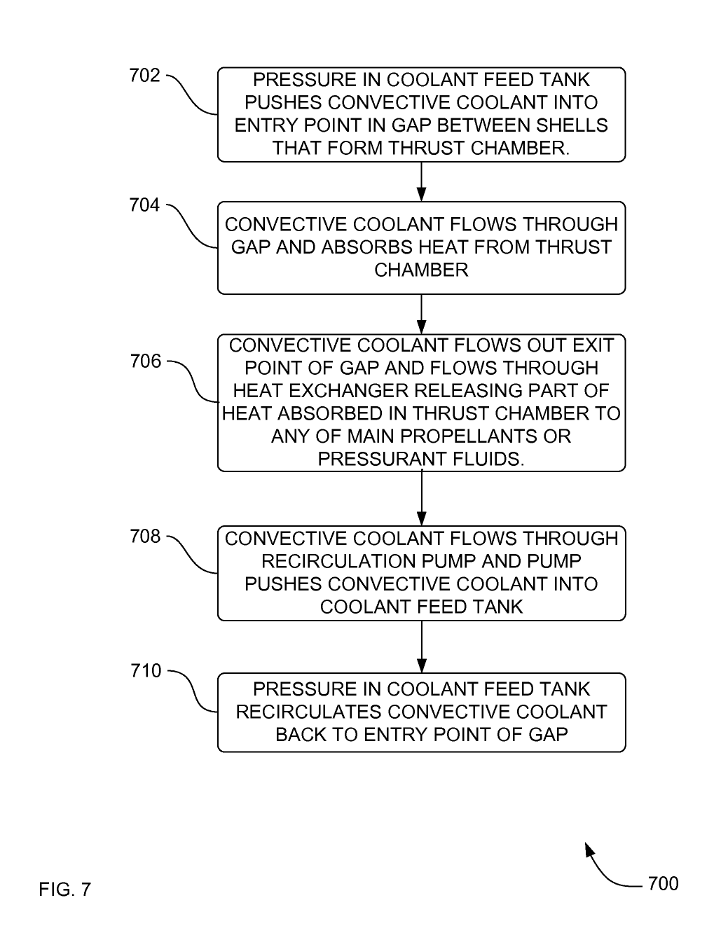

Spray cooling is included in some implementations of the thrust chamber 102 recirculating cooling system in which a spray coolant 18 is recirculated in a continuous cooling system loop. Recirculating spray coolant 18 in a continuous cooling system loop is very similar to recirculation shown in FIGS. 1 and 2 and the methods of FIGS. 7 and 8. However, with spray cooling the convective coolant 214 flowing between the inner shell 104 and outer shell 106 is replaced with spray coolant that is sprayed onto the cold wall of the inner shell 104. Spraying spray coolant onto the cold wall of the inner shell 104 allows the construction of a simplified shell structure thrust chamber 102 as does the recirculating cooling system using convective coolant 214.

Spray cooling can be implemented in any variation of rocket engines described herein where helpful and other rocket engines described herein can be implemented with the spray cooling.

### Sray Cooling: Main Attributes

The attributes for the spray cooling system include but are not limited to:

Independent Cooling System: The thrust chamber 102 cooling system operates completely independently of the engine's main propellant injector 116. Operating the thrust chamber 102 cooling system completely independently of the engine's main propellant injector 116 can result in less propellant tankage weight for pressure-fed rocket vehicles. The reason for the less propellant tankage weight is that in conventional regenerative cooled pressure-fed rocket engines the thrust chamber 102 coolant is one of the propellants and its respective propellant tank must have added pressure in the respective propellant tank to force the coolant/propellant through the cooling channels or tubes in the thrust chamber 102 and then through the pressure drop of the main propellant injector 116. The added pressure results in extra tank structural weight and additional weight in pressurizing gas and its gas storage tanks. The cooling system avoids the additional propellant tank weight.

Simple Shell Construction: A simple thin metal inner and outer shells 104, 106 is implemented as the main thrust chamber 102, thus eliminating extensive tooling and fabrication requirements.

Eliminates Extensive Coolant Tube Forming: The implementation of spray cooling greatly minimizes or eliminates the expense and lead-time of forming fluid coolant tubes necessary to cool the thrust chamber 102. In some implementations, tubing has minimal fabrication requirements and thus greatly simplifies and expedites production of the thrust chamber 102 and a cooling system.

The Use of Low-Cost, Readily Available Materials: Because the thrust chamber cooling safety factor can be adjusted to a large range of values and the thrust chamber structure can be maintained at low to modest maximum temperatures (i.e. below about 1000 deg F.). In some implementations, thrust chambers are fabricated from conventional processes and materials found throughout industry, such as materials like Inconels® and stainless steels (and others) and processes such as metal spinning and welding (and others).

Simplified Spraying/Jet Cooling System: Unlike currently available fluid cooled rocket engine thrust chambers, which require numerous intricately formed cooling tubes, the thrust chamber 102 is cooled with simple spray nozzles or orifices or both that will be referred hereafter as spray devices 8. The mounting of the spray devices 8 in the thrust chamber 102 is far simpler than fabricating a conventional regenerative cooled thrust chamber 102. Thus thrust chamber fabrication can be achieved with lower procurement times and at a lower overall cost as compared to conventional thrust chambers.

Flexible Cooling Safety Factor Gives Higher Reliability: Because in one version of the spray cooling system unexpended spray coolant 18 is pumped back into the coolant feed tank 112 and, if implemented, cooled with a heat exchanger 138 then more spray coolant 18 than is necessary to cool the thrust chamber 102 can be sprayed to cool the thrust chamber 102 at any one moment. When more spray coolant 18 than is necessary to cool the thrust chamber 102 can be sprayed to cool the thrust chamber 102 at any one moment, the cooling safety factor for the thrust chamber 102 can be set to any value by adjusting the spray coolant 18 flowrate to achieve the desired cooling safety factor. The cooling safety factor can also be increased by the amount of spray pattern overlap. If the outer edge of the spray pattern of each spray device 8 (where the pattern intersects the inner shell 104 touches or nearly touches the center line of the adjacent spray patterns then one spray device 8 in two can fail due to plugging from containments in the cooling system with the cooling system still maintaining adequate spray coverage of the heated area to prevent thrust chamber 102 failure. The increase in cooling safety factor will result in an increase in thrust chamber 102 reliability.

Implementations described herein provide a lightweight rocket engine that can be constructed of almost any size, all while using only low-cost fabrication methods and inexpensive, non-exotic materials. Thus, implementations described herein greatly simplify and expedite the production of a fluid-cooled rocket engine thrust chamber.

### Spray Cooling System: Baseline Features

Implementations are not limited to the baseline implementation. The baseline implementation is an example of how a spray cooling system is implemented in an actual rocket engine.

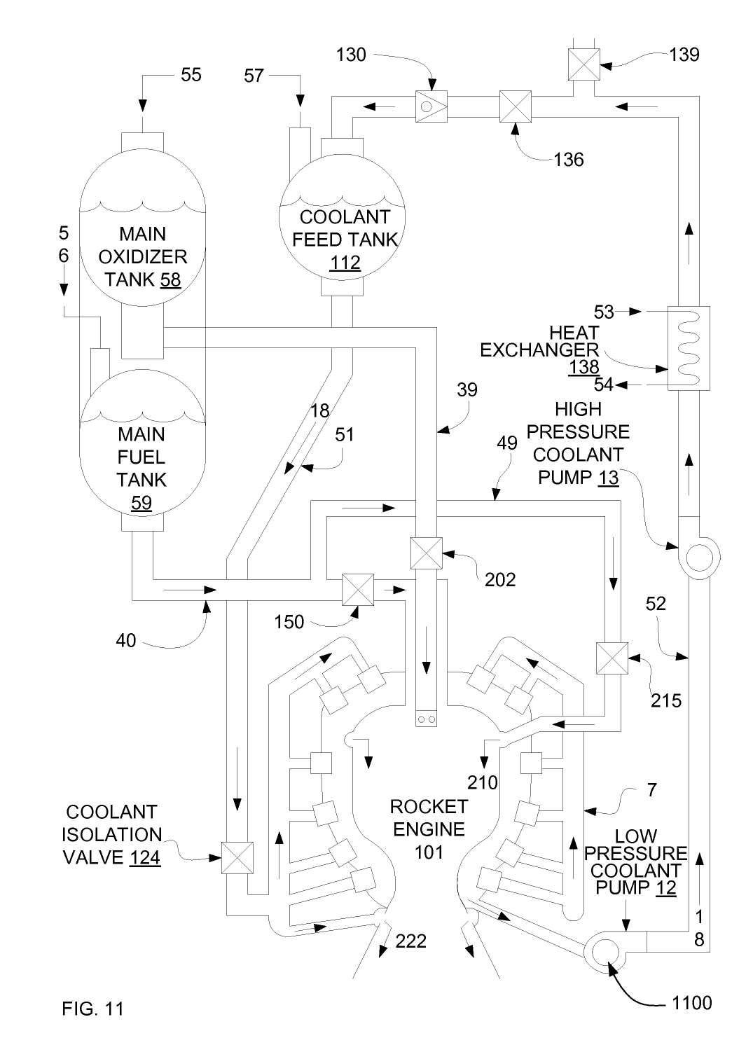

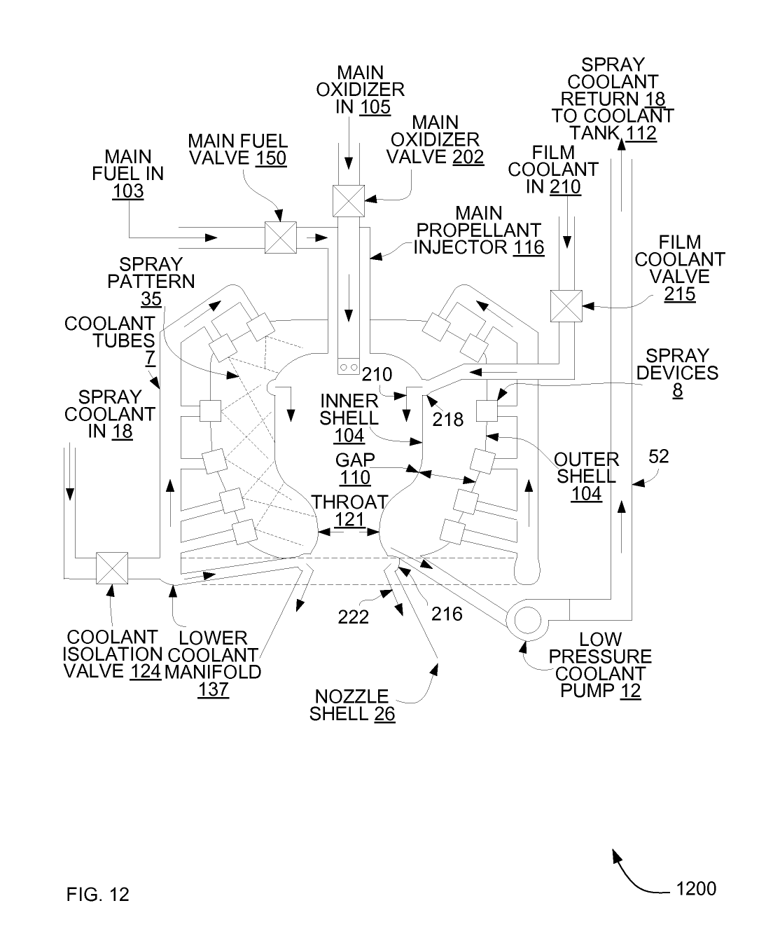

A baseline rocket engine for the spray cooling system is a liquid, bi-propellant rocket engine using jet fuel as the main fuel 103 and liquid oxygen as the main oxidizer 105. The structure of the engine's thrust chamber 102 is a double shell structure with an inner and outer shell 104, 106 (FIGS. 11 and 12) and a gap 110 in between where the spray coolant 18 flows. The baseline material of construction for the shells 104, 106 is an Inconel® metal alloy. The main propellant injector 116 for the engine is a pintle type of injector as originally developed in the early 1960's. The combustion chamber 122 operating pressure is 300 psia. The engine is spray cooled exclusively with the water as the spray coolant 18 where a portion of the spray coolant 18 is implemented to film cool the a portion of the expansion nozzle 118 at a flowrate equal to 2.9% of the total fluid flowrate to the engine (including the spray coolant 18). A portion of the expansion nozzle 118 is a simple metal, single wall, shell structure: the nozzle shell 26. All spray devices 8 of the baseline system are of the fixed position type (as opposed to rotating). A portion of the jet fuel (approx. 3.7% of the total fluid flow to the engine) is injected at the top of the thrust chamber 102 along the hot-wall 204 of the inner shell 104 (i.e. along the inside wall of the combustion chamber 122) where the jet fuel functions as the internal film coolant 210 to reduce the heat flux to the spray coolant 18.

The baseline rocket engine is a pressure-fed engine, where the main propellant tanks are pressurized to the point where they can feed the propellants directly into the thrust chamber 102 without the use of main propellant pumps. With the exception of check valves, all valves in the total rocket system are assumed to be actuated valves. Miscellaneous valves such as fill valves, safety valves, purge valves, etc. are not shown in FIGS. 11 and 12 because these are standard aerospace or industrial items not required to be shown in the figures. In addition, the above details (such as combustion chamber 122 pressure, flowrates, propellants, etc.) are for example purposes only and can vary from rocket engine to rocket engine according to the requirements of the rocket system and the specification.

### Sray Cooling Baseline

The primary feature of the baseline implementation is a double walled shell structure consisting of the inner and outer shells 104, 106. For orientation purposes, the inner shell 104 has a hot wall adjacent to the engine's combustion flames and a cold wall that is opposite to the hot-wall (i.e. between the inner shell 104 and outer shell 106). The outer shell 106 has an inner wall in between the two shells and an outer wall that is the exterior surface of the thrust chamber 102.

In the baseline implementation, the thrust chamber 102 is cooled with water (known as the spray coolant 18) that is projected onto the inner shell's 104 cold-wall surface by a number of spray nozzles (i.e. spray devices 8). Other types of spray coolants 18 can be implemented as well alone or in combination with each other. The spray nozzles in this case produce a spray pattern 35 (shape of area of impact on inner shell 104) of water, usually circular, square, or rectangular shaped, that absorbs the heat that is conducted through the inner shell 104 from the engine's combustion gases. As shown in FIG. 12 the spray patterns 35 from each of the spray devices (nozzles) 8 overlap each other so that (on the cold wall of the inner shell) the edge of each spray pattern 35 is approximately touching the centerline of the spray patterns 35 adjacent to it. The overlapping spray pattern ensures 100% water coverage of the entire cold-wall of the inner shell 104. The exact quantity of spray coolant 18 required to cool a rocket engine depends on the materials of construction, the desired confidence level in the engine, and the desired maximum temperature of the engine's structures, but the amount of spray coolant 18 will typically fall between 1% and 10% of the total fluid flow to the thrust chamber 102 of the engine (includes main propellants, film coolant, and spray coolant).

To ensure that there is adequate cooling of the thrust chamber 102, more water than is necessary for cooling is fed to the spray devices 8 by a pressurized coolant feed tank 112. Since excess spray coolant 18 is flowing through the spray devices 8, that portion of spray coolant 18 that does not evaporate during the cooling process is recirculated back to the coolant feed tank 112 for reuse with either one or multiple coolant recirculation pumps 108 in series or in parallel to each other or both. In the baseline implementation, two pumps are implemented in series with each other, in lieu of a single coolant recirculation pump 108. The first pump is a low pressure coolant pump 12 (also known as the low pressure pump) located at the low point of the engine. The first pump routes the spray coolant 18 to a high pressure coolant pump 13 (also known as the high pressure pump) that pumps the spray coolant 18 back into the coolant feed tank 112. Two pumps are implemented here instead of a single pump in order to reduce the weight hanging on the lightweight expansion nozzle, the low pressure coolant pump 12 being as small as possible. The output pressures of the low and high pressure pumps 12, 13 can be any value, but typical values fall between approximately 5 to 20 psig for the low pressure coolant pump 12 and 20 to 100 psig for the high pressure coolant pump 13. In order to provide the spray devices 8 with spray coolant 18, the coolant feed tank 112 would have an internal pressure that would be between approximately 10 to 80 psig, although higher or lower pressures could be implemented for the tank, depending on the exact characteristics of the spray devices 8 and the gap 110 operating pressure.

The exact number of coolant tubes 7 and spray devices 8 can vary according to the exact type of spray device 8 selected. For added cooling safety factor, more coolant tubes 7 and spray devices 8 than the minimal amount necessary to cool the thrust chamber 102 can be selected. Also for added cooling safety factor the spray patterns 35 of the spray devices 8 can overlap each other as described herein. If one of the spray devices 8 should become plugged due to contamination there will still be adequate cooling of the inner shell 104 (i.e. adequate spray coverage of the heated area) if the overlap of the spray patterns 35 is sufficiently large.

As seen in FIG. 12, the baseline implementation the spray devices 8 protrude through the outer shell 106 to spray coolant on the inner shell 104. The spray devices 8 are fed spray coolant 18 from the coolant tubes 7. The coolant tubes 7 are in turn fed coolant through the lower coolant manifold 137 that is fed spray coolant 18 from the coolant feed tank 112. The spray devices 8 could be mounted on the outer shell's 106 outer wall, they could be mounted so as to protrude through the outer shell 106, or they could be mounted on the outer shell's 106 inner wall in the gap 110 between the inner and outer shells 104, 106, or on the cold wall of the inner shell 104, or anywhere in the gap 110. The coolant tubes 7 and lower coolant manifold 137 could be mounted on the exterior of the thrust chamber 102 as shown in FIG. 12 or be mounted in the gap 110 between the inner and outer shells 104, 106. The exact mounting location of the coolant tubes 7, lower coolant manifold 137, or spray devices 8 is not critical to the operation of implementations, so long as the areas of the thrust chamber 102 that require cooling receive the required coolant.

That portion of the spray coolant 18 that evaporates during the cooling process flows from the gap 110 between the inner and outer shells 104, 106 and flows out one or more exhaust ports 15 mounted to the outer shell 106 (not shown in FIG. 12). In some implementations, an exhaust tube 16 is attached to the exhaust port 15 to dump the evaporated spray coolant 18, including dumping the evaporated spray coolant 18 into the atmosphere as is the case with the baseline implementation. The rate of spray coolant 18 evaporation and the size of the exhaust port 15 (or ports) determine the operating pressure in the gap 110 between the inner and outer shells 104, 106. The gap 110 operating pressure can be any value but a typical value for the operating pressure of the gap 110 would be between 2 and 15 psia, low enough so as not to collapse the inner shell 104. The gap 110 width only has to be large enough to accommodate the amount of spray device 8 protrusion into the gap 110 and the amount of spacing required between the spray device 8 tip and the inner shell 104 in order to ensure proper spray coolant 18 coverage of the inner shell's 104 cold-wall. The gap 110 also has to be large enough to ensure adequate venting of vaporized spray coolant 18 resulting from the spray cooling process without the venting vapor interfering with the spray characteristics of the spray devices 8. In some implementations, the width of the gap 110 width accommodates the cooling and exhausting process.

The baseline implementation includes liquid oxygen (Lox) and jet fuel as the engine's main propellants (i.e. the propellants that generate the bulk of the rocket engine's thrust). To reduce the amount of spray coolant 18 required to cool the inner shell 104 to acceptable temperatures, film cooling is performed. Film coolant is a liquid or gas that flows along the hot-wall 204 surface of the inner shell 104. In the baseline implementation, the film coolant (called internal film coolant 210) is jet fuel that is injected along the inner shell 104 hot-wall 204. The jet fuel internal film coolant 210 is a coking film coolant and reduces the heat to be absorbed by the spray coolant 18, by its evaporation and/or decomposition, and then by depositing carbon (soot) on the Inner Shell's hot-wall 204 surface. The carbon or soot is an excellent insulator that greatly reduces the transmission of heat to the spray coolant 18. The carbon deposition process is referred to as coking. The amount of internal film coolant 210 utilized is variable depending on the maximum desired hot-wall 204 temperature of the inner shell 104 and the materials of construction, but the amount usually falls between 0 and 10% of the total fluid flow to the interior of the engine's thrust chamber (includes both main propellants and film coolant flow).

The baseline implementation includes the main propellant injector 116 implemented as a Pintle injector. The thrust chamber 102 cooling system can be implemented with almost any liquid rocket propellant injector as will be discussed in the following sections.

In some implementations, most of the spray coolant 18 will not evaporate when the spray coolant 18 is cooling the engine, hence a single coolant recirculation pump 108 or the coolant low and high pressure pumps 12, 13 are needed. In the baseline implementation a portion of the spray coolant 18 is implemented to cool a portion of the expansion nozzle 118 as nozzle film coolant 222 that is injected along the nozzle interior wall 206, which allows the coolant feed tank 112 to be empty or near empty when the coolant tank is no longer needed aboard a rocket vehicle, thus resulting in more useful payload being carried by the vehicle. If a portion of the spray coolant 18 is not implemented to cool the expansion nozzle 118 then the coolant feed tank 112 can be drained with a coolant metering device 17 located anywhere in the cooling system where the coolant metering device 17 can dump liquid coolant. The coolant metering device 17 can be either an actively controlled or preset device. Such a device is not implemented in the baseline implementation but can be implemented to dump spray coolant 18 either directly into the atmosphere or any other location.

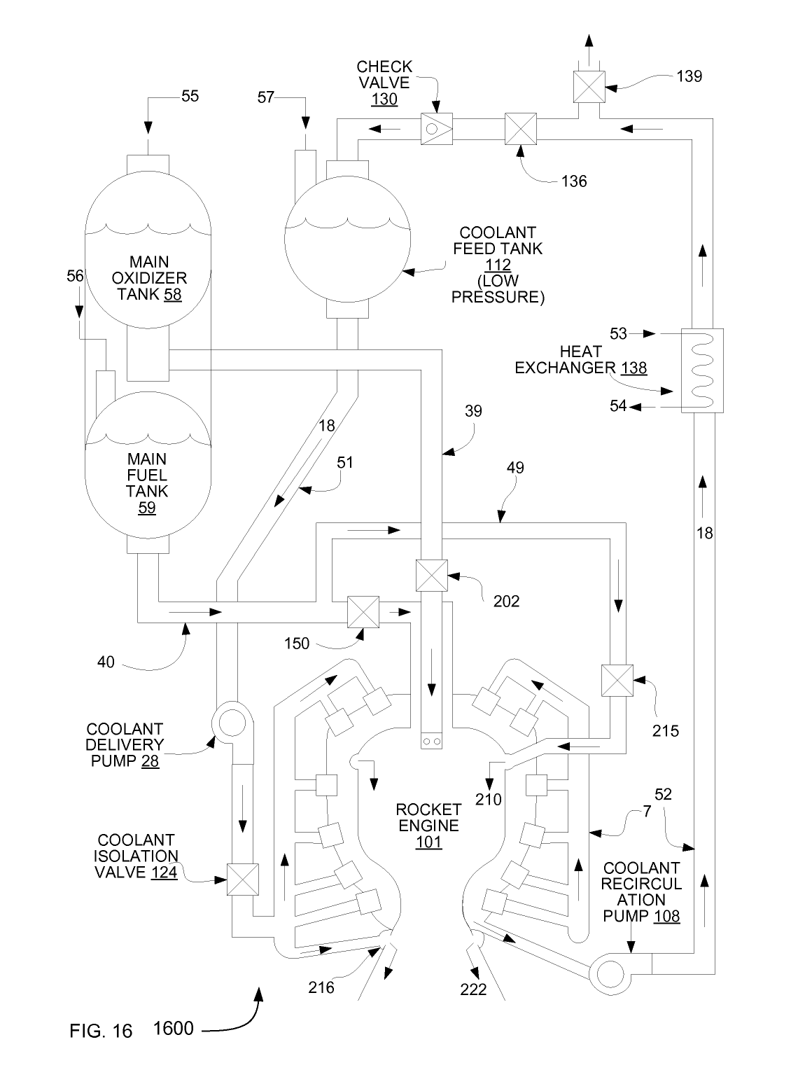

Summarizing with FIG. 11, to start the cooling system, the pressure vent valve 139 is closed and the coolant isolation valve 124 and the pressure isolation valve 136 are opened at approximately the same time that the low pressure pump 12 and the high pressure pump 13 are started to initiate flow of the spray coolant 18 back to the coolant feed tank 112; the spray coolant 18/nozzle film coolant 222 flowing through the spray devices 8 and nozzle film coolant orifices by virtue of the pressure in the coolant feed tank 112. Thereupon, the coolant flow to the heat exchanger 138 is also initiated. At the same time or nearly the same time the main fuel valve 150, main oxidizer valve 202 are opened to start the engine while the film coolant valve 215 is opened to help cool the thrust chamber 102. The low pressure pump 12 and the high pressure pump 13 pump the excess spray coolant 18 (i.e. that portion that does not evaporate or not implemented as nozzle film coolant 222) through the heat exchanger 138 where the spray coolant 18 is cooled and then flows back to the coolant feed tank 112. The alternative cooling system in FIG. 16 operates in a similar fashion with the exception that the coolant feed tank 112 is at very low pressure so the spray coolant 18 is pushed through the spray devices 8 and nozzle film coolant 222 orifices by the pumping action of the coolant delivery pump 28. Since the coolant feed tank 112 is at low pressure only one coolant recirculation pump 108 is needed to pump the coolant back to the coolant feed tank 112.

### Alternative Implementations of the Spray Cooled Thrust Chamber:

Orifices are implemented as spray devices (as opposed to a spray nozzle). The orifices can be orifice fittings or orifices that are simply drilled, broached, EDM's (electro discharge machined), or formed directly into the coolant tubes 7, coolant manifolds, or in fittings. Orifice spray devices are different than coolant tubes in a conventional regenerative cooled engine that are typically stacked together like ‘asparagus’ and usually do not project coolant directly upon the hot surface to be cooled. Orifice spray devices in the thrust chamber cooling system will also operate with other types of rocket engines such as engines with so-called flat faced injectors, such as the Space Shuttle SSME and the Apollo J-2, H-1, and F-1 engines. Strictly speaking, such engines do not have a thrust chamber dome 220 at the top of the combustion chamber 122 as does the pintle injector engine, but have a flat, dish-like main propellant injector 116 face with a number of holes in it, as a conventional bathroom shower-head often does. The thrust chamber cooling system is similar to that of the previously described cooling system for the pintle injector engine with the exception that there is no thrust chamber dome 220 to cool. However, such flat-face injector rocket engines may have something called a propellant dome or an oxidizer dome or fuel dome at the top of their thrust chambers. Such structures are simply for directing propellant (usually the oxidizer) to the main propellant injector 116 and are not parts of the thrust chamber 102 that are directly exposed to hot combustion gases and would thus require cooling. Such structures should not be implemented with a thrust chamber dome 220 as described herein. Other options for the spray cooling system include but are not limited to:

Option 1: Combustion Chamber Type: This cooling system can be implemented with any shape of thrust chamber 102 or combustion chamber 122 including the conventional cylindrical combustion chambers (as in most rocket engines today) and spherical combustion chambers (such as in the German WW2 V2 rocket engine). Likewise the outer shell 106 of the thrust chamber 102 can be of any shape so as long as the gap 110 between the inner and outer shells 104, 106 is sufficient to allow the spray devices 8 to provide the inner shell 104 with adequate coverage of spray coolant 18. The spray cooled baseline implementation in FIG. 12 shows the outer shell 106 to be contoured, but another option would have the outer shell 106 be a straight cylinder, or any other shape, so long as the spray coolant can cool the thrust chamber 102. Another option would be to cool the thrust chamber 102 without using an outer shell 106 or without using any coolant recirculation pumps 108 but to just dump the spray coolant 18 into the atmosphere.

Option 2: Engine Main Propellants: A cooling system that operates independently of the main propellant injector 116 can be implemented in rocket engines that combust any type of main propellants, such as jet fuel, RP-1, kerosene, liquid hydrogen, liquid methane, propane, liquid oxygen, hydrogen peroxide, alcohol, nitric acid, and others.

Option 3: Main Propellant Injector: Because the cooling system operates independently of the main propellant injector 116, the cooling system can be implemented with rocket engines utilizing any type of main propellant injector 116 including the Pintle injector originally developed in the 1960's or so-called Flat-Face injectors such as utilized in the Space Shuttle Main Engine (SSME) and the Apollo J-2, H-1, and F-1 engines.

Option 4: Film Coolant: To reduce the amount of spray coolant 18 required, a cooling system can be implemented with internal film coolant 210 injected along the hot-wall 204 of the inner shell 104. The internal film coolant 210 is not a necessity but the internal film coolant can be implemented with a spray cooling system. The internal film coolant 210 can be injected in the thrust chamber 102 in any manner or number of places. In addition, any fluid can be implemented as internal film coolant 210 as long as the cooling properties of the fluid and how the fluid interacts with the spray cooling system are known. The internal film coolant 210 includes both coking and noncoking internal film coolants 19. Film cooling options for internal film coolant 210 are also valid for nozzle film coolants 21.

Option 5: Spray Coolant: The spray coolant 18 fluid in the thrust chamber 102 spray cooling system can be any liquid, gas, or fluid as long as the fluid can absorb the heat flowing through the thrust chamber inner shell 104 while keeping the inner shell 104 cool enough so that the inner shell 104 does not melt or fail structurally during engine operation. Water would be an ideal spray coolant 18, but the spray coolant 18 could also be one of the engine's main propellants such as liquid hydrogen, liquid methane, liquid oxygen, or others. Liquid nitrogen or other cryogenic fluids can also be implemented. If one of the main propellants (fuel or oxidizer) is implemented as a spray coolant 18 then main propellant can be fed to the spray devices 8 directly from the main propellant tank of the main propellant spray coolant 18.

Option 6: Spray Devices: The spray devices 8 can be any mechanism for spraying the spray coolant 18 onto the inner shell's 104 cold wall including spray nozzles, pressure nozzles, self-atomizing nozzles, swirl nozzles, orifices, simple drilled orifices, orifice fittings, open ended tubes, gas-assisted spray nozzles, or any other spray device as long as the mechanism for spraying the spray coolant covers the area intended to be cooled with spray coolant. Spray nozzles, pressure nozzles, self-atomizing nozzles, and swirl nozzles break up a stream of liquid coolant by inducing a swirl or expansion in a liquid coolant prior to injecting the liquid coolant from of the nozzle. After injection, the liquid coolant breaks up into a spray of small droplets. These types of nozzles do not use a gas to assist in droplet formations and is the type of spray nozzle utilized in the spray cooled baseline implementation. The gas-assisted spray nozzle uses a gas in addition to a liquid spray coolant 18 to help break up the coolant into the small droplets as the gas and liquid coolant are injected together. Any gas of the appropriate temperature from any source available would be acceptable to break up the coolant into the small droplets as the gas and liquid coolant are injected together. The spray devices 8 can inject the coolant in any shape of spray pattern that will provide coolant to the area to be cooled. Possible patterns are circular, square, rectangular, or others, or combinations of any patterns that will adequately cover the area requiring cooling.

Option 7: Spray Coolant Recirculation Pumps: There are numerous options for the arrangement of the coolant recirculation pumps (in which the baseline implementation is represented by the low pressure pump 12 and the high pressure pump 13). Some of the options include:

a.) The coolant pumps could be arranged as shown in the baseline implementation, FIG. 11. That is, a low pressure coolant pump 12 is fixed to the low point of the engine and pumps coolant to the high pressure coolant pump 13 that in turn pumps the coolant back into the coolant feed tank 112 (or tanks).

b.) The function of the low and high pressure coolant pumps 12, 13 could be combined into one coolant recirculation pump 108 located at the engine's low point.

c.) The branch tee feeding nozzle film coolant 222 to the expansion nozzle 118 can be located downstream of the high pressure coolant pump 13 as can the optional coolant metering device 17.

d.) As shown in FIG. 16, the coolant feed tank 112 can have a very low operating pressure, for example less than 5 psig, and therefore the spray coolant 18 can be fed to the spray devices 8 by a coolant delivery pump 28. Since the coolant feed tank 112 is at low pressure, only a small, single coolant recirculation pump 108 would be required to deliver the unexpended coolant back to the coolant feed tank 112.

e.) Some implementations include no coolant recirculation pumps 108, in which case, excess spray coolant 18 is dumped directly into the atmosphere or surrounding environment.

f.) In the place of a single coolant recirculation pumps, multiple pumps could be implemented for any pump station.

Option 8: Thrust Chamber Materials/Processes of Construction: The thrust chamber 102 can be made with any materials or processes that can create shell structures of the appropriate size, shape, and structural strength and that allow the heat absorbed by the thrust chamber 102 to be absorbed by the spray coolant 18 to the extent where the thrust chamber 102 will not get so hot as to melt or structurally fail due to material heating. Some of the candidate materials for the thrust chamber 102 include but are not limited to copper, aluminum, steel, stainless steel, nickel, Inconel®, brass, bronze, unreinforced polymers, reinforced polymers and alloys or composites of any of the above materials or any combination of the above materials.

Option 9: Cooled Surface Enhancement of Heat Transfer: The surface characteristics of the cold-wall of the inner shell 104 can be modified to increase the heat transfer coefficient (btu/(in̂2-sec-deg F.)) of the spray coolant system. A higher heat transfer coefficient apparatus that the inner shell 104 can absorb/conduct more heat while having lower wall temperatures. The enhancements to the cold wall of the inner shell 104 include smoothing, roughing, sanding, sand blasting, grit blasting, shot peening, sputtering, and/or machining or forming small squares, rectangles, triangles, or grooves into the cold-wall, or other methods. Another option is to plate the cold-wall with a highly conductive metal such as gold, silver, nickel, or copper as examples. Still another option is to flame spray or plasma spray or use some other process (including painting) to install a porous metal surface onto the cold-wall of the inner shell 104. These modifications could also be done to the surfaces adjacent to the cold-wall of the inner shell 104 in any combination with any other modification in order to achieve the desired heat transfer coefficient.

The hot-wall of the inner shell 104 can be modified to reduce heat flux conducting through the inner shell 104 to the spray coolant. One method is to use the inner shell 104 parent material as is without any coatings. Another is to anodize the hot-wall 204 for those materials that can be anodized such as aluminum. Anodizing creates and heat resistant oxide layer on the material that reduces the amount of heat conducted through the inner shell 104. Another modification to reduce heat conduction is to deposit a ceramic, metal, metal oxide, or composite layer on the inner shell 104 hot-wall. Still another modification to the inner shell 104 hot-wall is to increase resistance of the inner shell 104 to oxidation by combustion gases. Increase resistance of the inner shell 104 to oxidation by combustion gases can be achieved by depositing a ceramic or metal layer on the hot-wall using flame spraying, plasma spraying, vapor deposition, plating, or any other deposition technique. Some of the possible candidate metals that can be deposited on the hot-wall 204 include but are not limited to Inconel®, nickel, copper, brass, stainless steel, gold, silver, and others. Options that are valid for the Inner Shell hot-wall 204 are also valid for the nozzle interior wall 206.

Option 10: Cooling the Spray Coolant: After the spray coolant 18 has cooled the thrust chamber 102, the spray coolant 18 will have been warmed from the heat that the spray coolant 18 has absorbed from the thrust chamber 102. in some implementations, the unexpended spray coolant 18 returning to the coolant feed tank 112 is circulated through a heat exchanger 138 (FIG. 11) to cool the unexpended spray coolant 18 as the unexpended spray coolant is being pumped back to the coolant feed tank 112. The heat exchanger 138 can be downstream of either the low or high pressure coolant pumps 12, 13 or if only one coolant recirculation pump 108 is implemented, downstream of that pump. The heat exchanger 138 can be located anywhere in the cooling system so long as the heat exchanger 138 removes the heat or a portion of the heat absorbed by the spray coolant 18 from the thrust chamber 102. On a rocket vehicle the heat exchanger 138 can take the form of a coiled tube, a coiled and finned tube, straight tubes, straight finned tubes, or any other heat exchanger configuration that is suitable for cooling the spray coolant 18. The fluids implemented to cool the spray coolant 18 on a rocket vehicle would be the vehicle's main propellants or pressurant gas or fluid (i.e. the main fuel and/or main oxidizer or pressurizing gas or any combination of the above). To cool the spray coolant 18 the heat exchanger 138 would located at one of multiple possible locations: inside the main oxidizer tank, inside the main fuel tank, inside the main pressurant gas tank, inside the main oxidizer feedline 39 (that feeds the engine), inside the main fuel feedline 40 (that feeds propellants to the engine), or on the outside of the main fuel or oxidizer lines or pressurant gas line. Or, a portion of the main propellants can be diverted into a stand alone heat exchanger 138 to cool the spray coolant 18 and then is dumped overboard the rocket vehicle or is rediverted to feed or cool the engine/engines or is diverted back to the main propellant tanks. The heat exchanger 138 can be of any location and configuration using any fluid within a rocket vehicle or system as coolant so long as the heat exchanger 138 absorbs the heat that the recirculating spray coolant 18 has absorbed in the thrust chamber 102. Diverting a portion of either propellant to the heat exchanger 138 can be accomplished by pressure alone or with a pump. Again, the heat exchanger 138 is an option and is also an option to run the spray cooling system without a heat exchanger 138.

Option 11: Coolant Tubes 7: The exact configuration of the coolant tube/tubes 7 is not critical to the function and therefore can vary. The coolant tube(s) 7 can be of any quantity, number, size, shape, material, configuration, wall thickness, or shape in cross-section, as long as they can feed adequate coolant to the spray devices 8 and accommodate enough spray devices 8 to adequately cool the thrust chamber 102. Adequately cooling apparatus to prevent the thrust chamber 102 from overheating to the point of melting or failing structurally. Some possibilities for tube materials include but are not limited to copper, stainless steel, Inconel®, steel, aluminum, and nickel or alloys or composites of all of these materials or other materials. The cross-section shape of the tube can be circular, square, octagonal, hexagonal, round on one side and flat on the other, oval, or any other shape that will carry fluid. The coolant tubes 7 can also be configured as half-tubes split along their length that are welded to the outer shell's 106 inner or outer surface. What is true of the coolant tubes 7 as stated above is also true of the lower coolant manifold 137. In addition, the coolant tubes 7 can be mounted exterior to the outer shell 106 or on its interior in the gap 110 between the inner and outer shells 104, 106 or can be integral with either shell.

Option 12: Spray Coolant Pattern Overlap: The spray impact area of the spray coolant 18 upon the inner shell 104 is called the spray pattern 35 and can be of any configuration as long as there is adequate coverage of the thrust chamber 102 and especially the inner shell 104 with spray coolant. In those cases where the spray devices 8 are in the form of spray nozzles (as opposed to simple orifices) the flowfield emitting from the nozzles is typically (although not always) pyramid, fan, or cone-shaped with the later being the most common. The impingement area (spray pattern 35) of the spray coolant 18 upon the inner shell 104 can be of any shape but will typically be a circle, a square, a rectangle, or an ellipse or any combination of shapes. The impingement areas of the individual spray devices 8 can overlap each other to any degree or they can not overlap, or smaller spray devices 8 can be implemented in between the larger spray devices 8 to fill in any gaps between the larger spray devices 8 with spray coolant 18 (i.e. provide 100% coverage of the area to be cooled with spray coolant). Again, so long as adequate cooling is provided, any number of spray devices 8 can be implemented to cool the thrust chamber 102. In addition, the spray devices 8 can be mounted exterior to the outer shell 106, could protrude through the outer shell 106, could be mounted in the inner wall of the outer shell 106 or could be mounted in the gap 110 between the inner and outer shells 104, 106. Any other mounting scheme for the spray devices 8 is acceptable as long as they can provide adequate cooling for the thrust chamber 102. For those scenarios where the spray devices 8 protrude through the outer shell 106 or are located on the exterior of the outer shell 106, some implementations seal the spray devices 8 to the outer shell 106 by implementing any adequate sealing method including but not limited to welding, brazing, soldering, caulking, adhesive bonding.

Option 13: Pump or Pressure Fed: Engines that are either pump fed or pressure fed can be implemented, in which the main propellants are fed to the engine either by pumps (i.e. pump fed) or pressurized propellant tanks (i.e. pressure fed as in FIGS. 2 and 8). Likewise the spray devices 8 can be supplied the spray coolant 18 either directly from a pressurized coolant feed tank 112 or another option is to have a coolant delivery pump 28 between the spray devices 8 and the coolant feed tank 112 that pumps spray coolant 18 to the spray devices 8. Either method can be implemented. Any of the pumps mentioned above can be of any type or configuration or driven by any energy source so long as they are capable of pumping fluid at the desired flowrate and pressure.

Option 14: Spray Cooled Rocket Engines Using Hydrogen As Propellant (i.e. a hydrogen Engine): Rocket engines that use gaseous, liquid, vaporized, or supercritical hydrogen as one of its main propellants can use spray cooling to cool their thrust chambers 102. In some implementations, the thrust chamber 102 of a Hydrogen Engine is cooled by water as the spray coolant 18 and a film coolant of either hydrogen or a hydrocarbon fuel. Hydrocarbon fuels, such as jet fuel, RP-1, kerosene, propane, methane, and others deposit carbon on the hot-wall 204 of the inner shell 104 of the thrust chamber 102. The carbon has a low heat transfer coefficient (btu/(in̂2-sec-deg F.)) so the carbon reduces the heat flowing into the spray coolant 18 and thus minimizes the amount of spray coolant 18 required to cool the thrust chamber 102. Reducing the required spray coolant 18 increases the efficiency of a rocket engine and thus that of the vehicle the engine is propelling. Another film coolant that can be implemented in hydrogen engines is simply liquid, gaseous, supercritical, or evaporated hydrogen that can reduce heat to the spray coolant 18 by its large heat absorption capacity because hydrogen does not deposit carbon. Nonetheless, as with any rocket engine or thrust chamber 102, a hydrogen engine and a thrust chamber 102 of a hydrogen engine can be cooled using any of the spray and/or film coolants with adequate thermal and heat absorption properties. This includes using hydrogen as the spray coolant 18 in any of its various phases.

Option 14a: Misc. Options: The spray coolant 18 can flow in the coolant tube(s) 7 (or tubes) in either the ‘up’ or ‘down’ directions. The spray coolant 18 can start at the expansion nozzle 118 and flow upwards towards the main propellant injector 116 as previously described, or the spray coolant 18 starts flowing from near the injector-end of the engine and flow downward towards the expansion nozzle 118 where spray coolant 18 can be injected as film coolant for the expansion nozzle 118 as shown in FIG. 12. Other options are:

a.) The spray coolant 18 can perform its cooling function in the liquid phase (all liquid), or as a boiling liquid (two phase fluid), or in the gaseous state (as a gas or vapor), or as a nucleate boiling liquid, or as a supercritical fluid, or in any combination of the various fluid states or phases.

b.) Either the internal film coolant 210 or the spray coolant 18 or both need not be the same types of fluid as those that make up the main propellants. For example, in a liquid oxygen/hydrogen engine, the internal film coolant 210 could be one of many different coking fluids, while the spray coolant 18 could be hydrogen, water or other non-coking fluid.

Option 15: Increased Gap Operating Pressure: The pressure in the gap 110 during any phase of rocket engine operation or non-operation can be adjusted to any desired level by sizing or controlling the Exhaust Port(s) 15. The gap 110 operating pressure can be controlled by either an orifice, or control valve, or check valve, or regulator, or other pressure control device at the exhaust ports 15, or by simply adjusting the size of the exhaust port(s) 15 without using other pressure control devices. What these control devices do is regulate the exhaust rate of the vapor generated by the evaporation of a portion of the spray coolant 18. The regulation of the gap 110 pressure is desirable for two main reasons:

a.) One reason is to prevent the gap 110 pressure from becoming so large that the inner shell 104 collapses or buckles.

b.) The other reason is that in raising the gap 110 operating pressure the boiling temperature of a liquid spray coolant 18 is increased and thus the amount of heat the spray coolant 18 absorbs prior to boiling is increased. In some cooling systems of this type the spray coolant 18 can be operated without significant bulk boiling in the function as a coolant. If the vapor generated by the evaporation of a portion of the spray coolant 18 is not enough to raise the gap 110 operating pressure to the desired level, then a gas or evaporating fluid in sufficient quantities can be introduced into the gap 110 to raise the gap 110 pressure to the required level. The gas or evaporating fluid can be regulated by any available pressure regulating apparatus.

Option 16: Number of Spray Devices: The number of spray devices 8 implemented to cool the thrust chamber 102 is optional and only needs to be great enough to ensure adequate cooling of the thrust chamber 102. The exact number depends on the type of spray device 8 implemented, its distance from the inner shell 104, the degree of spray pattern 35 overlap, and the amount of cooling safety factor specified.

Option 17: Hybrid or Solid Rockets: This spray cooling system can be implemented on hybrid propellant rocket thrust chambers and nozzles as well as liquid propellant rockets and rocket engines. Hybrid rockets have at least one propellant that is a liquid and at least one propellant that is a solid, such as a rubber or plastic. The internal film coolant 210 or spray coolant 18 can either be the hybrid rockets liquid main propellant or can be part of the propulsion system as a separate tank, cooling fluid, and plumbing system. The spray cooling system can also be implemented with solid propellant rockets thrust chambers and nozzles if the tanks and plumbing and coolants are carried on board for the internal film coolant 210 and the spray coolant 18.

Option 18: Purge to Prevent Buckling: If the flow of the spray coolant 18 is initiated before the engine starts and the combustion chamber 122 has increased, and if the gap 110 pressure or the impact of the spray coolant 18 on the inner shell 104 is enough to collapse the inner shell 104 then a flow of purge gas can be initiated through the combustion chamber 122 to pressurize the combustion chamber 122 enough to prevent collapse of the inner shell 104 until the engine has started.

Option 19: Gap Spacing: There are many options of maintaining the gap 110 between the inner and outer shells 104, 106. In some implementations, the gap 110 is void with no structures or solid items; In some implementations the gap 110 has spacers of any shape, size, or material; in some implementations the gaps 110 has ribs or baffles that are formed or machined on the cold wall of the inner shell 104 and/or the inner wall of the outer shell 106; in some implementations the gap 110 has ribs or baffles that are loose but installed in the gap 110; in some implementations the gap 110 has ribs that are bonded or secured to the inner or outer shells 104, 106. One reason for baffles is to direct the flow of the spent spray coolant 18 that is being diverted to a coolant recirculation pump.

The inner and outer shells 104, 106 could be attached to each other directly or indirectly at their ends, or they can be secured to each other intermittently across their surfaces with welding, brazing, soldering, rivets, bots, welded studs, or by other apparatus. Securing the inner and outer shells 104, 106 to each other prevents the inner shell 104 from collapsing from higher gap 110 operating pressures.

So, for a simple shell-structure thrust chamber 102 the inner and outer shells 104, 106 can be free floating from each other (i.e secured to each other only at their ends, either directly or indirectly), or can have any type of rib or spacer in the gap 110 made of any material that is adequately compatible with the spray coolant 18 and secured using any methods, or the inner and outer shells 104, 106 can be secured to each other intermittently across their surfaces using any method including bolts, rivets, studs, welding, brazing, soldering, and bonding of any kind (including adhesive bonding), or other methods. A reason for securing the inner shell 104 and outer shell 106 to each other is when the pressure differential across the inner shell 104 (i.e. from the gap 110 to the inside of the combustion chamber 122) is great enough to collapse the inner shell 104. Reasons for differential pressure this high include but are not limited to the specified operating pressure in the gap 110 and the drop in static pressure near the throat 121 and in the expansion nozzle 118 after the engine starts.

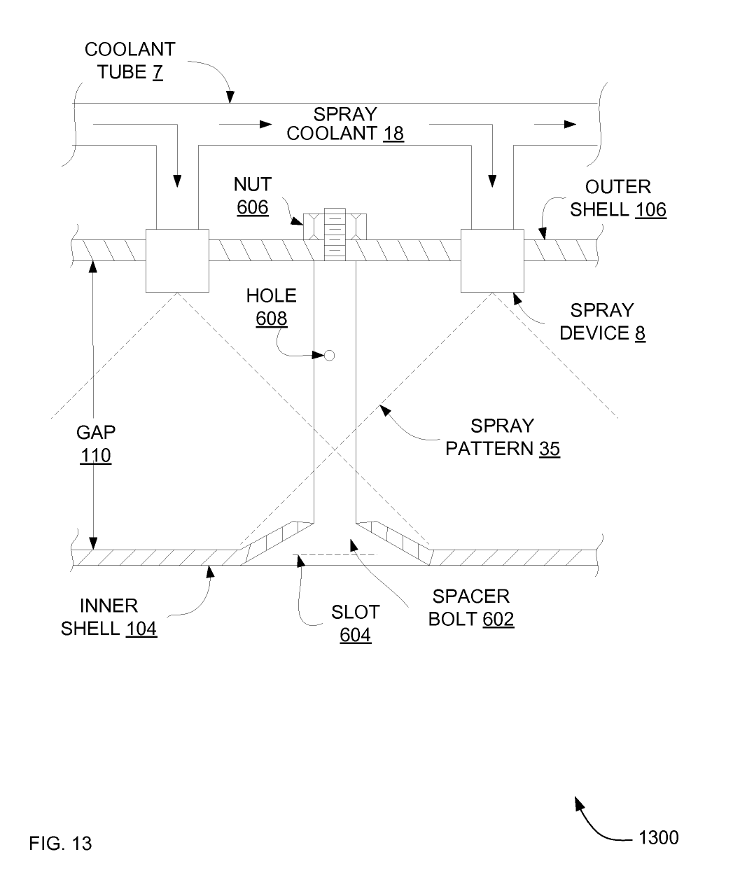

Option 20: Gap Spacer Bolt: FIG. 13 shows an example spacer bolt arrangement that could be implemented to connect the inner shell 104 to the outer shell 106 to prevent collapse of the inner shell 104. This bolting arrangement is only an example arrangement so other bolting or attaching arrangements can be implemented. In the example bolting configuration of FIG. 13 the spacer bolt 602 is made of a strong yet highly conductive material such as an alloy of copper or nickel. The inner shell 104 is dimpled to ensure that the bolt head is flush with the hot-wall on the inside of the thrust chamber 102. A step is fabricated into the spacer bolt 602 to maintain the gap 110 at constant width. Some implementations of the spacer bolt 602 have a slot 604 or any other kind of keying mechanism, oriented parallel to the hot gas flow inside the thrust chamber 102. The nut 606 is sealed against the outer shell 106 with braze, solder, welding, adhesives, polymers, or by other apparatus. The nut 606 can be sealed with an o-ring or gasket instead of the apparatus listed above, which when implemented with a slightly oversized hole in the outer shell 106 allows the outer shell 106 to move slightly relative to the inner shell 104 to allow relative movement of the two shells when the inner shell 104 thermally expands due to heating. Washers can be implemented with the nut 606 when deemed helpful. To assist in accommodating thermal expansion differences between the inner shell 104 and outer shell 106, some implementations expansion joint(s), such as a bellows or other expansion joint, are installed in the outer shell 106. For implementations with spacer bolts 602 that have a large enough diameter an optional hole 608 can be fabricated in the spacer bolt to allow spray coolant 18 to penetrate the spacer bolt 602 and thus be more effective in cooling the bolt. As an alternative to the spacer bolt 602, a bolt can be implemented with a spacer with the spacer bridging the gap 110 (i.e. the spacer bolt 602 goes through a spacer that the inner shell 104 and outer shell 106 butt up against). In this way the inner shell 104 and outer shell 106 are pulled are anchored against the spacer when the spacer bolt 602 and nut 606 are tightened, thus maintaining the appropriate dimension of the gap 110 and keeping the inner shell 104 from buckling. As an option a hole 608 for coolant to flow through can be formed in the spacer bolt 602 and spacer.

Option 21: Valve Usage: The baseline thrust chamber spray cooling system utilizes a thrust chamber 102, low pressure coolant pump 12, high pressure coolant pump 13, heat exchanger 138, coolant isolation valve 124, pressure vent valve 139, pressure isolation valve 136, pressure check valve 130, coolant feed tank 112, film coolant valve 215, and, of course, pipe or tubing to connect these components together. Any valves in the system are optional and can be added or removed to improve coolant and propellant handling, loading, and draining, system operation and timing, safety, reliability, and to prevent collapse of the inner shell 104 in implementations where the gap 110 operating pressure is at a higher pressure than the minimum collapse pressure of the inner shell 104. Some of the optional valves include but are not limited to manual valves, actuated valves, purge valves, relief valves, check valves, and others, and can be located anywhere in the spray coolant system to achieve the desired results. Check valves can be replaced with actuated valves or other devices.

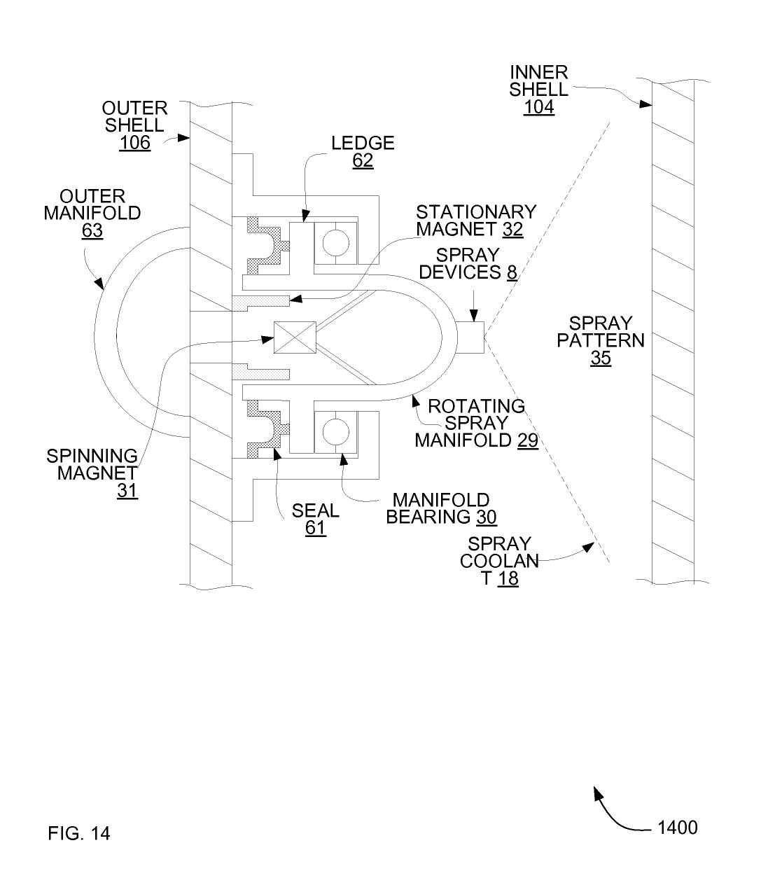

Option 22: Rotating Spray Devices: The spray devices 8 in FIG. 12 are fixed in stationary positions. The spray devices 8 can be mounted on a rotating spray manifold 29 with the manifold and the spray devices 8 rotating together on a wheel-like structure. A rotating manifold with spray devices 8 provides the benefit of overlapping spray patterns 35 without actually having the spray patterns 35 physically overlap. Overlapping spray patterns 35 can give increased redundancy in the cooling system. However, when the patterns do overlap (i.e. intersect each other), they change each other's spray/cooling characteristics in a way that can only be reliably determined through testing. The rotating spray manifold 29 concept can eliminate any requirement or need for significant physical spray pattern 35 overlap. A cross section of such a rotating manifold with Spray Devices is shown in FIG. 14. The rotating spray manifold 29 of FIG. 14 is mounted on the inner wall of the outer shell 106 (i.e. in the gap 110). The manifold distributes the spray coolant 18 to the spray devices 8 while the whole assembly rotates on a bearing or series of bearings called the manifold bearing 30. The rotating spray manifold 29 will require a seal 61, which is portrayed in FIG. 14 as a pressure-assisted dynamic seal, but can be any seal or sealing surface that adequately contains fluid. The manifold bearing 30 can be lubricated or cooled with spray coolant 18 or with other available apparatus. If spray coolant 18 is implemented as a bearing lubricant or bearing coolant then this can be accomplished by putting one or more small optional holes in the seal 61 so spray coolant 18 can flow to the manifold bearing 30. Any number of rotating spray manifolds 29 with any number of spray devices 8 can be implemented so long as the thrust chamber Inner shell 104 and other thrust chamber 102 components (such as the dome 220) have adequate cooling coverage. The rotating spray manifold 29 in FIG. 14 is driven by any of various options including electromagnetically or with motor driven gears, pulleys, chains and sprockets, friction wheels, pneumatics or any other apparatus of attaining rotational movement. This includes motors that are driven by electricity, pneumatics, hydraulics, and other methods. The electromagnetic option is similar to an electric motor or an electromagnetic accelerator commonly known as a mass driver or rail gun. Essentially the manifold can be driven with a combination of electromagnets and permanent magnets or with a combination of electromagnets. In FIG. 14 the spinning magnet 31 is one or more permanent magnets that are driven by one or more stationary magnets 32 attached to the outer shell 106. The stationary magnets are electromagnets. The polarity of the stationary magnet(s) 32 is changed in order to drive the spinning magnet(s) 31 similar to the operation of an electric motor. This polarity change is accomplished using methods similar to that of electric motors including using an electronic controller 33. These changes in polarity causes the spinning magnet(s) 31 and the stationary magnet(s) 32 to act against each other to produce a spinning motion of the rotating spray manifold 29. The spinning magnet 31 can be a permanent magnet with the stationary magnet 32 being an electromagnet, or the reverse of this can be the case, or both magnets can be electromagnets with one or both of the two undergoing polarity changes to drive the spinning of the manifold. Likewise, the manifold can be driven by charging electromagnetic coils (in the stationary magnet 32 or spinning magnet 31 or both) and then discharging one or both of them in an alternating and controlled fashion as in an electromagnetic accelerator using an electronic controller 33 or other methods of control such as implemented in electromagnetic accelerators. In this electromagnetic accelerator’ scenario both the spinning and stationary magnets 31, 32 can be electromagnets or at least one can be a permanent magnet. The rotational speed of the rotating spray manifold 29 can be any value so long as adequate cooling is obtained. As with fixed position spray devices 8, the spray patterns of the spray devices 8 on the rotating spray manifold 29 can overlap or not overlap. Some implementations locate the rotating spray manifold 29 on the cold wall of the inner shell 104 as opposed to the inner wall of the outer shell 106. Some implementations have rotating spray manifolds located on both shells. In some implementations the manifold is integral to either shell. This rotating spray manifold 29 method of application of spray coolant 18 can be implemented in combination with statically mounted spray devices 8 as well. Other options and characteristics of this cooling method include;

a.) It is an option to feed the rotating spray manifold(s) 29 with spray coolant 18 from a tube(s) or manifold(s) mounted on the exterior surface of the outer shell 106 with a coolant inlet hole(s) at each rotating spray manifold 29. Such a manifold, called the outer manifold 63 is shown if FIG. 14.

b.) The spinning magnet 31 can be located anywhere in or on the rotating spray manifold 29.

c.) The rotating spray manifold(s) 29 can be rotated by canting one or more of the spray devices 8 at an angle sufficient to induce rotation of the manifold when flowing spray coolant 18 (i.e without any other rotation device).

d.) The manifold bearing(s) 30 can be any type of bearing or bearing surface that will allow rotation of the manifold with ball bearings being one of the candidates.

e.) A rotating spray manifold 29 mounted on the outer shell 106 will induce a centripetal pressure that will work against the injection pressure of the spray devices 8. Such a resisting pressure will have to be compensated for by the operating pressure of the coolant feed tank 112 or coolant delivery pump 28. A rotating spray manifold 29 located on the inner shell 104 would induce a centripetal pressure that would increase the injecting pressure of the spray devices 8.

f.) Some implementations of a rotating spray manifold(s) 29 mounted on or part of the inner shell 104 include the feed tube(s) or manifold(s) that feed spray coolant 18 the manifold(s) are mounted on the cold wall of the inner shell 104.

g.) For a rotating spray manifold 29 the spray devices 8 are rotating on the manifold, but the spray coolant 18 in the manifold is effectively not rotating. This creates a shearing between the spray device 8 and the spray coolant 18 in the manifold that in turn creates a higher pressure-drop in the spray delivery system. This pressure drop can be reduced by having the spray coolant 18 inlet(s) to the manifold mounted tangential to the manifold that would make the coolant in the manifold follow a circular path around the manifold and thus flow (i.e. rotate) in the manifold in the same direction as the spray devices 8 are moving. Since the cooling fluid in the manifold and the spray devices 8 would be moving in the same direction, the shearing between them is reduced and thus shearing pressure drop is reduced. However, this rotational flow of coolant in the rotating spray manifold 29 will create a centripetal pressure that would also increase pressure drop in the system. The best option would be a compromise between the velocity of the rotating flow in the manifold and the shearing between the coolant and spray devices 8. Such a compromise would best be determined by testing. Another method of getting the spray coolant 18 in the rotating spray manifold 29 to rotate is to add baffles (i.e. vanes) to the interior of the manifold that would push the coolant in the same rotational direction that the manifold is moving. Inducing a rotation in the coolant in the same direction as the manifold will reduce the relative movement between the coolant and spray devices 8 which will also reduce the chance that such relative movement will effect the shape of the spray pattern 35 produced by the spray devices 8.

h.) The rotating spray manifold 29 shown in FIG. 14 should be considered to be an example only and can vary in configuration depending on available components and manufacturing processes. For instance, depending on available bearings, the manifold bearing 30 can double as both a bearing and a seal. In some implementations there can be a bearing utilized on both sides of the ledge 62. In some implementations the seal 61 can be of a different configuration depending on seal availability. In some implementations the stationary magnet 32 or the spinning magnet 31 can be shaped differently or mounted differently. In some implementations the rotating spray manifold 29 could be shaped, sized, or retained differently. For instance, the retaining ledge 62 can be a step-like structure as opposed to a ledge protruding out from the manifold. In some implementations the retaining ledge is eliminated entirely with a different type of retaining mechanism such as making the rotating spray manifold 29 and the manifold retainer 60 conical shaped. The unique thing about the rotating spray manifold 29 as shown in FIG. 14 is its ability to rotate and cool a thrust chamber via spraying at the same time, while the individual components can vary according to what is available in industry.

i.) A rotating spray manifold 29 mounted on the cold wall of the inner shell 104 would require a standoff device, most likely a tube, upon which would be mounted a Spray Device(2) (8) that would be pointed back at the inner shell 104 for cooling purposes. The standoff device would be mounted to the rotating spray manifold 29 and would hold the spray device(s) 8 far enough from the inner shell 104 so that the spray devices 8 would be effective in cooling the inner shell 104.

j.) The rotating spray manifold 29 and its associating hardware can be fabricated from any materials implemented to fabricate the thrust chamber 102 as discussed in previous sections herein. This also includes metals or polymers, reinforced or not reinforced.

Option 23: Spray Coolant Additives: The spray coolant 18 can be a pure fluid, a mixture of fluids, or a fluid with the addition of additives to obtain specific coolant characteristics. For example, if water is implemented as the spray coolant 18, in some implementations additives added to the water that either lower the freezing point, raise the boiling point, reduce the corrosion potential or to achieve any other effect of the water so long as the water still can absorb heat from the thrust chamber 102. In some implementations the spray coolant 18 is chilled or thermally adjusted prior to introduction to the spray cooling system. These same modifications can be performed on the internal film coolant 210 and nozzle film coolant 222 as well.

Option 23a: Phase of Spray Coolant: The spray coolant 18 can perform its cooling function in the liquid phase (all liquid), as a nucleate boiling liquid (i.e. with collapsing bubbles), as a boiling liquid (two phase fluid), as a supercritical fluid, or in the gaseous state (as a gas or vapor), or in any combination of these fluid states. In some implementations, the spray coolant 18 is chilled prior to introduction into the thrust chamber 102. The spray coolant 18 can be prechilled by cooling the spray coolant 18 before or after loading the spray coolant 18 into the coolant feed tank 112, or by cooling the spray coolant 18 with a heat exchanger 138 and a portion of one or all of the rocket engine main propellants as described above for cooling spray coolant 18 before or after the spray coolant 18 has absorbed heat from the thrust chamber 102. Pre-cooling the spray coolant 18 will allow the spray coolant 18 to absorb more heat from the thrust chamber 102 for a given spray coolant 18 flowrate.

Option 24: Spray Cooling System Pumps: The pumps in the spray cooling system can be any type of pump that can move the required fluid and can be driven by any type of device or energy source. Likewise any number of pumps can be implemented anywhere in the spray cooling system flow path so long as the pump (pumps) keep the spray coolant 18 moving at the desired flowrate. An example of the type of pumps that can be implemented in the spray cooling system would be electric motor driven centrifugal pumps powered by a battery(s), but not limited to this type of pump or energy source.

Option 25: Processes and Materials (cont'd): The thrust chamber 102 is made of a thin sheet metal or sheet metal composite. The thrust chamber 102 can be made to any wall thickness depending on the size and combustion chamber pressure of the engine, but a range of 0.020″ to 0.125″ would be typical. Any process or material or combination of these could be implemented to make the thrust chamber 102 as long as the thrust chamber 102 is of the appropriate thickness to take the structural and pressure loading of the thrust chamber 102 and will sufficiently conduct heat through the inner shell 104 to the spray coolant 18. Some of the possible candidate materials for the thrust chamber 102 include but are not limited to Inconel®, stainless steel, steel, copper, aluminum, reinforced polymers, unreinforced polymers and alloys, combinations, or composites of any of these materials or other materials. The outer shell 106 can be reinforced by wrapping the outer shell 106 in a composite material such as a filament wound overwrap such as graphite/epoxy, Kevlar/epoxy, or glass/epoxy or their equivalents or any other type of fiber/matrix composite either as a filament or tape winding or as a composite material cloth that is bonded or secured to the outer shell's 106 exterior surface. In addition, metallic stiffening ribs or structures can be welded, brazed, bonded, soldered, bolted, riveted, screwed, or fixed with other apparatus to the outer shell 106 to stiffen and strengthen the thrust chamber 102. Other options for this include formed composite ribs and structures of any shape that are secured or bonded to the outer shell's 106 exterior surface for the same purpose (of strengthening or stiffening the thrust chamber 102). Any structure can be added or formed into to the various surfaces of the thrust chamber 102 to strengthen or stiffen the thrust chamber 102 so long as these structures do not effect the functioning of the cooling system presented here.

Option 26: Film Coolant Injection Methods: The various options for injecting film coolant discussed in other sections herein also apply to thrust chambers that incorporate spray cooling. In addition, the injection options for the internal film coolant 210 injected into the thrust chamber 102 or combustion chamber 122 also apply to the nozzle film coolant 222 injected into the expansion nozzle 118.

It is an option to eliminate the film coolant valve 215 shown if FIGS. 11 and 12 and simply tap off the film coolant feedline 49 downstream of the propellant main valve (usually the main fuel valve but can be main oxidizer valve as well). In some implementations the baseline engine includes apparatus to branch the film coolant feedline 49 off of the main fuel feedline 40 downstream of the main fuel valve 150 which results in the main fuel valve 150 controlling both the internal film coolant 210 and the main fuel 103 flowrates. Nonetheless, in the baseline implementation a film coolant valve 215 includes an additional control of the engine start/shutdown process. A separate film coolant manifold/injector 218 as shown in FIG. 12 is not be necessary with certain types of main propellant injectors 116 where the film coolant manifold/injector 218 is built directly into the injector, such as is the case with many flat-face propellant injectors. Some implementations include a nozzle film coolant valve 126 to control the flow of coolant to the expansion nozzle 118. A nozzle film coolant valve 126 is not implemented in the baseline implementation (FIG. 12) but can be included.

Option 27: Cooling nozzle extensions: Rocket engines with largely expanded expansion nozzle 118s (4) typically have what is known as a nozzle extension. This is especially true for engines that are operable at high altitudes. A spray cooled thrust chamber 102 is compatible with such nozzle extensions that are cooled with existing conventional cooling methods known in the rocket industry as film cooling (with any film coolant), transpiration cooling, dump cooling, spray cooling, ablative cooling, regenerative cooling, radiation cooling and others or any combination of the above. These nozzle extensions can be secured to a thrust chamber by any apparatus including welding, bolting, riveting, clamping and others. The purpose of this paragraph is point out that conventional nozzle extensions that are additions to the spray cooled thrust chambers 102 are compatible with spray cooled thrust chambers 102 and can be added to the rocket engine.

Option 28: Other expansion nozzle 118 Options: Although in the baseline implementation of FIG. 12 the spray coolant 18 is expended as nozzle film coolant 222 in the expansion nozzle 118 to cool the nozzle using other methods as well: methods known in the rocket industry as dump cooling, or transpiration cooling, or regenerative cooling, or other methods or any combination of these methods.

A.) In some implementations the nozzle film coolant 222 is injected at a location above the throat 121 as opposed to downstream of the throat 121, as in the baseline implementation. In some implementations a portion or all of the spray coolant 18 that collects at the bottom of the gap 110 is injected directly along the hot-wall 204 above the throat 121 (i.e. as film or transpiration coolant). The injection can be accomplished with the pressure in the gap 110 or with a pump.

B.) In some implementations exhaust vapor that is generated from the spray coolant 18 is injected into the expansion nozzle 118 as film or transpiration coolant as well as liquid nozzle film coolant 222. In this case the exhaust port 15 can be reduced in size or even eliminated.

C.) Instead of the coolant recirculation pump(s) sending the spray coolant 18 back to the coolant feed tank 112, the pump(s) can pump a portion or all of the spray coolant 18 directly to the expansion nozzle 118 as nozzle film coolant 222.

D.) The lower coolant manifold 137 and the nozzle film coolant manifold/injector 216 can be combined into one manifold/injector.

E.) Any portions of the thrust chamber 102 can be spray cooled when and where helpful and spray cooling can be combined with other thrust chamber cooling methods where and when helpful.

Option 29: Closed Loop Option: If enough of the main propellants (main fuel 103 or main oxidizer 105 or both) or pressurant gas can be implemented to cool the spray coolant 18 so that all of the heat absorbed by the spray coolant 18 in the thrust chamber 102 is then absorbed by the one or both of the main propellants or pressurant gas or any combination of these fluids, then the spray coolant 18 can release enough of the absorbed heat (absorbed in the thrust chamber 102) for the cooling system to run in closed loop or semi-closed loop fashion. Thus, only a small amount of the spray coolant 18 running in the totally closed or semi-closed loop is required to cool the thrust chamber 102 with very little or no spray coolant 18 being expended during rocket engine operation. In this case either no coolant coolant feed tank 112 or only a very small coolant tank is required. In this way, the average overall temperature of the spray coolant 18 cannot increase or increase significantly (having given absorbed heat of the spray coolant to the main propellant/propellants, or pressurant gas) thus the coolant feed tank 112 can be very small or totally absent as compared to a system where spray coolant is being dumped overboard (from a rocket engine or rocket vehicle) or is being implemented to cool the expansion nozzle 118 as nozzle film coolant 222.

Option 30: Coolant Tube Options: The coolant tubes 7 shown in FIG. 12 can be replaced with any type of tube or manifolding made from any type of process or material that will bring spray coolant 18 to the spray devices 8 at the appropriate flowrate and pressure. This includes the coolant tubes 7 being one or more tubes that spiral around the thrust chamber 102, contoured tubes, or tubes mounted at an angle. This also includes replacing the coolant tubes 7 with manifolds, welded or otherwise, that are mounted to either the Outer or Inner Shells (5,6) or are integral with either the Outer or Inner Shells (5,6) or are mounted in the gap 110.

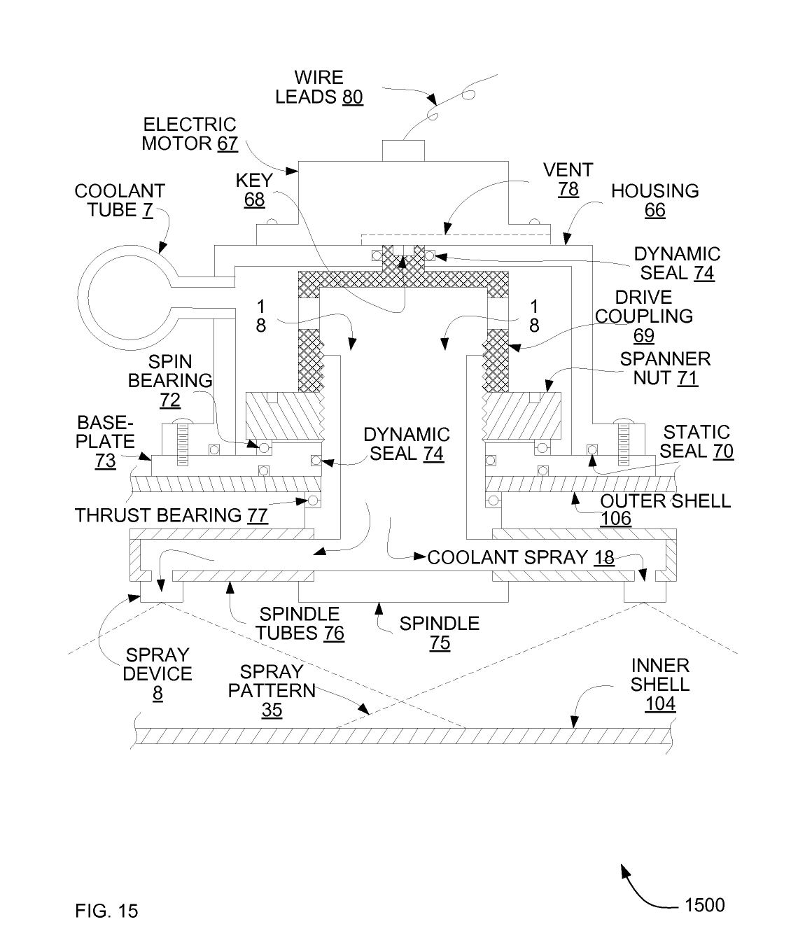

Option 31: Cooling Spindle Option: An alternative to the rotating spray manifold 29 for spinning the spray devices 8 is the cooling spindle 1500 as shown in FIG. 15. The appearance of the cooling spindle is similar to a pyrotechnic wheel (such as seen on the 4^{th} of July). The cooling spindle operates as follows:

The foundation of this cooling option is the rotating spindle 75. The spindle 75 is hollow to allow spray coolant 18 to flow through the spindle 75 on its way to the spray devices 8. The spray devices 8 rotate around the spindle's 75 longitudinal axis and the spindle 75 and spray devices 8 are driven (i.e. rotated) by an electric motor 67. The spray devices 8 are connected to the spindle 75 via tubes called spindle tubes 76 that are arranged around the spindle 75 like spokes on a wagon wheel. The assembly is covered by a housing 66 upon which the electric motor 67 is mounted. In one option, simple holes in the outer shell 106 are the only modifications required to mount the spindle 75. After the thrust bearing 77 is slipped over the spindle 75 the spindle is inserted through the hole in the outer shell 106 as shown in FIG. 15. Then the baseplate 73 is slipped over the spindle 75 with the appropriate static and dynamic seals 70, 74. Then the spin bearing 72 is put into place, and then the spanner nut 71 is screwed onto the threads at the end of the spindle 75 and tightened. The drive coupling 69 is then screwed on the spindle 75 threads and the other end of the drive coupling 69 engages the electric motor 67 with a key 68 mechanism. The drive coupling 69 and spanner nut 71 can be fabricated as one part but are shown as two parts in FIG. 15. The cooling spindle 1500 operates with spray coolant 18 flowing from the coolant tube(s) 7 into the housing 66. From the housing 66 the spray coolant 18 flows through holes in the drive coupling 69. From the drive coupling 69 the spray coolant 18 flows through the spindle 75 to the spindle tubes 76 to the rotating spray devices 8 where the coolant is sprayed onto the inner shell 104. The faster the rotation rate of the assembly, the more injection pressure there will be at the spray device 8 inlets. In addition, there are two features of this cooling method that have to be considered:

1.) The gap 110 has wide enough to accommodate a spinning object so that the spinning object (the cooling spindle 1500) does not hit the curved outer shell 106 next to it. Another option to widening the gap 110 is to contour the outer shell 106 to accommodate the cooling spindle 1500 without interference or to contour the cooling spindle 1500 to fit the gap 110.

2.) The cooling spindle 1500 rotates and traces out a circular overall pattern. The circular overall pattern of the overall spray pattern 35 overlaps adjacent spray patterns 35 to ensure 100% cooling area coverage with spray coolant 18.

Other options and feature of the cooling spindle 1500 are:

A.) In FIG. 15 the spray devices 8 are mounted to tubes that spin around an axis, but the spray devices 8 can be mounted to a hollow spinning wheel or other spinning shape (such as a hoop) as an alternative.

B.) As many spray devices 8 can be implemented on the spinning tubes (spindle tubes 76) or spinning wheel (or other spinning shapes) as is helpful.

C.) The spindle tubes 76 can have additional structural bracing attached to them where helpful.

D.) The electric motor 67 can be any type of electric motor that is adequate to the job of turning the cooling spindle 1500 including gear-motors, synchronous motors, and others. In addition, other types of rotational devices can be implemented in place of the electric motor 67 such as available devices powered by hydraulics or pneumatics.

E.) An optional vent 78 can be installed at the bottom of the electric motor 67 to allow the escape of coolant that may leak out of the adjacent dynamic seal 74 so that the coolant cannot penetrate into the electric motor 67.

F.) The thrust bearings 77 and spin bearings 72 shown in FIG. 15 are baselined as ball-bearing type bearings but can be any type of bearing that can take the loads and rpm's of the cooling spindle 1500. Likewise, the seals in FIG. 15 are shown as O-rings but can be other types of seals (such as pressure-assisted seals) so long as they can take the pressure, fluid exposure, and rpm's of the cooling spindle 1500.

G.) The cooling spindle 1500 can be made of any materials deemed adequate including metals or polymers, reinforced or not.

H.) In place of the coolant tubes 7 any type of manifolding capable of carrying spray coolant 18 to the cooling spindle 1500 can be implemented.

i.) One or more of the spray devices 8 on the cooling spindle 1500 can be canted at an angle to induce the cooling spindle 1500 to rotate without using a separate driving device such as an electric motor 67.

J.) The outer shell 106 is typically (but not always) a curved shell so that the bottom surface of the baseplate 73 should have an equivalent curve to the baseplate 73 to closely engage the curved surface that is the outer shell 106. In most cases the meeting of these two curved surfaces will be enough to prevent the baseplate 73 from slipping due to the torque from the electric motor 67. In those cases where slippage of the baseplate 73 will occur an additional key device (such as a screw or pin, etc.) can be implemented between the outer shell 106 and the baseplate 73 or anywhere else in the cooling spindle 1500 where helpful.

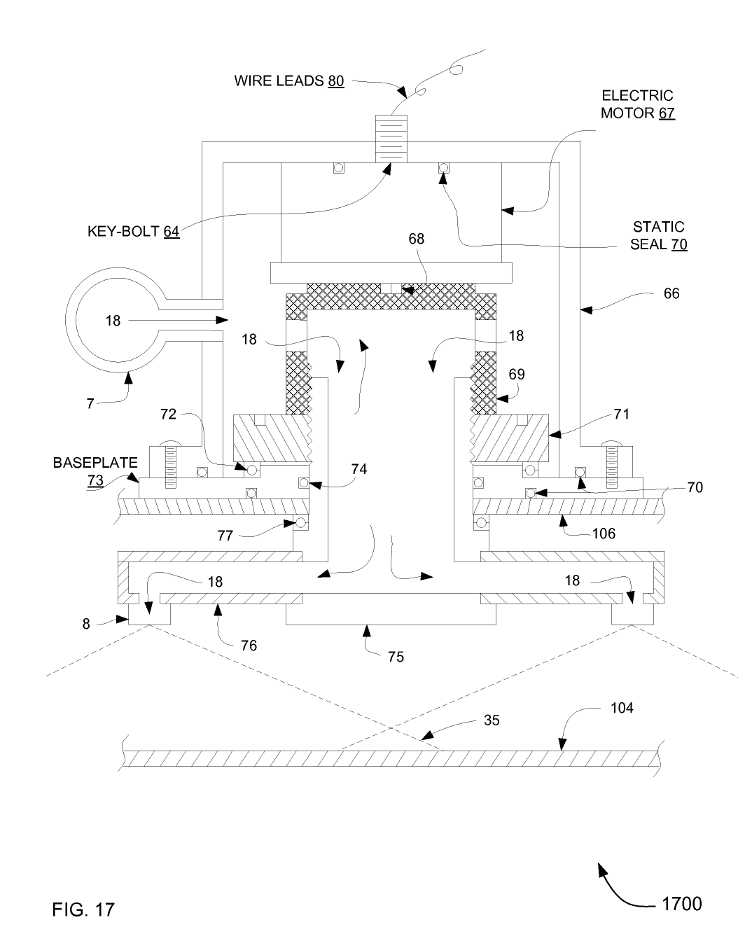

K.) As an option, the electric motor 67 can be mounted inside the housing 66 as shown in FIG. 17. The bolt sticking out of the top of the motor is a hollow combination bold and keying mechanism called the key-bolt 64. The key-bolt 64 is hollow to allow the wire leads to pass through.

L.) The drive coupling 69 can be modified to be a shaft with splines at both ends. The splines on one end can engage grooves inside the spindle 75 while the other end can engage a mating splined coupling attached to the electric motor 67.

Option 32: Other Spray Device Options: The spray device 8 can be any device that is capable of breaking up a liquid stream into a flow of droplets or fluid film. This includes not only spray nozzles that atomize by inducing a swirl to the fluid that they are spraying, but also nozzles that atomize the fluid by impingement, either as two or more fluid streams that impinge upon each other and thus atomize each other, or as one or more fluid streams that atomize by impinging on a solid surface(s). The surface(s) can be either the inner shell 104 itself (such as a simple orifice spray device 8 injecting fluid onto the inner shell 104), or the surface(s) can be another surface other than the inner shell 104 that atomizes the fluid stream (i.e. turns the fluid stream into a spray via impingement) before fluid stream impinges on the inner shell 104.

Option 33: Other Options for the Cooling Spindle: As mentioned previously the cooling spindle 1500 can be spun on its axis with either a motor-type device or by canting the spray devices 8 at an angle such that rotation of the spindle 75 will be induced. Or, spinning can be induced by installing an orifice(s) or other spray device(s) 8 in the spindle tube(s) 76 (or the equivalent to the spindle tube(s) 76 such as a hollow wheel) an angle of 90 degrees to the spray axis of the other spray device(s) 8 or at some other angle to the spray axis so that rotation of the spindle 75 will be induced in a way similar to the way some lawn sprinklers are induced to rotate. Also, any number of spray device(s) 8 can be installed any where on the spindle tubes 76 or the tubes' equivalent such as a spinning hollow wheel. This includes installing a spray device(s) 8 on or approximately on the bottom surface of the spindle 75 itself (i.e. the Spindle's surface nearest the inner shell 104.

### Simplified Thrust Chamber Regenerative Cooling System

A simplified thrust chamber regenerative cooling system is similar to the thrust chamber and recirculating cooling system of FIGS. 1 and 2 and the methods of FIGS. 7 and 8 except that the simplified thrust chamber regenerative cooling system accomplishes the goal of regenerative cooling of the thrust chamber 102 with one or both or a portion of the engine's main propellants. This is accomplished in a manner that results in a simplified thrust chamber 102 construction that is largely made of sheet metal. The simplified thrust chamber regenerative cooling system provides valve control to constantly minimize the maximum pressure differential (i.e. the deltap) across the inner shell 104 such that the inner shell 104 thickness can be minimized and the structural connections between the inner and outer shells 104, 106 can be minimized or eliminated thus resulting in a lighter, simpler, dual-shell regenerative cooled thrust chamber 102. The simplified thrust chamber regenerative cooling system is similar to the recirculating cooling system except that the main coolant consists of main propellant flowrate that is combusted in the combustion chamber 122 to produce thrust.

The main coolant, the regenerative coolant 10, is either the liquid rocket engine's main fuel flowrate, or the rocket engine's main oxidizer flowrate, or a combination or portion of either or both. The regenerative coolant (propellant) can be either the total flowrate of a propellant(s) flowing to engine or a portion of that propellant flowrate. After the propellant/coolant cools the thrust chamber 102, all or a portion of the propellant/coolant flows through the main propellant injector 116 and is burned in the combustion chamber 122. In addition, a portion of a propellant flowrate can be implemented as internal film coolant 210 that is described in other sections herein. The simplified thrust chamber regenerative cooling system provides control of valves and other apparatus to allow the regenerative cooled thrust chamber 102 to be built in a simplified form consisting of simple metal shell structures as will be described in the sections below. The unique use of valves and operation of the engine allows the use of a lightweight, simplified thrust chamber structure that will not collapse due to pressure during operation. The result is a thrust chamber 102 structure that is much simpler and easier to fabricate than current conventional, liquid propellant, regenerative cooled thrust chambers 102.

Conventional currently available regenerative cooled liquid propellant rocket engines utilize one of the main propellants as a coolant to cool the thrust chamber 102. Some implementations of the main propellants include the fuel and the oxidizer. The wall of the thrust chamber 102 is usually fabricated by a series of formed tubes that are brazed or welded together side by side like asparagus to form the thrust chamber 102. One of the main propellants flows through the tubes and cools the thrust chamber 102. In some implementations, the main propellant that flows through the tubes to cool the thrust chamber is the fuel. Conventional regenerative cooled thrust chambers 102 can also be formed with thick billets of copper alloys or other materials that are formed into the shape of a thrust chamber 102 and then have cooling channels fabricated into them for the regenerative coolant 10 to flow in. These channels are then sealed with the application of the thrust chamber 102's (1) outer wall that is conventionally fabricated by processes that include but are not limited to electroplating, vapor deposition, plasma spraving, etc. These processes are typically very expensive and only accomplished by a few companies throughout the world for rocket engines. The simplified thrust chamber regenerative cooling system can be fabricated by numerous low-cost metal fabricators that are found throughout industry anywhere in the world.

### Simplified Regenerative Cooling Attributes

Simplified regenerative cooling simplifies the engine fabrication to the point where a balance is achieved between a rocket engine that is low cost and a rocket engine that has enough performance (i.e. Isp performance) to fly useful missions.

The simplification of the thrust chamber 102 is accomplished in six specific ways:

1.) Simple Shell Construction in which the main thrust chamber 102 components include simple thin metal shells (6, 7) called the inner shell 104 and outer shell 106.

2.) Elimination of Coolant Tubes: Simplified regenerative cooling eliminates the large number of fluid coolant tubes necessary to cool the thrust chamber 102 which usually number from dozens to hundreds of Coolant Tubes in conventional regenerative cooled thrust chamber 102s. The simple shell structure greatly simplifies and expedites fabrication of the thrust chamber 102.

3.) The Use of Low-Cost, Readily Available Materials: Because the thrust chamber inner shell's 104 interior surface wall (i.e. the hot wall 204 or the hot-gas-side wall) can be maintained at modest temperatures (i.e. below about 1000 deg F. as a maximum), low-cost materials that maintain their strength at these low-to-medium temperatures may be implemented instead of exotic, rare, or expensive materials that must maintain sufficient strength at temperatures above approximately 1000 deg F.

4.) Adjustable Coolant Safety Factor (optional): In some implementations a portion of the regenerative coolant 10 is recirculated back to an appropriate propellant tank of the regenerative coolant 10, the appropriate propellant tank being the fuel tank, the oxidizer tank or both. The regenerative coolant 10 is recirculated by a recirculation pump 108 and thus become available or reuse. The flowrate of the regenerative coolant 18 can be adjusted to any value. The recirculation of the regenerative coolants 10 provides more coolant flowrate than necessary to cool the engine/thrust chamber 102, thus ensuring a large, generous and adequate cooling safety factor. The regenerative coolant 10 flowrate can be increased for better cooling and lower fabrication tolerances without additional loss of coolant. For example, if a thrust chamber 102 is cooled with jet fuel as the regenerative coolant 10, more jet fuel than necessary as a coolant can be flowed in the gap 110 between the inner and outer shells 104, 106 to increase the cooling safety factor. The excess regenerative coolant 10 not burned in the thrust chamber 102 can be pumped back to its propellant tank and its excess heat removed in a heat exchanger 138 that is cooled with all or a portion of the main oxidizer flowrate.

5.) Looser Tolerances Possible In Fabrication: Since all of the rocket system's main fuel 103 or main oxidizer 105 flowrate or both or any portion of those can be implemented as regenerative coolant 10, or more regenerative coolant 10 than necessary to cool the thrust chamber 102 can be implemented as coolant, the gap 110 between the inner and outer shells 104, 106 will be wide enough to allow for greater tolerance values. As an example, the size of the gap 110 might be 0.125″ with a tolerance of ±30% which would translate to ±0.0375 or a total tolerance range of 0.075 which is considered to be a very loose tolerance in commercial circles. These larger gap 110 sizes and tolerance ranges make the thrust chamber 102 easier to produce using commonly available, low-cost fabrication methods such as, but not exclusive to, spinning, stamping, rolling, bending, welding, brazing, soldering, plating, and/or machining of all kinds. The larger size of the gap 110 also greatly increases the number of vendors (including lower cost vendors) that can be selected to fabricate acceptable and working thrust chambers 102.

6.) Large gap 110 Sizes Give Less Plugging and Pressure Drop: For the reasons presented above, larger gap 110 sizes between the Inner and Outer Shells are possible (i.e. greater than approximately 0.05″ depending on engine size). The larger the gap 110 size, the less susceptible the gap 110 is to plugging from contaminants and the less sensitive to contaminants that the overall propulsion system would be. Plugging inhibits the flow of regenerative coolant 10 and thus creates hot spots in the thrust chamber 102 that could lead to chamber failure.

For every level of rocket engine heat flux (btu/in̂2-sec) flowing into the thrust chamber 102 there must be a minimum fluid velocity above which the regenerative coolant 10 in the gap 110 must flow in order to keep the thrust chamber 102 from overheating and failing. The regenerative coolant 10 fluid velocity below which the thrust chamber 102 will fail is called the burnout velocity’, the point at which the thrust chamber 102 inner shell 104 will melt or fail structurally due to weakening from excessive heating. Higher values of engine heat fluxes mean a higher minimum regenerative coolant 10 fluid velocity is required to avoid burnout. The higher the required minimum burnout velocity, the narrower the gap 110 for a given regenerative coolant 10 flowrate, the highest area of heat flux in the thrust chamber 102 being at or near the throat 121. Since all of one or all of the main propellants can be implemented as regenerative coolant 10 or more regenerative coolant 10 than necessary can be implemented, the gap 110 dimension will always be sufficiently large (i.e. i.e. greater than approximately 0.050″, depending on engine size) to be less susceptible to contaminant plugging. In addition, larger gap 110 dimensions mean proportionally less fluid pressure drop in the regenerative cooling system.

A smaller coolant flow passage results in a proportionally higher pressure drop in the thrust chamber 102 coolant fluid system due to increasing surface friction/boundary layer effects. On a rocket vehicle a higher coolant system pressure drop results in a heavier coolant tank/tanks (i.e. a main propellant tank in this case) or a higher horsepower pump to pump the coolant. The result is a rocket vehicle with higher inert weight and is thus capable of carrying less useful payload. This is especially true because coolant system pressure drops get disproportionately higher the smaller the coolant fluid flow passage is. A minimum coolant velocity (burnout velocity) can be maintained and exceeded with larger coolant flow passage sizes (i.e. gap 110 sizes) since all of one or all of the main propellants can be implemented as the regenerative coolant 10 or more regenerative coolant 10 implemented (as coolant) than necessary.

### Baseline Rocket Engine Configuration for Simplified Regeneratively Cooled Thrust Chamber

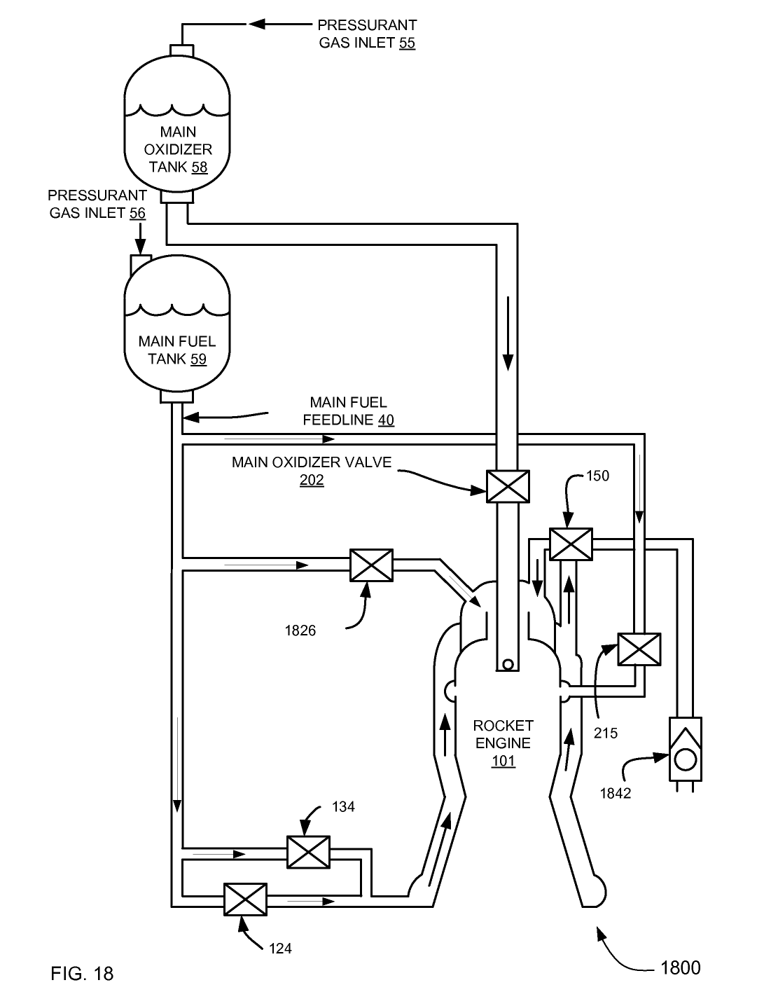

A baseline rocket engine for a simplified regenerative cooled thrust chamber is a liquid, bi-propellant rocket engine using jet fuel as the main fuel 103 and liquid oxygen as the main oxidizer 105. The structure of the engine's thrust chamber 102 is a double shell structure with an inner and outer shell 104, 106 (FIGS. 18, 19, and 20) and a gap 110 in between where the regenerative coolant 10 flows. The baseline material of construction for the shells is an Inconel® metal alloy. The main propellant injector 116 for the engine is a pintle type of injector as originally developed in the early 1960's. The combustion chamber 122 operating pressure is 300 psia. The engine is regenerative cooled exclusively with the jet fuel where the total fuel flowrate to the engine flows through the gap 110 to cool the thrust chamber 102 shells. After flowing through the gap 110 the great bulk of the jet fuel flows through the main propellant injector 116 where the jet fuel is injected into the combustion chamber 122 and is burned as one of the two main propellants. A portion of the jet fuel (approx. 3.7% of the total fluid flow to the engine) is injected at the top of the thrust chamber 102 along the hot-gas wall (204) of the inner shell 104 (i.e. along the inside wall of the combustion chamber 122) where the jet fuel functions as the internal film coolant 210 where the jet fuel reduces the heat flux to the regenerative coolant 10.

The baseline rocket engine is a pressure-fed engine, where the main propellant tanks are pressurized to the point where they can feed the propellants directly into the thrust chamber 102 without the use of main propellant pumps. In addition, details of the baseline implementation exemplary only and can vary from rocket engine to rocket engine.

### Detailed Description and Operation of the Simplified Regenerative Cooled Baseline Configuration

The primary feature is a thrust chamber 102 consisting of a double walled shell structure consisting of the inner and outer shells 104, 106. For orientation purposes, the inner shell 104 has a hot wall adjacent to the engine's combustion flames and a cold wall that is opposite to the hot-wall. The outer shell 106 has an inner wall in between the two shells and an outer wall that is the exterior surface of the thrust chamber 102.

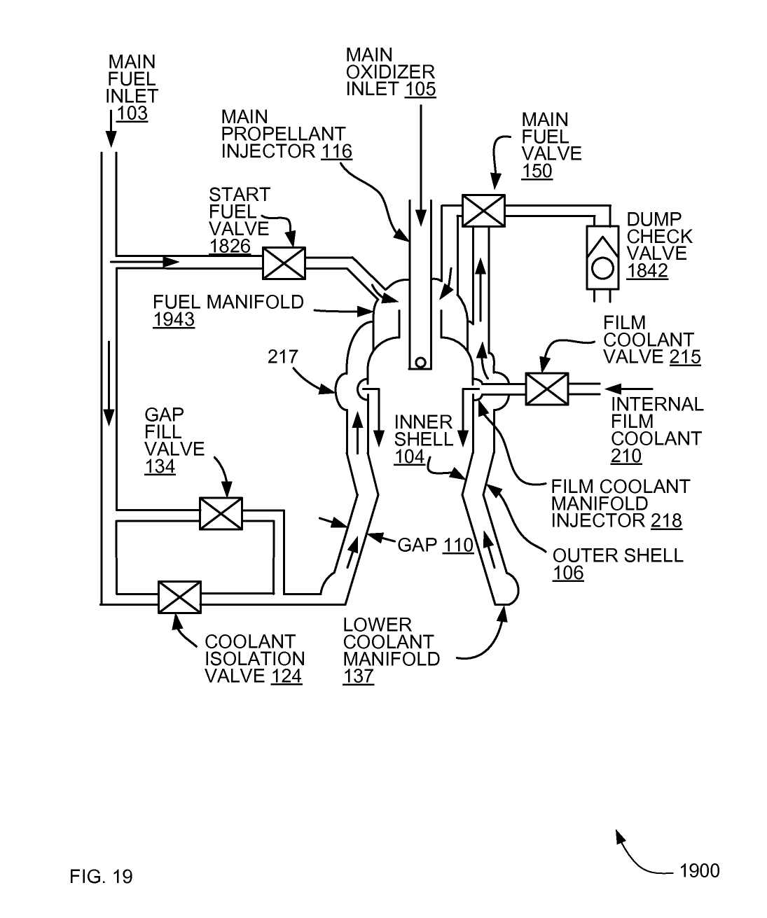

As previously mentioned, the baseline rocket engine configuration (shown in FIG. 19) is a “pressure fed” rocket engine (i.e. engine is fed propellants directly from pressurized tanks and not from turbopumps) and contains six basic engine valves, the main oxidizer valve 202, the fuel start valve 1826, the film coolant valve 215, the coolant isolation valve 124, the main fuel valve 150, and the gap fill valve 134. The main fuel valve 150 is a three-way valve. When actuated one way, the main fuel valve 150 dumps the fuel/coolant overboard from the engine. When the main fuel valve 150 is actuated the other way, the fuel/coolant dump closes and the fuel/coolant flows into the main propellant injector 116 as one of the two main propellants running the engine. FIG. 19 represents the baseline engine configuration which uses fuel to cool the thrust chamber but the valves can be rearranged to cool the thrust chamber 102 with oxidizer as well. The valves can be represented by single or multiple valves. The way the valves function is as follows:

In implementations where the pressure in the gap 110 between the inner and outer shells 104, 106 is less than the critical pressure required to collapse the inner shell 104 prior to engine startup (i.e. before the Main Propellants are burning and there is pressure in the combustion chamber 122), then the coolant isolation valve 124, the gap fill valve 134, and the fuel start valve 1826 mentioned above are optional. One or all of them can be implemented.

When the regenerative coolant 10 fluid operating pressure in the gap 110 is higher than the critical external collapse pressure of the inner shell 104 (when engine not running), then the gap 110 pressure cannot be allowed come up to full operating value until the engine has started and the combustion chamber 122 pressure is at the full operating value (300 psia as an example). Preventing the pressure in the gap 110 to come up to full operating value reduces the maximum pressure differential that the inner shell 104 is exposed to during its useful life.

As an example, a rocket engine with a combustion chamber 122 pressure of 300 psia, the pressure of in the gap 110 assuming fuel regenerative coolant 10 would be about 350-390 psia. Depending on the size of the engine and the thickness of the inner shell 104 this may be enough to collapse the inner shell 104 before the engine has started and the combustion chamber 122 pressure has come up to 300 psia because this would result in a differential pressure of about 335-375 psid across the inner shell 104 (before the engine has started). After the engine has started the differential pressure across the inner shell 104 would only be about 35-75 psid, which is much less pressure differential trying to collapse the inner shell 104 (than there was before the engine started). The goal is to have an inner shell 104 that can withstand a pressure differential of 35-75 psid (in this example) without collapsing or buckling but not 335-375 psid.

Therefore, with proper valve control and timing the pressure in the gap 110 is allowed to come up to full operating pressure (about 350-390 psia) only after the combustion chamber 122 pressure has reached its full operating value (300 psia as an example). In other words the increase in gap 110 pressure slightly lags the increase in combustion chamber 122 pressure. The result would be a thinner inner shell 104 and/or less required attachment points between the inner and outer shells 104, 106 (to resist buckling (of the inner shell 104)). The thinner inner shell 104 would result in a lighter engine that is more efficient in transferring heat (i.e. operates at a lower temperature) to the regenerative coolant 10. The valve control/timing for doing this is accomplished as follows:

Prior to engine startup, the gap 110 in between the inner and outer shells 104, 106 is filled with regenerative coolant 10; this is done by opening the gap fill valve 134 with the main fuel valve 150 in the ‘dump’ position (the ‘dump’ position of the valve routes regenerative coolant 10 overboard from the engine). The gap fill valve 134 is either appropriately orificed, appropriately sized, or cyclically opened and then closed in order to fill the gap 110 without collapsing the inner shell 104. After the gap 110 is filled with coolant the gap fill valve 134 is closed. During this process all other engine valves are closed.

In some implementations the gap fill valve 134 includes a metering device or implemented therewith so that during the filling process the gap 110 pressure never exceeds the collapse pressure of the inner shell 104. The gap 110 can also be filled from a port connected to a separate source of coolant/propellant. The port would then simply be plugged (or closed off) once the gap 110 is filled, or the gap 110 can be filled with the coolant isolation valve 124 opened before the propellant/coolant tank has been pressurized above the collapse pressure of the inner shell 104.

Once the gap 110 is filled with regenerative coolant 10 and the gap fill valve 134 is closed, the engine is started as follows:

The fuel start valve 1826 and the main oxidizer valve 202 are opened to start the rocket engine and ignition of the propellants occurs in the combustion chamber 122. As the pressure in the thrust chamber 102's combustion chamber 122 starts to rise (after ignition), the coolant isolation valve 124 begins to open and starts regenerative coolant 10 flow through the gap 110 to cool the thrust chamber 102 during the engine start process. The main fuel valve 150 is currently in the dump position so any coolant flowing through the gap 110 at this time is dumped overboard. As soon as the combustion chamber 122 pressure rises to its full operating value (or nearly so) of 300 psia in the baseline implementation the main fuel valve 150 is actuated from the ‘dump’ position to the ‘run’ position which directs the fuel coolant to the engine's main propellant injector 116. As the main fuel valve 150 is being thusly actuated and in unison with it, the fuel start valve 1826 is actuated closed at the same time (or nearly the same time) as the main fuel valve 150 is actuated to the ‘run’ position. With this actuation sequence the gap 110 pressure is allowed to come up to full operating pressure without collapsing or buckling the inner shell 104 (because the combustion chamber 122 pressure helps resist collapse of the inner shell 104). This is necessary because the fuel/coolant in the gap 110 is at a higher pressure than the thrust chamber 102 internal pressure because the gap 110 has the added pressure of the main propellant injector's 116 pressure drop (gap 110 operating pressure is about 350-400 psia as an example) and could collapse the inner shell 104 before the combustion chamber 122 pressure comes up to 300 psia. In some implementations a check valve is included downstream of the fuel start valve 1826.

In some engines the inner shell 104 will not collapse when the gap 110 is at full operating pressure whether the engine has started or not. The possibility of collapse of the inner shell 104 depends on the size of the engine, the thickness inner shell 104, the material of the inner shell 104, the operating temperature of the inner shell 6, the pressure drop of the main injector (2), and other influences. However, if the pressure of the regenerative coolant 10 in the gap 110 can potentially exceed the collapse pressure of the inner shell 104, then the previous valve sequence is how the engine can be started and run without collapsing or buckling the inner shell 104 given that the inner shell 104 and overall thrust chamber 102 are implementationed to handle the maximum pressure differential that is actually achieved across the inner shell 104.

### Simplified Regenerative Cooling System Options

The options for the Simplified regenerative cooling system include but are not limited to the options discussed herein. This includes (but not limited to) the options discussed below as well as options concerning combustion chamber type, engine main propellants, main propellant injector types, film coolants, film coolant injection methods and locations, gap spacer bolts, nozzle extension cooling methods, construction materials and processes, thrust chamber surface enhancements, and others.

Option 1: Regenerative Coolant: The type of propellant implemented as the regenerative coolant 10 in the thrust chamber 102 regenerative cooling system can be any propellant that is either a liquid, supercritical fluid, gas, boiling liquid, or any fluid phase so long as the propellant can absorb heat flowing through the thrust chamber 102 inner shell 104 while allowing the inner shell 104 to remain cool enough so that the inner shell does not melt or fail structurally during engine operation.

Option 2: Regenerative Coolant/Propellant Additives: The regenerative coolant 10 can be a pure fluid, a mixture of fluids, or a fluid with the addition of additives to obtain specific coolant characteristics. For example, if jet fuel is implemented as the regenerative coolant 10 the jet fuel can include additives that either lower the freezing point, raise the boiling point, reduce the corrosion potential or achieve any other effect so long as the jet fuel can absorb the heat from the thrust chamber 102. In some implementations, the regenerative coolant 10 is chilled or thermally adjusted prior to introduction to the simplified regenerative cooling system. These same modifications can be performed on the internal film coolant 210 as well.

Option 3: Gap Spacing: There are many options of maintaining the gap 110 between the inner and outer shells 104, 106. The gap 110 could be void with no structures or solid items in the gap 110; for example the gap 110 can include spacers of any shape, size, or material; the gap 110 can include ribs that are formed or machined on the cold wall of the inner shell 104 and/or the inner wall of the outer shell 106; the gap 110 can include ribs that are loose but installed in the gap 110; the gap 110 can include ribs that are bonded or secured to the inner or outer shells 104, 106 using any methods. In some implementations, the spacing of the gap 110 is maintained by rivet, bolt, or screw heads; rivets, bolts, or screws that protrude through the outer shell 106, but have their heads within the gap 110, the heads acting as spacers and the inner and outer shells 104, 106 being unattached to each other except at their ends. The rivets, bolts, or screws would be sealed to the outer shell 106 to prevent fluid leakage with solder, braze, or polymer sealant but any sealing method will do so long as the sealing method does not impair the heat absorbing ability of the simplified regenerative cooling system, nor the structural integrity of the rocket engine.

The inner and outer shells 104, 106 could be only attached to each other directly or indirectly at their ends, or they can be secured to each other intermittently across their surfaces with rivets, bots, welded studs, or by other apparatus. The inner and outer shells 104, 106 are secured to each other to prevent the inner shell 104 from collapsing from a high regenerative coolant 10 pressure that creates a higher than critical differential pressure across the inner shell 104. Reasons for a higher than critical (for buckling) differential pressure include regenerative coolant 10 maximum operating pressure in the gap 110, acceleration effects on the regenerative coolant 10, and the drop in static pressure near the throat 121 and in the expansion nozzle 118 after the engine starts, and others.

So, for a simple shell-structure thrust chamber 102 the inner and outer shells 104, 106 can be free floating from each other (i.e secured to each other only at their ends, either directly or indirectly), or can have any type of rib or spacer in the gap 110 made of any material that is adequately compatible with the regenerative coolant 10 and secured using any methods, or the inner and outer shells 104, 106 can be secured to each other intermittently across their surfaces using any method including bolts, rivets, studs, welding, brazing, soldering, and bonding of any kind, including adhesive bonding.

Option 4: Valve Usage: The baseline of the simplified regenerative cooling system requires the use of a thrust chamber 102, main propellant tank, the fuel start valve 1826, the film coolant valve 215, the coolant isolation valve 124, the main fuel valve 150, and the gap fill valve 134 and, of course, pipe or tubing to connect these components together. Any valves in the system are optional and can be added, modified, or removed to improve coolant handling, loading, and draining, system operation and timing, safety, and to prevent collapse of the inner shell 104 in implementcations where the Regenerative Coolant System is at a higher pressure than the minimum collapse pressure of the inner shell 104. Some of the optional valves include but are not limited to manual valves, actuated valves, relief valves, check valves, pyrotechnic valves, guillotine valves, blade valves, and others, and can be located anywhere in the Regenerative Coolant System. Check valves can be replaced with actuated valves.

Option 5: Pump or Pressure Fed: This type of simplified rocket thrust chamber 102 regenerative cooling system can be implemented to cool any type of rocket engine thrust chamber 102 whether the engine has its main propellants fed as a pressure-fed rocket engine (i.e. main propellants fed to the engine solely by pressurizing the main propellant tanks) or as a pump-fed rocket engine (i.e. where the main propellants are fed to the engine by a pump or pumps, usually but not always a turbopump/turbopumps).

Option 6: Regenerative Coolant Flow Direction: The regenerative coolant 10 can flow in either the ‘up’ or ‘down’ directions or in any other direction (such as in a spiral), including circumferentially or spirally, as long as regenerative coolant 10 can cool the thrust chamber 102. In some implementations, the flow of the regenerative coolant 10 starts at the expansion nozzle 118 and flow upwards towards the main propellant injector 116 as previously described. In some implementations, the flow of the regenerative coolant starts near the injector-end of the engine and flows downward towards the expansion nozzle 118. In some implementations, the regenerative coolant 10 starts flowing at the thrust chamber 102 middle and flow towards the ends of the thrust chamber 102. In some implementations, a portion of the regenerative coolant 10 is bled off as internal film coolant 210 anywhere required in the thrust chamber 102.

Option 7: Phase of Regenerative Coolant: The regenerative coolant 10 can perform its cooling function in the liquid phase (all liquid), as a nucleate boiling liquid (i.e. with collapsing bubbles), as a boiling liquid (two phase fluid), as a supercritical fluid, or in the gaseous state (as a gas or vapor), or in any combination of these three fluid states. In some implementations, the regenerative coolant 10 is chilled prior to introduction into the thrust chamber 102. In some implementations, the regenerative coolant chilled by cooling the regenerative coolant 10 before or after loading the regenerative coolant 10 into the main propellant tank, or by cooling the regenerative coolant 10 with a heat exchanger 138 and a portion of one or all of the rocket engine main propellants as described above for cooling regenerative coolant 10 after the regenerative coolant 10 has absorbed heat from the thrust chamber 102. Pre-cooling the regenerative coolant 10 will allow the regenerative coolant 10 to absorb more heat from the thrust chamber 102 for a given regenerative coolant 10 flowrate.

Option 8: Cooling Injectors: In addition to cooling the thrust chamber 102 the regenerative coolant 10 can be implemented to cool any portion of the main propellant injector 116.

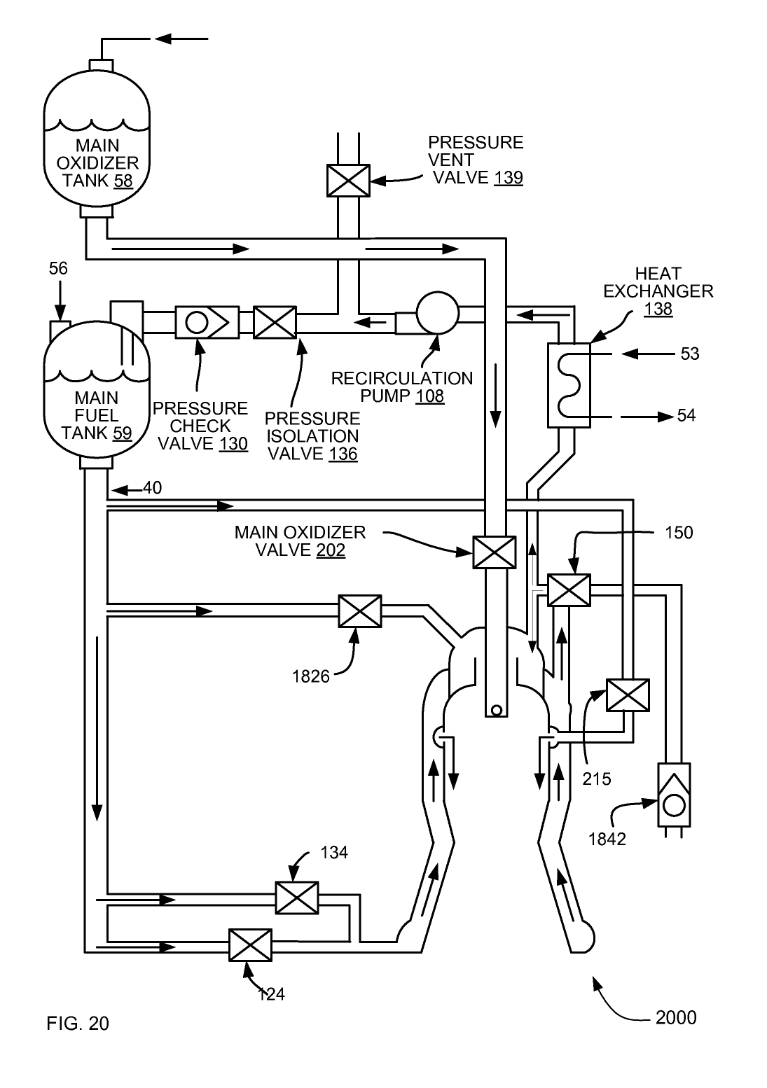

Option 9: Optional Regenerative Coolant Recirculation System: To make the gap 110 larger for manufacturing convenience, more regenerative coolant 10 can be flowed through the gap 110 between the inner and outer shells 104, 106 than is necessary to cool the thrust chamber 102 below its maximum allowable temperature. Since excess regenerative coolant 10 is flowing through the thrust chamber 102, that portion of regenerative coolant 10 that is not injected into the thrust chamber 102 as main propellant or internal film coolant 210 is recirculated back to the appropriate propellant tank for reuse with a recirculation pump 108 located anywhere desired in the regenerative coolant loop 30 (pump shown at the top of the engine in FIG. 20). The recirculation pump 108 is any type of pump that can pump the regenerative coolant 10 and can be electrically, hydraulically, or pneumatically driven or driven by any other apparatus so long as the pump pumps the coolant. The regenerative coolant loop 30 includes all flow lines, valves, tanks, and other components to recirculate at least a portion of the regenerative coolant 10 in a continuous path (i.e. a round-and-round loop) as the regenerative coolant loop 30 cools the thrust chamber 102.

The output pressures of the recirculation pump 108 can be any value, but output pressure of the recirculation pump 108 must at least be enough to compensate for the pressure drop and head difference (height difference) of the regenerative coolant 10 as the regenerative coolant 10 flows through the regenerative coolant loop 30. The output pressure of the recirculation pump must also be less than the amount of pressure required to cause the inner shell 104 to collapse. Typical values (for example only, other values applicable) of the recirculation pump's 108 output pressure could fall between approximately 5 to 100 psid (differential pressure across pump) but the ultimate value is determined by the regenerative coolant loop's 30 pressure drop, the height difference of the cooling loop, and the effects of the local acceleration field.

The baseline regenerative coolant loop 30 as shown in FIG. 20 also has a heat exchanger 138 for cooling the excess regenerative coolant 10 of the heat regenerative coolant loop 30 has absorbed in the thrust chamber 102. The heat exchanger 138 is optional and can be placed anywhere in the regenerative coolant loop 30.

Option 10: Recirculation Pumps: For the regenerative coolant loop option the regenerative coolant 10 recirculation pump 108 can be any type of pump that can move a fluid and can be driven by any type of energy source. Likewise any number of pumps can be implemented anywhere in the regenerative coolant 10 flow path as long as the pump (pumps) keeps the excess regenerative coolant 10 recirculating at the desired flowrate.

Option 11: Cooling the Regenerative Coolant (when implemented with Regenerative Coolant Loop System): After the regenerative coolant 10 (i.e. propellant) has cooled the thrust chamber 102 the regenerative coolant 10 will be warmed from the heat absorbed by the regenerative coolant 10 from the thrust chamber 102. For the Regenerative Coolant Loop option, the portion of the regenerative coolant 10 that is being recirculated back to the its perspective propellant tank can be run through a heat exchanger 138 to cool the regenerative coolant 10 as the regenerative coolant 10 is being pumped back to its appropriate propellant tank. The heat exchanger 138 can be located anywhere in the regenerative coolant loop 30. The heat exchanger 138 can take the form of a coiled tube(s), a coiled and finned tube, straight tubes, straight finned tubes, or any other configuration that is suitable for cooling the recirculating regenerative coolant 10. The fluids implemented to cool the recirculating regenerative coolant 10 would be one or both or any of the rocket engine's main propellants (i.e. the main fuel and/or main oxidizer) or rocket vehicles pressurant gas. To cool the recirculating regenerative coolant 10 the heat exchanger 138 would located at one of several possible locations: inside the main oxidizer tank 58, inside the main fuel tank 59, or inside both main propellant tanks, inside the main pressurant gas tank 33, inside the main oxidizer feedline 39 (that feeds the engine), inside the main fuel line 40 (that feeds the engine), inside the main pressurant gas lines 55, 56 (that pressurizes the main propellant tanks), or mounted around the outside of the main fuel, main oxidizer, or pressurant gas lines 40, 39, 55, 56. In some implementations, a small pump pumps main propellant over the heat exchanger 138 to absorb heat from the recirculating regenerative coolant 10. In some implementations, the main propellant is routed to the heat exchanger 138 with presssure. In some implementations, a portion of either or both of the main propellants is diverted into the heat exchanger 138 to cool the recirculating regenerative coolant 10 and then the main propellant coolant is dumped overboard the rocket vehicle, or is rediverted to combust in or to cool the engine/engines, or is routed back to the main propellant tank(s). The heat exchanger 138 can be implemented to run the cooling system. The heat exchanger 138 can be of any location and configuration using any fluid within a rocket vehicle or system so long as the heat exchanger 138 absorbs the heat the recirculating regenerative coolant 10 has absorbed in the thrust chamber 102. One of the optional heat exchanger 138 configurations include but is not limited to spraying one or both of the main propellants on the heat exchanger 138 to absorb heat. Any methods that use main propellants as a coolant(s) for the heat exchanger 138 are also applicable to using the rocket vehicle's pressurant gas or pressurant fluid as a coolant in the heat exchanger 138. The use of more than one heat exchanger 138 is also an option.

Option 12: Processes and Materials: The thrust chamber 102 is made of a thin sheet metal or sheet metal composite. The thrust chamber 102 can be made to any wall thickness depending on the size and combustion chamber pressure of the engine, but 0.020″ to 0.125″ would be typical. Any process or material or combination of these could be implemented to make the thrust chamber 102 as long as the thrust chamber 102 is of the appropriate thickness to take the structural and pressure loading of the thrust chamber 102 and will sufficiently conduct heat through the inner shell 104 to the regenerative coolant 10. Possible materials for the thrust chamber 102 include Inconel®, stainless steel, steel, copper, aluminum and alloys or composites of all of these materials or other materials. The outer shell 106 can be reinforced by wrapping the outer shell 106 in a composite material such as a filament wound overwrap such as graphite/epoxy, Kevlar/epoxy, or glass/epoxy or their equivalents or any other type of fiber/matrix composite either as a filament or tape winding or as a composite material cloth that is bonded or secured to the Outer Shell's (7) exterior surface. In addition, metallic stiffening ribs or structures can be welded, brazed, bonded, or soldered to the outer shell 106 to stiffen and strengthen the thrust chamber 102. Other options for this include formed composite ribs and structures of any shape that are formed into, attached, or bonded to the outer shell's 106 exterior surface for the same purpose (of strengthening or stiffening the thrust chamber 102). Any structure can be added to or formed into the various surfaces of the thrust chamber 102 to strengthen or stiffen the thrust chamber if these structures do not effect the functioning of the cooling system presented here.

Option 13: Type Of Fluids for Conductive Coolant: In some implementations, the internal film coolant 210 need not be the same types of fluid as those that make up the main propellants. For example, in a Liquid Oxygen/Hydrogen engine in which lox/LH2 are main propellants, the combustion chamber 122 internal film coolant 210 could be one of many different coking fluids or fuels while the regenerative coolant 10 could be a main propellant such as hydrogen or oxygen or both. Fluids can be mixed and matched to best cool the engine for a particular mission or engine implementation. The internal film coolant 210 can also be a noncoking fluid such as liquid or gaseous hydrogen.

Option 14: Regenerative Coolant Can Cool Any Part of thrust chamber 102 or Main Propellant Injector: The regenerative coolant 10 cools the thrust chamber 102 that cools the combustion chamber 122, expansion nozzle 118, main propellant injector 116, the thrust chamber dome 220, or any of these components whole or in part, separately or in combination with each other, or any other part of the thrust chamber 102.

Option 15: Using Regenerative Coolant to Power Rocket Engine and/or Rocket Vehicle Machinery: Some implementations include a regenerative coolant 10 that, when cooling the thrust chamber 102, will evaporate into a gas or vapor or uses a liquid or supercritical fluid that has been warmed to the point where the regenerative coolant 10 will expand when flowing through a nozzle or orifice, then a portion of the warmed regenerative coolant 10 fluid can be implemented to power mechanical machinery implemented in association of the rocket engine or rocket vehicle. For example, the warmed regenerative coolant 10 can be implemented to power (i.e. spin) a turbine that powers pumps for pumping some or all of the rocket engine's main propellants and/or coolants. Or the warmed fluid can be implemented to power electrical generators, positive displacement pumps, or any other mechanical devices that can be powered with expanding fluid. Another option is to use a portion of the regenerative coolant 10 to cool all or part of the expansion nozzle 118 or dump the regenerative coolant 10 overboard as described above.

Option 16: Liquid or Hybrid Rockets: The simplified regenerative cooling system can be implemented on hybrid propellant rockets as well as liquid propellant rockets and rocket engines, which can use any number of liquid propellants including monopropellants. Hybrid rockets have at least one propellant that is a liquid and at least one propellant that is a solid, such as a rubber or plastic. The use of the simplified regenerative cooling system can use the hybrid rocket's liquid main propellant as the regenerative coolant 10. The internal film coolant 210 can either be the hybrid rocket's liquid main propellant or can be another fluid in a separate tank and plumbing system (i.e. form the main propellant).

Option 17: Throat/Expansion Nozzle Plug: As an option to valve control and timing or more attach points (between the inner and outer shells) to prevent collapse of the inner shell 104 a plug can be put in or near the throat 121 or in the expansion nozzle 118. The plug would allow the combustion chamber 122 and/or complete thrust chamber 102 to be pressurized with gas to the point where the inner shell 104 will not collapse when the gap 110 is at full pressure before the engine has started. Upon engine start the plug would be ejected from the engine whole or would break apart and then be ejected after which the thrust chamber 102 would be at full operating pressure and thus buckling of the inner shell 104 would be avoided.

Option 18: Check Valves: Upper stage rocket engines that are climbing in altitude but have not yet ignited face the possibility of collapsing the inner shell 104 depending on the exact implementation of the upper stage rocket engine. The reasons for the possible collapse are two-fold. One is that the rocket vehicle is most likely increasing in acceleration and thus the regenerative coolant 10 that has been prefilled into the gap 110 is coming under increasing static head pressure. The second reason is that the pressure inside the combustion chamber 122 is constantly decreasing and approaching a vacuum as the rocket vehicle climbs through the atmosphere. This drop in pressure in the combustion chamber 122 results in an increasing pressure differential across the inner shell 104 and could threaten to collapse the inner shell 104 depending on the specific implementation of the thrust chamber 102. The dump check valve 1842 cannot significantly reduce the increase in gap 110 pressure due to head height and acceleration effects without wasting significant propellant/coolant. Preventing inner shell 104 collapse due to these effects would be prevented by inner shell 104 thickness and/or material or by attaching the inner shell 104 to the outer shell 106 using methods described in other sections herein. In some implementations, the dump check valve 1842 is set to a cracking pressure (i.e. about 0.1 to 10.0 psia depending on the type of fluid in the gap 110) that would allow the gap 110 to vent while the rocket vehicle is climbing in the atmosphere (or outside the atmosphere) and thus prevent the inner shell 104 from collapsing due to the decrease in local atmospheric pressure or due to thermal expansion effects while at the same time the pressure in the gap 110 will be kept high enough (0.1 to 10.0 psia) to prevent the regenerative coolant 10 in the gap 110 from vacuum boiling. The dump check valve 1842 can be replaced with an actuated valve or other type of relief device.

Option 19: Film Coolant Valve/Manifolding Options: The internal film coolant 210 can be controlled with its own film coolant valve 215 as shown in FIG. 19 or the film coolant valve 215 can be eliminated and the internal film coolant 210 fed directly from the gap 110 if the regenerative coolant 10 is a fluid that is sufficient as a film coolant. Other options include routing a film coolant carrying tube or tubes directly from anywhere downstream of the fuel start valve 1826 or main fuel valve 150 to the film coolant manifold/injector 218 with or without a film coolant valve 215 depending on the specific control requirements of the engine. Likewise the engine configuration of FIG. 19 can utilize a film coolant valve 215 as shown in the figure or the internal film coolant 210 can be tapped off anywhere downstream of the main fuel valve 150 without a film coolant valve 215. The film coolant bypass 217 in FIG. 19 is shown at the gap 110 wrap around the film coolant manifold/injector 218. Other options for the bypass include bypassing the film coolant manifold/injector 218 with a tube or tubes or one or more welded manifolds or other methods.

Option 31: Coolant Recirculation Loop Return Line: The return line taking excess regenerative coolant 10 back to the main fuel tank 59 (or other propellant tank) of the regenerative coolant loop 30 is shown in FIG. 20 as branching off downstream of the main fuel valve 150. An option to this branch point is to branch off the return line upstream of the main fuel valve 150. As mentioned previously in some implementations, the regenerative coolant 10 is a propellant other than fuel.

Option 32: Valve Options: Other than the check valves, all the valves implemented in the above rocket systems are assumed to be actuated valves. In some implementations, actuated valves can be substituted for the check valves, or manual valves can be implemented in the system where helpful. Any other types of valves can be implemented where helpful such as relief valves, pyrotechnic valves, guillotine valves, blade valves, and others.

33.) Option 33: Controlling Coolant Recirculation Loop (30) Pressure: The pressure vent valve 139 as shown in FIG. 20 can be implemented to prevent over-pressure of the regenerative coolant loop 30 due to thermal expansion or other effects. The pressure vent valve 139 can be an actuated valve or other valve implemented for relief and venting purposes.

34.) Option 34: Film Coolant Flowrate Options: The flowrates of the internal film coolant 210 as a percentage of total fluid flowrate to the rocket engine and/or thrust chamber is adjustable to values other than those values described in the previous sections so long as the regenerative coolant 10 is able to adequately absorb the heat transferred to the inner shell 104 while keeping the thrust chamber 102 intact. Likewise, the operating pressures in the combustion chamber 122 and gap 110 can be set to whatever values, so long as the heat transfer and structural integrity of the thrust chamber 102 is maintained.

### Method Implementations

In the previous section, apparatus of the operation of an implementation was described. In this section, an implementation of a particular method is described by reference to a flowchart.

FIG. 7 is a flowchart of a method 700 to cool a rocket engine through recirculation of a convective coolant 214. In method 700, at least a portion of a convective coolant 214 is circulated at least twice through a gap 110 between an inner shell 104 of a thrust chamber 102 and an outer shell 106 of the thrust chamber 102.

Method 700 includes a pressurized coolant feed tank 112 pushing a convective coolant 214 into the entry point 142 of the gap 110 between the inner and outer shells 104, 106 of a thrust chamber 102, at block 702.

Method 700 also includes the convective coolant 214 absorbing heat from the thrust chamber 102 when flowing in the gap 110, at block 704.

Method 700 also includes the convective coolant 214 flowing out an exit point 146 of the gap and flowing through a heat exchanger 138 releasing heat absorbed in the thrust chamber 102 to any of main propellants or pressurant fluid, at block 706.

Method 700 also includes the convective coolant 214 flowing into a recirclation pump 108 that pumps the convective coolant 214 back into the coolant feed tank 112, at block 708.

Method 700 also includes recirculating the convective coolant 214 from the coolant feed tank 112 back to the entry point 142 of the gap 110 to begin cooling cycle again, at block 710.

FIG. 8 is a flowchart of a method 800 to cool a rocket engine according to an implementation. Method 800 includes injecting an internal film coolant 210 onto an interior hot-wall 204 of a thrust chamber 102 of the rocket engine, at block 802.

Some implementations of method 800 also include circulating a convective coolant 214 through a gap 110 in the structure of the thrust chamber 102 of the rocket engine, at block 804.

Method 800 also includes injecting the convective coolant 214 onto the interior wall 206 of the expansion nozzle 118 as a nozzle film coolant 222, at block 806. The internal film coolant 210 and the convective coolant 214 are injected in various proportions described in other sections herein.

In one implementation briefly described in FIG. 1 above, dual coolants are implemented for the internal film coolant 210 and the convective coolant 214. “Coking” hydrocarbon internal film coolant 210 flows on the inner wall surface 204 (the hot wall side) of the thrust chamber 102 and a convective coolant 214 flows in a gap 110 between an inner shell 104 and an outer shell 106. In some implementations, the internal film coolant 210 minimizes the amount of convective coolant 214 required.

In addition to flowing through the gap 110 in the thrust chamber 102 a portion of the convective coolant 214 is released, along the inside surface of the expansion nozzle 118 where the convective coolant 214 cools at least a portion of the expansion nozzle 118 as a film coolant.

In one implementation the dual coolants include a coking, hydrocarbon internal film coolant 210, (usually a fuel as listed below) that absorbs heat, and that in turn, decreases the amount of heat that is absorbed by the thrust chamber 102 by carbon deposition and heat absorption. The heat that is absorbed by the thrust chamber 102 is then absorbed by the convective coolant 214 that flows in the gap 110.

In other examples of non-limiting variations, a coking or hydrocarbon internal film coolant 210 is a fuel such as jet fuel (like Jet-A or JP-4), kerosene and kerosene-based fuels, rocket fuel (such as RP-1), propane, butane, and/or liquid or gaseous methane or others. In that variation block 802 of method 800 includes spraying a certain amount of coking internal film coolant 210 against the inside hot-wall 204 surface of the rocket engine thrust chamber 102 downstream or upstream of the main propellant injector 116. The flow rate of coking internal film coolant 210 is approximately 1 to 10 percent of the total fluid flow to the propulsion system, including the main propellants (main fuel 103 and oxidizer 105) that can flow through the main propellant injector 116 and coolants. The amount of internal film coolant 210 can vary beyond the range of 1 to 10 percent. The deposition of carbon is a result of the decomposition of coking internal film coolant 210 by the heat that the coking internal film coolant 210 absorbs from the propellant burning within the thrust chamber 102. The internal film coolant 210 can be injected onto the thrust chamber 102 hot-wall 204 in either the liquid, boiling, supercritical, or gaseous states as long as the coking internal film coolant 210 deposits carbon on the inside hot-wall 204 surface of the thrust chamber 102.

The reduction of heat flow that results from the deposition of carbon from the internal film coolant 210 results in less heat will flow through the thrust chamber 102 inner shell 104 and less convective coolant 214 flow rate will be required in the gap 110 of the thrust chamber 102 to absorb it. Thus a coking hydrocarbon (carbon depositing) internal film coolant 210 results in less required convective coolant 214, that in turn results in a more efficient engine that produces higher thrust for a given total fluid flow rate to the rocket engine (i.e. propellant flow rate plus coolant flow rate). The coking internal film coolant 210 also provides a simple, low-cost construction and materials as described above. The coking internal film coolant 210 can be injected into the thrust chamber 102 using orifices arranged in a vortex pattern (see FIG. 3 and 4), injected parallel to the inner wall of the thrust chamber 102, injected perpendicular to the thrust chamber hot-wall, or injected at an angle to the hot-wall. To inject the coking internal film coolant 210, any number, geometry, size, or orientation of orifices can be implemented. The coking internal film coolant 210 can also be injected in the thrust chamber 102 at as many film coolant injection stations or rings as desired. The exact orientation, geometry, or number of internal film coolant 210 injection orifices is not critical so long as the internal film coolant 210 deposits the appropriate amount of carbon in the appropriate areas of the thrust chamber 102. In some implementations, the internal film coolant 210 is dispersed at more than one location along the inside 204 hot-wall surface of the thrust chamber 102. The injection options for the internal film coolant 210 are also valid for the nozzle film coolant 222.

The heat that gets through the carbon layer that is deposited by internal film coolant 210 and thus through the thrust chamber 102 is absorbed by convective coolant 214 that is flowing through the gap 110 between the outer shell 106 and inner shell 104 of the thrust chamber 102. In some implementations, the convective coolant 214 is one of any clean-evaporating noncoking fluids (i.e. non-coking at the temperature range when flowing in the gap 110 such as water, gaseous hydrogen, liquid hydrogen, jet fuel, kerosene, rocket fuel, propane, methane, or others. The requirement for the external convective coolant 214 is clean evaporation (i.e. does not deposit carbon within the gap 110 when at the temperature range achieved when within the gap 110.) Deposition of carbon or other residue within the gap 110 detrimentally reduces the flow rate of convective coolant 214 and reduces efficiency of the convective coolant 214 in absorbing the heat that gets through the thrust chamber 102 inner shell 104, thus resulting in undesirably high thrust chamber 102 temperatures, high convective coolant 214 pressure drops, with attendant reduced flow rates, or both.

The function of internal film coolant 210 is to minimize the amount heat flowing through the thrust chamber 102 so the amount of convective coolant 214 that is required is also reduced. If the amount of convective coolant 214 is minimized then the overall performance of the engine propulsion system will be increased. For systems utilizing a heat exchanger, the recirculation pump 108 and heat exchanger 138 will be smaller and lighter and cooling safety factor increased for a given convective coolant 214 flowrate.

In other examples of non-limiting variations, the convective coolant 214 is composed entirely of water that circulates in the gap 110. The water convective coolant 214 flows through the gap 110 upward from the expansion nozzle 118 to the top of the combustion chamber 122. When water convective coolant 214 flows to the top of the combustion chamber 122 a number of options of flow are available depending on the exact configuration of the engine. In some examples, the water (convective coolant 214) is injected along the internal wall 206 (the hot-gas-side wall) as film coolant in a similar manner that the internal film coolant 210 is injected as film coolant higher up near the main propellant injector 116. However, in the propulsion system of FIGS. 1, 2, 5, 11, 12, and 16 the convective coolant 214 is routed to the expansion nozzle 118 where the convective coolant 214 cools a portion of the expansion nozzle as film coolant.

Control of all cooling fluids will be implemented by sequencing valves to release and maintain the flow of cooling fluids to prevent overheating of engine components. Control of the sequencing valves for the cooling fluids is coordinated with timing and operation of the engine main propellant valves and igniter signals. Any method of sequencing of such valves common to or typical of control of rocket engines, such as the use of signals from the rocket vehicle flight computer, or from an independent engine control computer, or other sequencing electronics, can be implemented to control signals to the coolant control valve(s).

In some implementations, sufficient pressure is maintained in all coolant fluids so that flow of the coolant fluids is adequate to cool the engine for the operation of the engine during the flight. This pressure can be generated by a number of apparatus, such as through pumps or pressurized gas systems.

The flow of engine coolant fluids can be controlled so that coolant is present when the engine generates heat that, in the absence of cooling fluid, can damage the engine. The flow of engine fluid coolants can be controlled by opening and closing valves that gate coolant flow to the engine. The cooling valves are turned ON and OFF at specific times so that A) coolant fluid is not wasted when not needed and 2) coolant flow prevents engine overheating.

Thus, the timed control of coolant valves are coordinated with the main engine valves that turn ON and OFF the flow of main propellant into the rocket engine, because the heat generated by the burning of the main propellants (main fuel 103 and oxidizer 105) are removed by the coolant to prevent engine overheating and damage. A conventional method of controlling the sequencing of these valves is to use a small engine control computer that is attached to the rocket. This engine control computer can be the flight computer, which also has overall control of the guidance, navigation and control of the rocket vehicle; or the engine control computer can be a dedicated engine control computer acting as a sequencing device.

One purpose of the engine control computer is to generate electrical control signal commands that can have at least two electrical control states: a high voltage (or current) state and a low state. Some signal-generating electrical systems can also generate intermediate states so that a continuous signal level, from low to high can be generated. These signals are sent from the computer to the valve actuators. A valve actuator is a mechanical device that generates force and motion in two different directions, depending on level of the electrical states the valve actuator receives from the computer. Thus the control states generated by the computer will have the effect of opening and closing the coolant valves.

In some implementations, the timing of the control signals to the coolant valves is controlled by a software program stored in the engine control computer. The engine control computer has the typical features of any computer, and others common to hardened industrial computers and flight computers on rocket vehicles, namely:

1) A computer application program (software) that is stored in a memory device in the engine control computer.

2) A method of generating the application program and transferring the application program into the engine control computer. In some implementations, the transfer is performed well in advance of operation of the engine.

3) Sufficient built-in hardware common to all computers, such as volatile memory, registers, program counters, etc, needed to support the operation of a stored program capable of executing the application program.

4) A stored program or set of instructions that can execute the application program.

5) Input and output (I/O) lines which are hardwired to the engine control computer that send low-current/low-voltage electrical signals to and from signal conditioners or amplifiers.

6) Signal conditioners or power amplifiers that adjust the amplitude of signals going to and from the engine control computer to controlled devices and external sensors so that these signals can be received by the engine control computer or external device.

7) Environmental hardening so that the engine control computer can withstand conditions typical of rocket flight, including vibration, elevated temperatures, and vacuum conditions.

8) A communications line leading from outside the rocket vehicle to the engine control computer so that external countdown procedures on the ground can trigger the initiation of the applications program. This can be as simple as a single I/O line or can be a serial or parallel line that communicates to ground control.

The application program generates state outputs to the cooling system valves so that cooling fluid flows and prevents excessive temperatures from occurring in the engine.

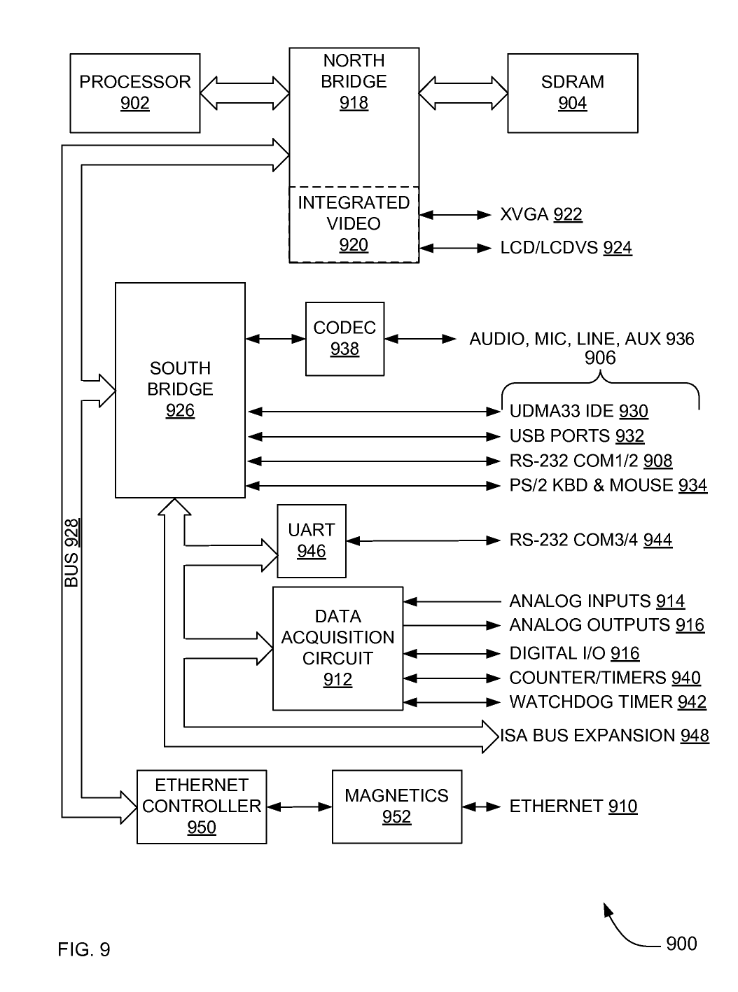

In some implementations, method 800 is implemented as a sequence of instructions which, when executed by a processor, such as processor 904 in FIG. 9, cause the processor to perform the respective method. In other implementations, method 800 is implemented as a computer-accessible medium having executable instructions capable of directing a processor, such as processor 904 in FIG. 9, to perform the respective method. In varying implementations, the medium is a magnetic medium, an electronic medium, or an optical medium.

### Hardware and Operating Environment

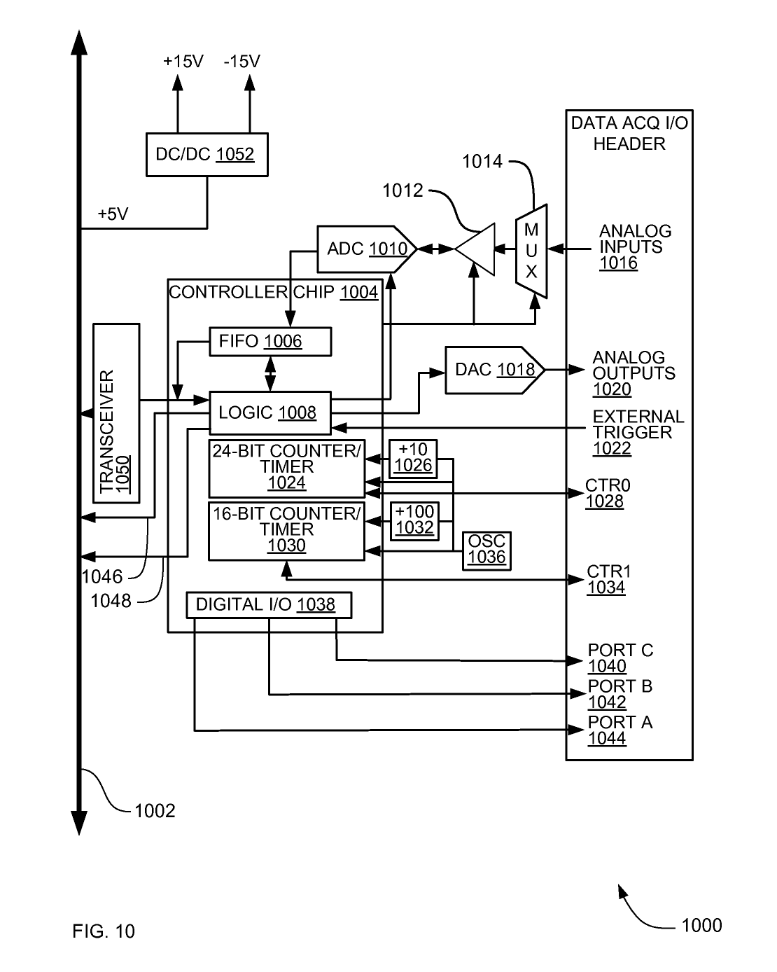

The description of FIG. 9 and FIG. 10 provides an overview of electrical hardware and suitable computing environments in conjunction with which some implementations can be implemented. Implementations are described in terms of a computer executing computer-executable instructions. However, some implementations can be implemented entirely in computer hardware in which the computer-executable instructions are implemented in read-only memory. Some implementations can also be implemented in client/server computing environments where remote devices that perform tasks are linked through a communications network. Program modules can be located in both local and remote memory storage devices in a distributed computing environment.

FIG. 9 is a block diagram of an engine control computer 900 in which different implementations can be practiced. The engine control computer 900 includes a processor (such as a Pentium III processor from Intel Corp. in this example) which includes dynamic and static ram and non-volatile program read-only-memory (not shown), operating memory 904 (SDRAM in this example), communication ports 906 (e.g., RS-232 908 COM1/2 or Ethernet 910), and a data acquisition circuit 912 with analog inputs 914 and outputs and digital inputs and outputs 916.

In some implementations of the engine control computer 900, the data acquisition circuit 912 is also coupled to counter timer ports 940 and watchdog timer ports 942. In some implementations of the engine control computer 900, an RS-232 port 944 is coupled through a universal asynchronous receiver/transmitter (UART) 946 to a bridge 926.

In some implementations of the engine control computer 900, the Ethernet port 910 is coupled to the bus 928 through an Ethernet controller 950.

With proper digital amplifiers and analog signal conditioners, the engine control computer 900 can be programmed to drive coolant control gate valves, either in a predetermined sequence, or interactively modify coolant flow by opening and closing (or modulating) coolant control valve positions, in response to engine or coolant temperatures. The engine temperatures (or coolant temperatures) can be monitored by thermal sensors, the output of which, after passing through appropriate signal conditioners, can be read by the analog to digital converters that are part of the data acquisition circuit 912. Thus the coolant or engine temperatures can be made available as information/data upon which the coolant application program can operate as part of decision-making software that acts to modulate coolant valve position in order to maintain the proper coolant and engine temperature.

FIG. 10 is a block diagram of a data acquisition circuit 1000 of an engine control computer in which different implementations can be practiced. The data acquisition circuit is one example of the data acquisition circuit 912 in FIG. 9 above. Some implementations of the data acquisition circuit 1000 provide 16-bit A/D performance with input voltage capability up to ±10V, and programmable input ranges.

The data acquisition circuit 1000 can include a bus 1002, such as a conventional PC/104 bus. The data acquisition circuit 1000 can be operably coupled to a controller chip 1004. Some implementations of the controller chip 1004 include an analog/digital first-in/first-out (FIFO) buffer 1006 that is operably coupled to controller logic 1008. In some implementations of the data acquisition circuit 1000, the FIFO 1006 receives signal data from and analog/digital converter (ADC) 1010, which exchanges signal data with a programmable gain amplifier 1012, which receives data from a multiplexer 1014, which receives signal data from analog inputs 1016.

In some implementations of the data acquisition circuit 1000, the controller logic 1008 sends signal data to the ADC 1010 and a digital/analog converter (DAC) 1018. The DAC 1018 sends signal data to analog outputs. The analog outputs, after proper amplification, can be implemented to modulate coolant valve actuator positions. In some implementations of the data acquisition circuit 1000, the controller logic 1008 receives signal data from an external trigger 1022.

In some implementations of the data acquisition circuit 1000, the controller chip 1004 includes a digital input/output (I/O) component 1038 that sends digital signal data to computer output ports.

In some implementations of the data acquisition circuit 1000, the controller logic 1008 sends signal data to the bus 1002 via a control line 1046 and an interrupt line 1048. In some implementations of the data acquisition circuit 1000, the controller logic 1008 exchanges signal data to the bus 1002 via a transceiver 1050.

Some implementations of the data acquisition circuit 1000 include 12-bit D/A channels, programmable digital I/O lines, and programmable counter/timers. Analog circuitry can be placed away from the high-speed digital logic to ensure low-noise performance for important applications. Some implementations of the data acquisition circuit 1000 are fully supported by operating systems that can include, but are not limited to, DOS™, Linux™, RTLinuX™, QNX™, Windows 98/NT/2000/XP/CE™, Forth™, and VxWorks™ to simplify application development.

### CONCLUSION

An economical liquid, bipropellant propulsion and cooling system is described. A technical effect of the system is sufficiently high thrust from a propulsion system that is economical to manufacture through recirculation of a convective coolant 214 through a gap around a thrust chamber. Although specific implementations are illustrated and described herein, it will be appreciated by those of ordinary skill in the art that any arrangement which is calculated to achieve the same purpose can be substituted for the specific implementations shown. This disclosure is intended to cover any adaptations or variations.

The systems, methods and apparatus herein describe a low-cost rocket engine technology that can be implemented to produce rocket engines of a very wide range of thrust sizes or propellant combinations for private, commercial, or government aerospace programs. The economical engine systems, methods and apparatus described herein will increase the confidence of these organizations in obtaining rocket engines at greatly reduced cost and procurement times. In addition, the economical systems, methods and apparatus described herein reduce the procurement lead time of rocket engines and the procurement costs. The systems, methods and apparatus described herein provide faster and cheaper development and reproduction of rocket engines of a very wide range of thrust sizes or propellant combinations (i.e. combinations of fuel and oxidizer).

In particular, one of skill in the art will readily appreciate that the names of the methods and apparatus are not intended to limit implementations. Furthermore, additional methods and apparatus can be added to the components, functions can be rearranged among the components, and new components to correspond to future enhancements and physical devices implemented in implementations can be introduced without departing from the scope of implementations. One of skill in the art will readily recognize that implementations are applicable to different thrust chambers 102, inside walls 204, combustion chambers 122, expansion nozzles 118, expansion nozzle interiors 206, expansion nozzle exteriors 208, main propellant injectors 116, oxidizers 105, fuels 103, internal film coolants 210, gaps 110, recirculation pumps 108, heat exchangers 138, spray devices 8, coolant tubes 504, convective coolant 214, and injectors 216.

The terminology implemented in this disclosure includes injectors, propellants, coolants, thrust chambers and alternate technologies which provide the same functionality as described herein.

1-72. (canceled)

73. A rocket engine system comprising:
a thrust chamber having a gap between an inner shell and an outer shell, the inner shell and the outer shell being attached together to form at least a portion of the thrust chamber; and
flowing a convective coolant into an entry point in a gap between an inner shell and an outer shell of a thrust chamber; and
circulating convective coolant through the gap from the entry point out through an exit point at a second location in the gap; and
a recirculating cooling system operably coupled to the gap in at least two locations and operable to recirculate convective coolant through the gap and a convective coolant loop; and
circulating a convective coolant at least twice through a gap between an inner shell of a thrust chamber and an outer shell of the thrust chamber.

74. The rocket engine system of claim 73, wherein more convective coolant flows through the gap than is required to cool at least a portion of the thrust chamber below a maximum allowable temperature of the thrust chamber; and
wherein the gap is between the inner and outer shell for at least a portion of the thrust chamber and convective coolant recirculates through the gap cooling at least a portion of the thrust chamber; and
wherein convective coolant flows through the gap in an amount that is about 1.1 to 25 times more than what is required to cool at least a portion of the thrust chamber below a maximum allowable temperature of the thrust chamber; and
expending the convective coolant to the extent that substantially little or no amount of convective coolant remains in a coolant feed tank when the desired amount of main propellant is expended.

75. The rocket engine system of claim 73, wherein the recirculating cooling system further comprises:
a recirculating convective coolant loop that couples a thrust chamber gap, a heat exchanger, a recirculation pump, and a coolant feed tank; and
wherein unexpended convective coolant is continuously recirculated through a convective coolant loop by the internal pressure of the coolant feed tank and the pressure added to the convective coolant by the recirculation pump; and
a heat exchanger that is operable to remove heat from at least a portion of the convective coolant; the heat exchanger coolant being any of the main propellants or pressurant fluid.

76. The rocket engine system of claim 73, wherein the recirculating cooling system further comprises:
injecting at least a portion of the convective coolant onto the interior wall of the expansion nozzle of the thrust chamber as a nozzle coolant.

77. The rocket engine system of claim 73, wherein the inner and outer shells further comprises:
a thin metal shell structure, the thickness of each shell being between about 0.010 inches and about 0.50 inches; and
a structure further comprising solid items in the gap or formed into the inner and outer shells as necessary to maintain the gap or to attach the shells together as necessary; and;
wherein the thickness of these solid items being in addition to the thickness of the inner and outer shells; and
a thrust chamber structure constructed of common materials such as metals, metal alloys, metal compounds, metal composites, plastics, plastic composites, and composite materials.

78. The rocket engine system of claim 73, wherein the thrust chamber has an internal film coolant injected onto at least a portion of the thrust chamber interior hot-wall.

79. The rocket engine system of claim 73, wherein the recirculating cooling system has a low pressure feed tank; and
the convective coolant is fed into the gap by a pump and is returned to the coolant feed tank by the recirculation pump.

80. The rocket engine of claim 73, wherein at least a portion of convective coolant is expended overboard through a coolant metering device.

81. A rocket engine system comprising:
a thrust chamber having a gap between an inner shell and an outer shell, the inner shell and the outer shell being attached together to form at least a portion of the thrust chamber; and
a recirculating cooling system operably coupled to spray devices in the gap and operable in a continuous recirculating spray coolant loop; and
wherein the spray devices project a spray coolant onto the cold-wall of the inner shell to cool at least a portion of the thrust chamber.

82. The rocket engine system of claim 81, the method comprising:
projecting a spray coolant onto an inner shell, the projecting performed by spray devices in a gap between an inner shell of a thrust chamber and an outer shell of the thrust chamber that; and
expending the spray coolant to the extent that substantially little or no spray coolant remains in the coolant feed tank when the desired amount of main propellant is expended.

83. The rocket engine system of claim 81, wherein the spray devices are statically mounted spray nozzles in the gap and are spraying a spray coolant onto the cold-wall of the inner shell to cool at least a portion of the thrust chamber.

84. The rocket engine system of claim 81, wherein the spray devices are mounted to one or more rotating spray manifolds in the gap that circumscribe the circumference of the thrust chamber, wherein a spray manifold further comprises a moving manifold that is spun by one or more permanent magnets and one or more electromagnets and the spray devices are spraying spray coolant onto the cold wall of the inner shell to cool at least a portion of the thrust chamber.

85. The rocket engine system of claim 81, wherein the spray devices are mounted to spindle tubes that in turn are mounted to a hollow, rotating spindle, wherein the spindle is spun by an electric motor and feeds the spray devices with a spray coolant which is projected onto the cold wall of the inner shell to cool at least a portion of the thrust chamber.

86. The rocket engine system of claim 81, wherein more spray coolant flows through the spray devices than is required to cool at least a portion of the thrust chamber below a maximum allowable temperature of the thrust chamber; and
wherein spray coolant is pumped through the spray devices in an amount that is about 1.1 to 25 times more than what is required to cool at least a portion of the thrust chamber below a maximum allowable temperature of the thrust chamber; and
wherein the gap is between the inner and outer shell for at least a portion of the thrust chamber and the spray coolant cools at least a portion of the thrust chamber.

87. The rocket engine system of claim 81, wherein the recirculating cooling system further comprises:
a recirculating spray coolant loop operable to couple a thrust chamber gap, a heat exchanger, a low pressure coolant pump, a high pressure coolant pump, a coolant feed tank, and spray devices; and
wherein at least one location that the recirculating cooling system further comprises:
a heat exchanger that removes heat from at least a portion of the spray coolant with the heat exchanger coolant being any of the main propellants or pressurant fluid; and
wherein, spray coolant is projected onto the cold wall of the inner shell by internal pressure of the coolant feed and then flows downward where spray coolant is collected at the bottom of the gap and then is pumped toward the high pressure coolant pump by a low pressure coolant pump located at a low point in the gap wherein the high pressure coolant pump pushes spray coolant back to the coolant feed tank.

88. The rocket engine system of claim 81, wherein the recirculating cooling system further comprises:
a nozzle film coolant manifold/injector operably coupled to the recirculating spray coolant loop and operable to pass at least a portion of the spray coolant onto the interior wall of at least a portion of the expansion nozzle as a nozzle coolant.

89. The rocket engine system of claim 81, wherein the inner shell further comprises:
a thin metal shell structure; wherein each of the inner shell and the outer shell of the thrust chamber further comprises:
a wall having a thickness of between about 0.010 inches and about 0.50 inches; and
wherein the thrust chamber structure further comprises:
a thrust chamber structure constructed of common materials such as metals, metal alloys, metal compounds, metal composites, plastics, plastic composites, and composite materials; and
further comprising solid items in the gap or formed into the inner or outer shells as necessary to maintain the gap or to attach the shells together; and
wherein the thickness of these solid items being in addition to the thickness of the inner and outer shells.

90. The rocket engine system of claim 81, wherein the thrust chamber has an internal film coolant injected onto at least a portion of the thrust chamber interior hot-wall.

91. The rocket engine system of claim 81, wherein at least a portion of the spray coolant is recirculated in a continuous loop by a coolant delivery pump and a coolant recirculation pump.

92. The rocket engine system of claim 91, wherein a spray coolant is recirculated in a continuous loop by the internal pressure of the coolant feed tank and by the pressure rise of a coolant recirculation pump.

93. The method of claim 81, wherein the expending of spray coolant further comprises:
dumping at least a portion of the spray coolant overboard through a coolant metering device.

94. A rocket engine system comprising:
a thrust chamber having a gap between an inner shell and an outer shell, the inner shell and the outer shell being attached together to form at least a portion of the thrust chamber; and
a simplified regenerative cooling system operably coupled to a thrust chamber gap and operable to circulate a main propellant regenerative coolant through the gap to cool the thrust chamber, wherein after cooling the at least a portion of the thrust chamber the regenerative coolant is injected into the combustion chamber by the main propellant injector and burned as a main propellant; and
wherein the thrust chamber inner shell is prevented from collapsing due to synchronizing the rise or decay in gap pressure with the rise or decay in thrust chamber internal pressure during rocket engine startup and shutdown; and
wherein a main propellant regenerative coolant flows through the gap to cool at least a portion of the thrust chamber below a maximum allowable temperature of the thrust chamber; and
the method comprising:
flowing a regenerative coolant into an entry point in a gap between an inner shell and an outer shell of a thrust chamber; and
flowing the regenerative coolant through the gap from the entry point and then out through an exit point at a second location in the gap.

95. The rocket engine system of claim 94, wherein the synchronization of gap and thrust chamber internal pressure is accomplished by the timing and control of the opening/closing of the following valves: main oxidizer valve, main fuel valve, fuel startup valve, and the coolant isolation valve, wherein the main fuel valve is a 3-way valve; and
wherein the simplified regenerative cooled rocket engine pre-start is as follows: the fuel start and main oxidizer valves are closed; main fuel valve is in a dump position; coolant isolation valve is partially open allowing some regenerative coolant flow without building up enough gap pressure to collapse inner shell; regenerative coolant flow is dumped overboard from engine by main fuel valve in dump position; and
wherein, the engine starts by the opening of the main oxidizer and fuel start valve, wherein as the propellant ignites in the thrust chamber the internal pressure of the thrust chamber rises, wherein the thrust chamber is cooled during the brief engine start procedure by a low pressure flow of the regenerative coolant that is being dumped overboard; and
wherein as the thrust chamber internal pressure begins to rise during ignition the coolant isolation valve begins to open, increasing the gap pressure and thus increasing regenerative coolant flow in synchronization with the rise in thrust chamber internal pressure to the extent that the inner shell does not collapse, and wherein in synchronization with the thrust chamber internal pressure rise the main fuel valve is changed from a dump position to diverting the regenerative coolant to the main propellant injector, the fuel startup valve closes and the engine is at full start without collapsing the inner shell.

96. The rocket engine system of claim 94, wherein more regenerative coolant than necessary is implemented to cool the thrust chamber, wherein the excess regenerative coolant not immediately implemented as engine combustible propellant after cooling the thrust chamber will be rerouted to its appropriate main propellant tank via a continuous regenerative coolant loop; and
wherein regenerative coolant flows through the gap in an amount that is about 1.1 to 10 times more than what is required to cool at least a portion of the thrust chamber below a maximum allowable temperature of the thrust chamber; and
wherein the continuous regenerative coolant loop further comprises:
a recirculating regenerative coolant loop that couples a heat exchanger, a recirculation pump, a pressure isolation valve, a pressure vent valve, a pressure check valve, a main propellant tank, a coolant isolation valve, a main fuel valve, a gap fill valve, and a thrust chamber gap, wherein a portion of the regenerative coolant is continuously recirculated through a regenerative coolant loop by the internal pressure of a main propellant tank and the pressure added to the regenerative coolant by the recirculation pump; and
wherein at least one location that the regenerative coolant loop further comprises:
a heat exchanger that removes heat from the regenerative coolant the heat exchanger coolant being any of the main propellants or pressurant fluid.

97. The rocket engine system of claim 94, wherein the gap is between the inner and outer shell for at least a portion of the thrust chamber and the regenerative coolant recirculates through the gap surrounding at least a portion of the thrust chamber; and
wherein the thrust chamber has an internal film coolant injected onto at least a portion of the thrust chamber interior hot-wall.

98. The rocket engine system of claim 94, wherein the inner shell and outer shell further comprises:
a thin metal shell structure; and
wherein the each of the inner shell and the outer shell of the thrust chamber further comprises:
a wall having a thickness of between about 0.010 inches and about 0.50 inches; and
further comprising solid items in the gap or formed into the inner and outer shells as necessary to maintain the gap or to attach the shells together; and
wherein the thickness of these solid items being in addition to the thickness of the inner and outer shells; and
wherein the thrust chamber further comprises:
a thrust chamber structure constructed of common materials such as metals, metal alloys, metal compounds, metal composites, plastics, plastic composites, and composite materials.
wherein the inner shell and the outer shell being attached together.
